(19) United States
(12) Patent Application Publication
(10) Pub. No.: US 2026/0368769 A1
(43) Pub. Date: Nov. 19, 2026

(54) REAL-TIME RETARGETING SEGMENTS CREATED BASED ON CONTENT DETECTED IN LIVE CONTENT SIGNALS USING AUTOMATIC CONTENT RECOGNITION

(71) Applicant: Roku, Inc., San Jose, CA (US)

(72) Inventors: Shashank Merchant, Sunnyvale, CA (US); Virginie M. Debelair, San Francisco, CA (US); Dong Jiang, Newton, MA (US); Vladyslav Oblamskyi, New York, NY (US)

(21) Appl. No.: 19/211,067

(22) Filed: May 16, 2025

(51) Int. Cl. G06Q 30/0204; G06F 9/54; H04N 21/234; H04N 21/258

(52) U.S. Cl. CPC G06Q 30/0204; G06F 9/542; H04N 21/23418; H04N 21/258

(57) ABSTRACT

System, apparatus, article of manufacture, method and/or computer program embodiments are provided for creating user segments in real-time (or near real-time) used to retarget users with selected content associated with content detected in live content. An example method includes detecting a content item in a content signal at a device of a user; determining whether a retargeting condition is satisfied with respect to the content item and user based on content item information and activity at the device during a presentation of the content item; based on the retargeting condition being satisfied, generating a notification configured to trigger the user to be added to a segment of users selected for retargeting with content associated with the content item; receiving the content associated with the segment, the content including content selected for the users based at least on the content item; and displaying the content for the user.

### BACKGROUND

### Field

This disclosure is generally directed to real-time or near real-time detection of content in signals and creating retargeting user segments.

### SUMMARY

Provided herein are system, apparatus, article of manufacture, method and/or computer program product embodiments (and/or combinations and/or sub-combinations thereof) for detecting content in real-time (or near real-time) using automatic content recognition and using the content detections to create retargeting user segments in real-time (or near real-time). In some aspects, a method is provided for creating, in real-time (or near real-time), users segments used to retarget users with selected content associated with specific content detected within live content signals. An example method can include detecting, using automatic content recognition (ACR), a first content item in a live content signal received by a device associated with a user; determining whether one or more retargeting conditions are satisfied with respect to the first content item and the user based on information about the first content item and activity detected at the device during a presentation of the first content item; in response to determining that the one or more retargeting conditions are satisfied, generating a retargeting event notification configured to trigger the user to be added or considered for addition to a user segment including users selected for retargeting with a second content item associated with the first content item; receiving, by the device, the second content associated with the user segment, wherein the second content includes content selected for the users in the user segment based at least in part on the first content item; and providing the second content to a user interface associated with the user for presentation.

In some aspects, a system is provided for creating, in real-time (or near real-time), users segments used to retarget users with selected content associated with specific content detected within live content signals. The system can include one or more computing and/or media devices such as, for example, a television, a media player, a server, a computer, a set-top box, an Internet-of-Things (IoT) device, a peripheral device, a mobile device (e.g., a smartphone, etc.), a wearable computing device (e.g., a smartwatch, smart glasses, a head-mounted display (HMD), an extended reality (e.g., virtual reality, augmented reality, mixed reality, virtual reality with video passthrough, etc.) glasses, etc.) system, a single-board computer (SBC) or system-on-chip (SoC) device, a video game console, and/or a smart device, among others.

The system can include memory used to store data, such as computing instructions, and one or more processors coupled to the memory and configured to perform operations including detecting, using ACR, a first content item in a content signal received by a device associated with a user; determining whether one or more retargeting conditions are satisfied with respect to the first content item and user based on information about the first content item and activity detected at the device during a presentation of the first content item; in response to determining that the one or more retargeting conditions are satisfied, generating a retargeting event notification configured to trigger the user to be added or considered for addition to a user segment including users selected for retargeting with a second content item associated with the first content item; receiving the second content associated with the user segment, the second content includeing content selected for the users in the user segment based at least in part on the first content item; and providing the second content to a user interface associated with the user for presentation.

In some aspects, a non-transitory computer-readable medium is provided for creating, in real-time (or near real-time), segments used to retarget users with content detected within content signals. The non-transitory computer-readable medium can have instructions stored thereon that, when executed by one or more processors, cause the one or more processors to perform operations including detecting, using ACR, a first content item in a content signal received by a device associated with a user; determining whether one or more retargeting conditions are satisfied with respect to the first content item and user based on information about the first content item and activity at the device during presentation of the first content item; in response to determining that the one or more retargeting conditions are satisfied, generating a retargeting event notification configured to trigger the user to be added or considered for addition to a user segment including users selected for retargeting with a second content item associated with the first content item; receiving the second content associated with the user segment, the second content including content selected for the users in the user segment based at least in part on the first content item; and providing the second content to a user interface associated with the user for presentation.

### BRIEF DESCRIPTION OF THE FIGURES

The accompanying drawings are incorporated herein and form a part of the specification.

FIG. 1 is a block diagram illustrating an example multimedia environment, according to some examples of the present disclosure.

FIG. 2 is a block diagram illustrating an example media device, according to some examples of the present disclosure.

FIG. 3 is a diagram illustrating an example system process for retargeting users with selected content, according to some examples of the present disclosure

FIG. 4 is a flowchart illustrating an example method for retargeting users with selected content, according to some examples of the present disclosure.

FIG. 5 is a flowchart illustrating an example method for retargeting users with selected content, according to some examples of the present disclosure.

FIG. 6 is a flowchart illustrating another example method for retargeting users with selected content, according to some examples of the present disclosure.

FIG. 7 is a diagram illustrating an example architecture of an example neural network, according to some examples of the present disclosure.

FIG. 8 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users can access and consume (e.g., watch, play, interact with, etc.) media content using devices with display and/or playback capabilities such as, for example, mobile phones (e.g., smartphones), set-top boxes, computers (e.g., desktop computers, laptop computers, tablet computers, etc.), televisions (TVs), Internet Protocol television (IPTV) devices or receivers, media players, displays or monitors, projectors, video game consoles, smart wearable devices (e.g., smartwatches, smart glasses, head-mounted displays (HMDs), extended reality devices (e.g., virtual reality glasses, augmented reality glasses, mixed reality glasses, virtual reality devices with video passthrough, etc.), single-board computers (SBCs), system-on-chip (SoC) devices, and Internet-of-Things (IoT) devices, among other devices. The media content can include digital formats and/or assets such as videos (e.g., live or pre-recorded/on-demand videos, streamed videos, TV shows, movies, animated videos, motion graphic videos, live recordings, video clips, any sequence of video frames, etc.), video games, audio, text (e.g., closed captions, subtitles, onscreen text, intertitles, superimposed text, etc.), graphics, media channels, images, etc.

For example, a user can use a media device to watch a video on a media content platform, an online streaming service, a content delivery network, a media player application, a video sharing application, a web browser, a TV platform, an Internet Protocol television (IPTV) platform, a broadcast service, etc. The video can include a live or on-demand/pre-recorded video (e.g., a movie, a TV show, a live video feed, a video stream, etc.), an animated video, a video broadcast, a video game, etc. The media device can access, receive, stream, play, and/or display the video from a local source, such as a local storage, or receive/stream the video from a remote source, such as a server, a media content platform/network, a content provider, an online or streaming service, the Internet, etc. In some examples, the media device can access, receive, stream, play, and/or display the video via a media channel, a media application, a content platform, a broadcast system or service, a web browser, a video receiver, a content sharing or collaboration platform, a social media network, etc. Moreover, the media device can include, access, and/or manage any content (e.g., live and/or pre-recorded videos such as movies and TV show, images, audio, text, etc.), media channel, media application, content setting, output device, functionality, component, etc.

The media device can display visual content on a display(s), such as a display of the media device and/or a separate/external display, and can output any audio content via a speaker device(s), such as an internal and/or external speaker device. The user of the media device can watch any visual content of the media content from the display(s) and/or listen to any audio of the media content output by the speaker device(s). The user can optionally use the media device (and/or an input device thereof), a remote, an application, and/or a separate device to access media content, play media content, record media content, interact with media content, search or navigate content, manage content settings (e.g., volume settings, closed caption settings, subtitle settings, resolution settings, color settings, etc.), etc.

In some cases, a content provider or platform can target content to users. The content provider or platform can select or generate the targeted content and provide the targeted content to media devices for presentation to the users. The targeted content can include content selected for and/or tailored to a user(s). For example, the targeted content can include content that the user(s) has demonstrated or indicated interest in (or a threshold amount or level of interest in), content that matches or aligns with (or has a threshold match or alignment with) an interest(s) or preference(s) of the user(s), content predicted to elicit a positive emotion or reaction from the user(s) (e.g., a conversion action, a subscription action, a comment, a “like” or rating, a playback action, an interaction, joy, desire, happiness, excitement, delight, etc.), content requested by the user(s), and/or content estimated or predicted to be interesting, appealing, engaging, and/or compelling to the user(s) (or elicit a threshold amount or level of user interest, appeal, or engagement). The targeted content can improve a content experience of targeted users, increase user engagement and/or retention, increase conversion rates, increase brand loyalty, increase a userbase (e.g., draw new users), increase user satisfaction, etc.

The targeted content can be selected for and/or tailored to a user(s) based on targeting information. The targeting information can include any information and/or cue indicating a potential interest or appeal to the user(s). In some cases, the targeting information can additionally or alternatively include any information and/or cue used to determine whether the user(s) likes or is predicted to like a targeting content candidate, the user(s) is likely (e.g., based on a threshold likelihood) interested in (e.g., or likely to have a threshold amount or level of interest in) the targeting content candidate, the user(s) is expected to react in a certain way(s) (e.g., a predetermined reaction, a reaction deemed positive, etc.) to the targeting content candidate, the targeting content candidate is predicted to elicit a certain reaction(s) from the user(s) (e.g., a predetermined reaction, a reaction deemed positive, a conversion action, etc.), the targeting content candidate matches or aligns with (or matches or aligns with by a threshold amount or percentage) an interest(s) or preference(s) of the user(s), the targeting content candidate is predicted to elicit a certain emotion(s) from the user(s) (e.g., a predetermined emotion, an emotion deemed positive, etc.), the targeting content candidate has a predicted or estimated appeal to the user(s), the targeting content candidate is predicted or expected to engage the user(s) (and/or engage the user(s) in a certain way(s), for a certain amount of time, and/or according to an engagement score), and/or the targeting content candidate is a suitable content candidate or match for the user(s).

For example, the targeting information can include user data, content data, user group data, demographics data, historical data, statistics, learned data, activity data, logged data, session data, targeting campaigns, etc. In some examples, the targeting information can include user preferences and/or interests, content patterns and/or statistics (e.g., content consumption patterns and/or statistics, content feedback patterns and/or statistics, content interaction patterns and/or statistics, conversion rates and/or patterns, content behavior and/or presentation patterns and/or statistics, user-specific and/or group-specific content patterns and/or statistics, etc.), user profiles and/or characteristics (e.g., demographics, user locations, user propensities/tendencies, user patterns, user attributes, user historical data and/or statistics, etc.), content characteristics (e.g., content configurations, categories, behaviors, settings, types, attributes, formats, delivery mechanisms/mediums, etc.), user activity (e.g., conversion actions, content interactions, playback actions, purchase activities/history, inputs, content requests, etc.), user feedback and/or inputs (e.g., user requests, comments, “likes”, ratings, actions, content interactions, subscriptions or subscription requests, conversions, etc.), cues indicating user interests and/or propensities/tendencies, and/or any other targeting information.

The targeted content can include any type of content selected for and/or targeted to a user(s) such as, for example, videos (e.g., movies, TV shows, animated videos, video games, live videos, etc.), images (e.g., still pictures, logos, artwork, avatars, thumbnails, etc.), audio (e.g., speech, music, sounds, etc.), invitational content (e.g., advertisements, marketing content, etc.), text (e.g., a text message, subtitles, closed captions, etc.), static and/or dynamic content, etc. For example, a content provider (e.g., a content platform or service) can target a video (e.g., a movie, a TV show, etc.) to users who the content provider determines are likely interested in the video (e.g., or predicted to have a threshold likelihood of interest in the video) or have indicated an interest or potential interest in the video. This way, the content provider can intelligently target the video to users who are expected to like the video or find the video appealing, are likely (or more likely) interested in the video, are more likely to be engaged by the video, etc. An advertiser can purchase advertising campaigns from the content provider. Based on the advertising campaigns, the content provider can target advertisements to users to drive user interest in the advertiser and/or advertised items (e.g., products, services, brands, events, etc.), ensure the advertisements provided to users have a threshold relevance to the users, better match advertisements to users or user interests, increase the value of advertisements, increase the conversion rates of the advertisements, etc.

The targeted content can be selected for and/or tailored to users based on targeting information. The targeting information can help tailor content to users, improve the content experiences of targeted users, improve targeting results, etc. In general, the amount, quality, and/or relevance of the targeting information can affect the performance, accuracy, and/or effectiveness of the targeted content selected and/or tailored based on the targeting information. For example, the performance, accuracy, and/or effectiveness of content targeted to users may depend on or be affected by the amount, quality, or relevance of targeting information used to target the users, with a higher quantity, quality, and/or relevance of targeting information generally resulting in better targeting performance, accuracy, and effectiveness.

The targeting performance, accuracy, and effectiveness can be increased by retargeting selected users with content. The retargeted users can include users who were previously targeted with certain content. For example, if a group of users is targeted with content, a subset of the targeted users who indicated a higher interest in the content (e.g., relative to other targeted users) or are otherwise determined/predicted to have a threshold likelihood of interest (and/or a higher interest relative to other users) in the content can be retargeted with content, such as a different or modified version of the targeted content, the same content as the targeted content, a content that has a relevance or relationship to the targeted content, a content determined based on the targeted content (and/or characteristics thereof), a content in a same category (e.g., content type, genre, attributes, etc.) as the targeted content, content from a same or related source (e.g., owner, provider, entity, producer, brand, advertiser, etc.) as the targeted content, and/or other content. Intelligently retargeting selected users can yield better targeting results and outcomes than retargeting all users from a userbase or random users. Accordingly, intelligently and selectively retargeting users with content can increase targeting results and outcomes.

For example, if a user shows interest in or reacts positively to targeted content, the user can be retargeted with content determined based on the targeted content. The content can include a version of the targeted content, a content item that has one or more attributes in common with the targeted content, a content item that has a relationship to the targeted content, a content item that has a common source as the targeted content, a content item that is of a same (or similar) category as the targeted content, a content item that is related or relevant to the targeted content, a modified version of the targeted content, the same content as the targeted content, etc. The user can be retargeted with the other content based on the user's interest in or reaction to the targeted content.

Since the user previously showed interest in or reacted positively to the targeted content item, retargeting the user with the other content item (which can be a different version of the targeted content item, have some relevance or relationship to the targeted content item, have a common attribute(s) as the targeted content item, correspond to a same or similar category as the targeted content item, be the same as the targeted content item, and/or be otherwise based on the targeted content item) can result in better targeting results and/or outcomes (e.g., higher conversion rates, increased user engagement or retention, higher targeting accuracies, better user experiences, etc.) than retargeting the other content item to other users who were previously targeted with the content item and did not show interest in or react positively to the targeted content item, or alternatively targeting the same and/or different users with a different content item, such as different users who have not been previously targeted with the targeted content item or the different content item or who have been targeted with the targeted content item but did not show interest in or react positively to the targeted content item.

To this end, a content provider (or user device) can determine whether to retarget a user who was previously targeted with a content item. The content provider (or user device) can choose to retarget the user with another content item determined based on the content previously targeted to the user. The retargeting content can include a different version of the content previously targeted, content that has a common, similar, related, and/or relevant attribute(s) with respect to the previously-targeted content (e.g., a common genre, category, content type, source, characteristics, producer, activity, content depictions, etc.). The content provider (or user device) can choose to retarget the user with the other content if the content provider (or user device) determines that the user likes, is interested in (or has a threshold interest in), is likely interested in (or has a threshold likelihood of being interested in), showed interest in, had a positive reaction to, is predicted to like or be interested in, and/or is predicted to react positively to the content. If the content provider (or user device) determines that a user likes, is interested in (or has a threshold interest in), is likely interest in (or has a threshold likelihood of being interested in), showed interest in, had a positive reaction to, is predicted to like or be interested in, and/or is predicted to react positively to the content, the content provider (or user device) can retarget the user the other content or include the user in a user segment representing a target audience for the other content. This way, the content provider (or user device) can intelligently retarget selected users with content predicted or expected to achieve better targeting results and/or outcomes.

To illustrate, users who consume (e.g., watch, play, etc.), repeat (e.g., rewatch, replay, etc.), interact with, do not skip or ignore, or engage with (e.g., provide feedback, provide inputs such as “like” inputs or comments, subscribe to, initiate a conversion action, etc.) a targeted content item, are likely more interested in the targeted content item as well as similar, related, or relevant content items, and are generally better targets for such content items than users who ignore, skip, do not interact with, do not engage with, and do not consume or repeat the targeted content item. Thus, in some examples, a content provider (or respective client devices) can detect the content presented by client devices associated with the users and/or content received by respective interfaces (e.g., video or audio/video interfaces such as high definition multimedia interfaces (HDMIs), video graphics array (VGA) interfaces, digital video interfaces (DVIs), USB-C interfaces, DisplayPort interfaces, etc.) of the client devices, including content targeted to the users, to determine whether the users were targeted with a content item (e.g., whether a targeted content item was provided to the client devices and/or respective interfaces for presentation and/or loaded by the client devices).

If a content item was targeted to the users, the content provider (or client devices) can check for any cues indicating whether the users consumed (e.g., watched, played), repeated, interacted with, engaged with, skipped, or ignored the targeted content. The content provider (or client devices) can use the cues to determine whether to retarget any of the users with content determined based on the targeted content or add any of the users to a user segment selected for retargeting with content, such as a different version of the targeted content, a same content or modified version of the content in the targeted content, similar content as the targeted content, content relevant or related to the targeted content, content that has one or more common or similar attributes as the targeted content, or other content.

For example, assume that the targeted content includes an in-stream video promoting Brand X, and was targeted to users streaming a movie from their devices. A content provider application or platform can detect that the movie streamed by the devices includes the in-stream video promoting Brand X. The application or platform can check for any cues indicating whether the users consumed (e.g., watched, played), repeated, interacted with, engaged with, skipped, or ignored the in-stream video promoting Brand X. The application or platform can use the cues to identify a subset of the users who consumed, repeated, interacted with, or engaged with the in-stream video, and optionally identify a different subset of users who skipped, ignored, did not consume, did not repeat, or did not engage with the in-stream video. The subset of users who consumed, repeated, interacted with, or engaged with the in-stream video are likely more interested in the content of the in-stream video and/or Brand X than other users who skipped, ignored, did not consume, did not repeat, or did not engage with the in-stream video. Accordingly, the application or platform can select the subset of users who consumed, repeated, interacted with, or engaged with the in-stream video for retargeting with content determined based on the content of the in-stream video promoting Brand X, such as a different version of the content, the same content, related or relevant content, content having a threshold similarity, content having a common or similar attribute(s), content of a same or similar category or entity, etc.

The application or platform can add the subset of users to a segment selected for retargeting with content determined based on the content of the in-stream video promoting Brand X, and exclude the other users from the segment. The application or platform can retarget the users in the segment with content determined based on the in-stream video promoting Brand X. The application or platform can provide such content in a same or different format as the in-stream video and/or within a same or different medium as the in-stream video (e.g., within the movie or within a different medium). For example, the application or platform can create an interstitial video promoting Brand X and containing the content (or a version thereof) of the in-stream video promoting Brand X. The application or platform can retarget the segment with the interstitial video promoting Brand X. In some cases, the application or platform can provide the interstitial video to the users in the segment within another portion of the movie. In other cases, the application or platform can provide the interstitial video to the users in the segment within other content, such as a page of the application or platform, a different movie or video, and/or any other content, space, or medium. The application or platform can include, for example, an application or platform of a provider(s), an application or platform used to access or stream the movie, etc.

By retargeting selected users with content, the application or platform can potentially achieve better targeting results and outcomes (e.g., better targeting performance, higher conversion results, better user experiences, more accurate targeting, etc.) than retargeting the content to all users, a random set of users, users who were never targeted, or users who are less likely of liking the content, being interested in the content, finding the content appealing, or being engaged by the content, such as users who were targeted with the content but ignored, skipped, did not interact with, or did not engage with the content. While retargeting users with content who have a higher likelihood of liking the content, are more likely interested in the content (e.g., have a threshold likelihood of interest in the content), have indicated or demonstrated an interest or preference in the content (or another content used to determine the retargeting content), etc., can result in better targeting results and outcomes, it can be difficult to obtain a sufficient amount of relevant and accurate targeting information for making effecting targeting or retargeting decisions. The amount, quality, relevance, and availability of targeting information is often limited, which can limit the ability to effectively target or retarget users with content. Moreover, obtaining such targeting information can take time, which can reduce the timely availability of targeting information, delay or reduce the ability to effectively target or retarget users with content, and can even result in lost content targeting or retargeting opportunities.

Provided herein are system, apparatus, device, method (also referred to as a process) and/or computer program product embodiments, combinations and/or sub-combinations thereof (also referred to as “systems and techniques” hereinafter) for obtaining targeting information in a timely fashion and using the targeting information to intelligently retarget selected users with certain content. For example, the systems and techniques described herein can analyze content played, displayed, and/or streamed at user devices in real-time (or near real-time) to obtain targeting information in a timely fashion (e.g., in real-time or near real-time). The systems and techniques described herein can use the targeting information to intelligently retarget specific users with content in a timely fashion. The systems and techniques described herein can obtain targeting information in real-time from content played/displayed by a user device(s) and/or received by an interface (e.g., an HDMI interface, VGA interface, DisplayPort interface, USB-C interface, DVI interface, etc.) of the user device(s), such as live content (e.g., a live feed, a live video, a live broadcast, a livestream, linear TV content or programming, a live video game, etc.) or pre-recorded/on-demand content (e.g., pre-recorded/on-demand videos, video games, application content, etc.), and use the targeting information to retarget selected users with specific content.

The systems and techniques described herein can detect content in a signal, such as a live signal (e.g., live video, livestream, live broadcast, linear TV content or programming, etc.) played, displayed, loaded, and/or streamed by client devices (and/or respective interfaces of the client devices such as HDMI, VGA, DVI, DisplayPort, USB-C, and/or other interfaces), and determine whether to retarget selected users (e.g., associated devices) with specific content determined based on the detected content. If the systems and techniques described herein determine to retarget a user with content, the systems and techniques described herein can add or subscribe that user to a user segment. The user segment can include or represent users selected for retargeting with content determined based on the detected content. The systems and techniques described herein can create user segments for retargeting in real-time (or near real-time). The systems and techniques described herein can retarget the users (or associated devices) in the user segment with content determined based on the detected content. The retargeted content (e.g., the content provided to the users) can include a different version of the detected content (or a content thereof), the same or similar content as a content of the detected content, similar content as the detected content, content relevant or related to the detected content, a content that has one or more common or similar attributes as the detected content, or any other content determined based on the detected content.

For example, the systems and techniques described herein can analyze a live video streamed, played, and/or displayed by a client device. The systems and techniques described herein can detect or recognize content in the live video and determine in real-time (or near real-time) whether to retarget a user of the client device with content determined based on the content in the live video. In some cases, the systems and techniques described herein can determine whether to retarget the user with content based on a determination that the detected or recognized content in the live video matches stored content available, designed, and/or selected for targeting or retargeting users (e.g., targeted content). To illustrate, the systems and techniques described herein can compare content detected in the live video with available targeting content (e.g., content used for and/or available, designed, and/or selected for targeting/retargeting users). If a content item matches a targeting content item from the available targeting content, the systems and techniques described herein can retarget selected users from the users who consumed (e.g., watched, played, streamed, etc.) the live content containing the content item with the targeting content item.

As used herein, references to retargeted content, retargeting content, content retargeted to a user or user segment do not mean that such content has been previously targeted or provided to such user or user segment, is the same as content previously provided or targeted to the user or user segment, or is being targeted or provided to the user or user segment again (e.g., more than once). In other words, the content in references to retargeted content, retargeting content, or content retargeted to a user or user segment can include the same content as a content previously targeted or provided to the user or user segment, a version of the content targeted or provided to the user or user segment, content that has not been targeted or provided to the user or user segment (e.g., different content), or any other content. Thus, the terms “retargeted”, “retarget”, or “retargeting” (e.g., retargeted content, retargeting content, retargeting a user with content, retargeting content to a user, retarget a user with content, retarget content to a user, etc.) indicate that a user(s) is being targeted/retargeted with content irrespective of whether such content has or has not been previously targeted to the user(s), and are not used to mean that such content has or has not been previously targeted or provided to the user(s) or is being provided or targeted to the user(s) again. Such content can therefore include a same or different version of content previously targeted or provided to a user, content that has not been previously targeted or provided to the user, or other content.

In some cases, the systems and techniques described herein can use fingerprints to identify detected content and/or can store respective fingerprints of targeting content detected, available for targeting/retargeting, and/or identified as targeting/retargeting candidates. The systems and techniques described herein can generate fingerprints for content based on any content, attributes, metadata, and/or information associated with the content. For example, to generate a fingerprint of a content item, the systems and techniques described herein can apply a hash function to a content (or portion thereof), attribute(s), and/or metadata of the content item. The result from the hash function can be used as a fingerprint of the content item that uniquely identifies the content item. In some cases, the systems and techniques described herein can identify a content item detected in a video (e.g., a live video) based on a fingerprint calculated or obtained for the content item. In some cases, the systems and techniques described herein can compare a content item detected in the video (e.g., a live video) with targeting content candidates, targeting content available, or any other targeting content. To compare the content item detected in a video to any targeting content items, the systems and techniques described herein can generate a fingerprint of the detected content item and compare the fingerprint to the respective fingerprints of one or more targeting content items. If the fingerprint matches a fingerprint from the respective fingerprints, the systems and techniques described herein can determine that the detected content item matches a content item from the one or more targeting content items. In some examples, the systems and techniques described herein can use the fingerprint of the detected content item to identify the detected content item, and can use the identified content item to select, configure, or create a content item to provide to users (or an associated user segment) selected for retargeting with content, or can select the identified content item for retargeting to such users (or user segment).

For example, in some cases, the systems and techniques described herein can identify the detected content item based on a fingerprint of the detected content item, and determine content to provide to users selected for retargeting based on the identified content item. In some cases, the systems and techniques described herein can determine that the fingerprint of the detected content item matches one of the respective fingerprints, and select the detected content item as the content or a basis of a content provided to users selected for retargeting with content, such as users who consumed or received the live video containing the detected content item via respective client devices. In some cases, the systems and techniques described herein can use the fingerprint match to determine (in real-time or near real-time) which detected content to analyze (e.g., including any user interactions with the content, a behavior of the content at the client devices, content statistics associated with the content, device and/or user activity associated with the content, etc.) when determining which users to retarget with content (with the same or different content) and/or as a filter to select (e.g., in real-time or near real-time) content for retargeting. This way, the systems and techniques described herein can more quickly (e.g., in real-time or near real-time) select content and/or users for retargeting and retarget selected users with content in a timely fashion.

In some cases, if the fingerprint of the detected content item does not match any of the respective fingerprints, the systems and techniques described herein can filter the detected content item (e.g., ignore the detected content item when analyzing content to determine which users to retarget with content) from the content analyzed to determine which users to retarget with content and/or from the content selected for retargeting, or optionally perform an additional or concurrent check to determine whether to use the detected content item (and/or associated statistics, interactions, user and/or device activity, etc.) as a basis for retargeting users with content (e.g., the detected content item, a different content item, a modified version of the detected content item, a content item determined based on the detected content item, etc.). The systems and techniques described herein can perform the optional check (e.g., the additional or concurrent check) based on one or more filters, conditions, cues, and/or any other targeting information described herein.

In some cases, the systems and techniques described herein can additionally or alternatively select which users (and/or associated devices) who received a content signal (e.g., a live video signal, etc.) or consumed associated content to retarget with content (e.g., the same or different content) based on a retargeting condition(s) and/or targeting information and/or cues, and/or can select which content in the content signal to use as a basis for content provided to retargeted users (e.g., as a basis to determine what content to provide to such users) based on the retargeting condition(s) and/or targeting information and/or cues. For example, the systems and techniques described herein can determine whether to use a detection of content in a content signal as a basis for retargeting selected users with content and/or determining what content to provide to the retargeted users. In some cases, the systems and techniques described herein can determine whether to retarget such users with content and/or determine which content to provide to such users based on information indicating whether the users consumed (e.g., played, viewed/watched, replayed, rewinded, etc.) the detected content in the content signal, interacted and/or engaged with the detected content, provided a certain input during playback/presentation of the detected content, initiated a conversion action associated with the detected content, did not skip/forward or close the detected content; whether the devices associated with such users displayed, played, and/or streamed the detected content and/or content signal; and/or whether such users are estimated to have a threshold likelihood of liking or being interested in the detected content (and/or associated content), a threshold likelihood of finding the detected content appealing/engaging, a threshold likelihood of reacting positively to being retargeted with content associated with the detected content (e.g., the same or different content), a preference(s) that matches a characteristic(s) of the detected content, a content statistic associated with or matching the detected content (and/or an associated content type/category), and/or an indicia indicating that they watched the detected content and/or have a threshold interest in the detected content (and/or associated content).

If a user is selected for retargeting with content and/or a specific content item is selected for use to retarget the user, the user can be added and/or subscribed to a user segment used to retarget selected users with content associated with the detected content in the content signal (e.g., the same content, a version of the same content, different content, specific content determined based on the detected content, etc.). The user segment can include or represent users selected for retargeting with content. In some cases, users can be added or subscribed to a user segment in real-time (or near real-time) and the user segment can be created, modified, and/or selected in real-time (or near real-time). The systems and techniques described herein can retarget each user in the user segment with content by providing such content to a respective device of each user; triggering the respective device of each user to load, stream, play, or display such content; or triggering a content source to deliver such content to the respective device of each user.

The content can provided to the retargeted users (also referred to as the “retargeted content” or the “retargeting content”) can include a content item(s) determined based on the detected content, a version of the detected content (e.g., a different or modified version of the detected content), the detected content, content having one or more attributes associated with the detected content, content having a threshold similarity or relevance to the detected content, content having a same provider or source as the detected content, content of a same category or entity as the detected content, etc. In some cases, to select content for a user being retargeted and/or select a user for retargeting with content (and/or to include in a user segment selected for retargeting with content) based on retargeting information, a retargeting condition(s), and/or a retargeting cue(s), the systems and techniques described herein can determine whether the user consumed (e.g., watched, played, etc.), interacted with, engaged with, or did not skip or ignore the detected content in the content signal. If the user consumed, interacted with, or engaged with the detected content and did not skip or ignore the detected content, the systems and techniques described herein can determine to retarget the user with content associated with the detected content, such as a version of the detected content (e.g., a different or modified version), a content determined/selected or generated based on the detected content, the detected content, and/or any other content. Accordingly, the systems and techniques described herein can add or subscribe the user to a user segment used to retarget with content based at least in part on the detected content.

The content provided to users when retargeting the users can have a relevance, similarity, and/or relationship to the detected content or can otherwise be determined or generated based on the detected content. If the users retargeted with such content have shown an interest in the detected content, are predicted to like or have interest in the detected content, or demonstrated a certain reaction to the detected content (e.g., consumed the detected content, interacted with the detected content, engaged with the detected content, did not skip/close or ignore the detected content, etc.), then retargeting such users with content determined based on the detected content (e.g., the same, different, or similar content) is more likely to yield better targeting results or outcomes than retargeting all users in a userbase with such content and/or retargeting such content to users who demonstrated a lack of interest (or an interest below a threshold) in the detected content, such as users who did not consume the detected content, skipped or closed the detected content, ignored the detected content, did not interact or engage with the detected content, etc.

If the user did not consume, interact with, or engage with the detected content or skipped or ignored the detected content, the systems and techniques described herein can determine not to retarget the user with content determined based on the detected content, content associated with the detected content, or the detected content. Accordingly, the systems and techniques described herein can exclude the user from the user segment. Once the user segment is created, the systems and techniques described herein can retarget each user (and/or associated device) in the user segment with content determined based on the detected content, such as a version of the detected content, a content having a common attribute(s) as the detected content, content from a same category or entity as the detected content, content having a threshold similarity or relevance to the detected content, content having some relationship to the detected content, content having some connection to the detected content, the detected content (or content thereof), etc.

In some cases, to determine whether a user is likely interested in the detected content (and/or content determined based on the detected content), has a threshold likelihood of liking the detected content (and/or content determined based on the detected content), has a threshold likelihood of finding the detected content (and/or content determined based on the detected content) appealing/engaging, has a threshold likelihood of reacting positively to a version of the detected content, or watched the detected content, the systems and techniques described herein can determine whether the user played/replayed or did not select an input element for skipping/forwarding or closing the detected content, interacted with the detected content, engaged with the detected content, or did not ignore the detected content. If the user watched, interacted with, or engaged with the detected content and did not skip or ignore the detected content, the systems and techniques described herein can determine to retarget the user with content determined based on the detected content. The systems and techniques described herein can add the user to a user segment used to retarget with content. The systems and techniques described herein can then retarget content to each user (and/or associated device) in the user segment.

In some examples, the systems and techniques described herein can select to retarget a user with content based on the detected content item and a determination that one or more retargeting conditions are satisfied with respect to that user. The one or more retargeting conditions can include (and/or can be satisfied based on), for example, a determination that the detected content matches targeted content available at/from a targeted content source(s) and/or a determination or indicia indicating that the user is likely interested in the detected content (e.g., and thus likely interested in content determined based on the detected content), has a threshold likelihood of liking the detected content, has a threshold likelihood of finding the detected content appealing/engaging, has a threshold likelihood of reacting positively to a version of the detected content or content determined based on the detected content, consumed (e.g., watched, played, etc.) the detected content, interacted with the detected content, engaged with the detected content, and/or did not skip or ignore the detected content. In some examples, the systems and techniques described herein can determine that the one or more retargeting conditions are satisfied based on a comparison of the detected content with targeted content available or targeted content candidates, a user interaction with the detected content, user activity or inactivity during playback/presentation of the detected content, and/or a user input associated with the detected content such as an input “liking” the content, subscribing to the content (and/or associated content), initiating playback or a replay of the content, adjusting a setting of the content (e.g., increasing a volume, maximizing or increasing a size of a window depicting the content, moving a window depicting the content, adjusting a content setting such as a resolution or framerate, etc.), commenting on the content, rewinding the content, providing feedback on the content, etc.

In some cases, the determination that the one or more retargeting conditions are satisfied with respect to a user can additionally or alternatively be based on an absence of a user input(s) during playback or presentation of the detected content. For example, the determination that the one or more retargeting conditions are satisfied can be based on a determination that a client device associated with the user played, replayed, and/or displayed the detected content without interruption from the user (e.g., without an input skipping, ignoring, closing, silencing, forwarding, blocking, obstructing, or interrupting the detected content) and/or without an input indicating a lack of interest or a disinterest of the user in the detected content (e.g., without an input disliking the detected content, negatively rating/commenting on the detected content, blocking the detected content, closing the detected content, requesting not to receive the detected content, etc.).

In some cases, the determination that the one or more retargeting conditions are satisfied with respect to a user can additionally or alternatively be based on a cue(s) indicating a content disinterest or disengagement (or a threshold amount of interest or engagement) of the user during a playback or presentation of the detected content. Non-limiting examples of cues indicating content disinterest or disengagement (or a lack of a threshold interest or engagement) can include or can be based on a lack of a user response to a prompt in the detected content, a lack of a user input during a portion of the detected content expecting (e.g., requesting, eliciting, etc.) a user input, an inactivity or a threshold period of inactivity by the user during a playback or presentation of the detected content, a timeout period triggered by user inactivity during a playback or presentation of the detected content, a user input interacting with a different content item (e.g., a different application, content window, content item, etc.) during the playback or presentation of the detected content, a user input conveying a negative emotion/sentiment or reaction with respect to the detected content (e.g., a negative comment, an input “disliking” the detected content, an input blocking the detected content (and/or associated content), an input skipping or closing the detected content, an input providing a rating of the detected content that is below a threshold, a user input in a portion of the detected content (or a portion of the screen displaying the detected content) that is not associated with an input function (e.g., an input in a region that does not include an input element, such as a button or a link, or interactive content, which can indicate the user is distracted or disengaged), an input forwarding the detected content, etc.

As previously noted, the systems and techniques described herein can create retargeting user segments in real-time or near real-time. For example, the systems and techniques described herein can perform real-time (or near real-time) content recognition to detect content in a content item playing, streaming, or displayed at a device, such as a live video, stream, broadcast, TV channel or program, etc. The systems and techniques described herein can select users for retargeting with content determined based on the detected content (in real-time or near-real time), and thus retarget users with content in a more-timely fashion. In some cases, the systems and techniques described herein can determine whether one or more retargeting conditions are satisfied for a user in real-time or near real-time. In response to detecting a content item in content (e.g., a live video/feed/broadcast, linear TV content, or any other type of content) playing, streaming, or displayed at a device and determining that one or more retargeting conditions associated with the content item are satisfied with respect to a user of the device, the systems and techniques described herein can add (e.g., in real-time or near real-time) the user to a segment of users selected for retargeting with content, such as content determined based on the detected content item, and create the user segment in real-time (or near real-time). The systems and techniques described herein can retarget the user segment with such content in real-time, near real-time, or a later time.

To retarget each user in a user segment with content, the systems and techniques described herein can provide the content to the respective device of each user, trigger the respective device of each user to play/display the content, or trigger a content source to provide the content to the respective device of each user for presentation/playback. The retargeted content can be provided, played, streamed, and/or displayed within a live or pre-recorded/-on-demand content signal or any other content, such as a page or interface of an application or platform (e.g., a home page, a navigation interface, etc.), a video, an image, a web page, an advertisement unit (e.g., a banner, an interstitial, an overlay, a video advertisement unit, a display advertisement unit, an in-stream advertisement unit, an offerwall, etc.), an application, a particular content item, etc. Moreover, the retargeted content can be provided, displayed, played, streamed, and/or configured in a same or different format and/or configuration as the content associated with the retargeted content. For example, to generate retargeted content, the systems and techniques described herein can modify a format, configuration, and/or content of the content associated with the retargeted content (e.g., the content detected in a content signal) and use the modified content item as the retargeted content.

As another example, the systems and techniques described herein can use the content associated with the retargeted content (e.g., the detected content in the content signal) to determine or generate the retargeted content. To illustrate, if the content signal is a video game and the content detected in the video game is content from a level in the video game or content indicating that the user completed the video game, the systems and techniques described herein can use such content to select an advertisement for another video game as the retargeted content. The other video game can include, for example, a related video game, a video game in a same video game category, a video game from a same franchise or video game developer, a video game that has a common attribute(s) as the video game associated with the detected content, a video game that has a threshold relevance or similarity to the video game associated with the detected content, a next video game in a sequence or video game family, a video game with a common topic, etc.

Accordingly, the systems and techniques described herein can retarget each user in a user segment with content that has a same or different format and/or configuration as the detected content associated with the retargeting content, is within a same or different container or content item as detected content, within a same or different medium (e.g., application, platform, page, content item, etc.) as the detected content, is provided via a same or different advertisement unit, has a same or different content, etc. For example, if the content detected in a content signal is an advertisement displayed via a specific advertisement unit, the retargeting content for the users in a user segment selected for retargeting with such content can include the advertisement provided via a same or different advertisement unit, a different type of advertisement, a modified version of the advertisement, the same or a different advertisement provided via a same or different medium, a different advertisement determined based on the detected advertisement, etc. The retargeting content can have a same or different content as the detected content and can be displayed, included, or provided within a same or different medium as the detected content, such as a live video that included the detected content, a different live or pre-recorded video, a same or different application, a same or different user interface, a same or different page, a same or different window, a same of different image, a same or different visual element, a same or different object, a same or different advertisement unit, a some or different container, etc.

By retargeting selected users with content determined based at least in part on content detected in content signals consumed by such users, the systems and techniques described herein can increase a targeting performance, effectiveness, result, and/or outcome. As previously explained, if a user shows interest in a content item, retargeting the user with the same content item or a similar or related/relevant content item determined based on that content item can leverage the interest of the user in the content item to achieve a better targeting result or outcome when retargeting the user. For example, users who watch an advertisement within a content signal are generally more likely to be interested in the advertisement (and/or content thereof) than users who skip or ignore the advertisement. Thus, retargeting users who watched the advertisement and did not skip or ignore the advertisement with the same advertisement or a different advertisement determined based on the advertisement can be more effective than broadcasting the advertisement or a different advertisement to all users or providing the advertisement or a different advertisement to a set of users that includes users who did not previously watch the advertisement, who skipped the advertisement, who previously ignored the advertisement, or who did not show interest in the advertisement (or showed disinterest in the advertisement).

As another example, users who interacted with, did not skip, or did not ignore a content item are more likely interested in the content item than users who skipped, ignored, or did not interact with the content item. Accordingly, retargeting the users who interacted with the content item and did not skip or ignore the content item with the content item or another content item determined based on the content item (e.g., a similar or relevant content item, a modified version of the content item, the content item with a different configuration or behavior/experience, a different content item with a same attribute(s) as the content item, etc.) can be more effective than broadcasting a content item to all users or providing a content item to a set of users that includes users who skipped, ignored, lacked interest in, or did not interact with an associated content item.

In some examples, the systems and techniques described herein can use automatic content recognition (ACR) to detect content played, streamed, and/or displayed by a device and/or received by an interface (e.g., an HDMI interface, a VGA interface, a DVI interface, a USB-C interface, a DisplayPort interface, etc.) of the device, such as live or linear content (e.g., a live feed, a livestream, a live broadcast, linear/live TV content, a live/linear TV program or channel, etc.). The systems and techniques described herein can use ACR to detect content in content signals in real-time or near real-time. The systems and techniques described herein can use the detected content to determine whether to retarget a user of the device with content associated with the detected content and/or determine which content to provide to the user. In some cases, the systems and techniques described herein can compare the detected content with targeted content available for users. If the detected content matches or has a threshold similarity or relevance to any targeted content item from the available targeted content, the systems and techniques described herein can use the targeted content item to retarget the user (or a version thereof). The systems and techniques described herein can determine or select to retarget the user with content determined based on the detected content (or with the detected content or a version thereof) in real-time or near real-time. Moreover, the systems and techniques described herein can create user segments in real-time (or near real-time). The user segments can be used to retarget users in the user segment with content.

In some cases, the systems and techniques described herein can use ACR to detect the content in a content signal and determine whether one or more retargeting conditions are satisfied with respect to a user associated with a device playing, streaming, receiving, processing, and/or displaying the content in the content signal. For example, the systems and techniques described herein can use ACR to detect targeted content in a content signal, and monitor the content signal and any inputs or activity at the device to determine whether one or more retargeting conditions are satisfied with respect to a user of the device. In some examples, to determine whether the one or more retargeting conditions are satisfied, the systems and techniques described herein can monitor the content signal and associated activity/inputs to determine whether the user skipped or closed the detected content, declined to watch the detected content, watched the detected content (e.g., allowed the detected content to play without skipping, interrupting, or closing the detected content), interacted with the detected content, provided an input indicating an interest or disinterest in the detected content, was inactive or disengaged during playback/presentation of the detected content (e.g., based on user inactivity, a timeout event, unresponsiveness to a prompt or a content requesting or expecting an input, etc.), showed interest in the detected content, etc.

Since users who consumed (e.g., watched, played, etc.), interacted with, engaged with, and/or showed interest in and did not skip or ignore a content item are more likely interested in such content item than users who skipped, ignored, closed, did not consume, or did not interact or engage with such content item, by retargeting users who consumed, interacted with, engaged with, showed interest in, did not skip, and/or did not ignore the detected content with content determined based on the detected content (e.g., the same content as the detected content, a different or modified version of the detected content, content associated with the detected content, etc.), the systems and techniques described herein can increase the targeting results and/or outcomes of the retargeted content. If the retargeted content includes invitational content, such as an advertisement, providing the retargeted content to such users can increase the likelihood of a user conversion associated with the invitational content.

By analyzing content (e.g., live content feeds, streams, broadcasts, etc.) in real-time using ACR and monitoring the content and user inputs/activity, the systems and techniques described herein can efficiently detect targeted content in the content and create user segments in a timely manner for retargeting content to, such as content associated with the detected targeted content, and make retargeting actions and/or decisions faster (e.g., in real-time or near real-time). For example, by analyzing content (e.g., live video feeds, streams, or broadcasts) using ACR in real-time or near real-time, the systems and techniques described herein can detect targeted and create retargeting user segments in real-time or near real-time (e.g., as users consume the content, as client devices play or display the content, etc.). The systems and techniques described herein can use the user segments to retarget content to selected users. In some examples, the systems and techniques described herein can allow an advertiser or provider to retarget users in a timely manner based on a determination that one or more retargeting conditions are satisfied (e.g., the content matches targeted content available; the users watched, interacted with, engaged with, or indicated an interest in the content; a retargeting cue; etc.).

The systems and techniques described herein can use the ACR on a content platform(s) to detect, in real-time (or near real-time), targeted content in content signals, such as advertisements in linear/live TV channels, feeds, or broadcasts consumed by users. The systems and techniques described herein can use the content detection results to generate targeted or hyper-targeted user segments, such as data management platform (DMP) segments, based on the content signals (e.g., linear/live TV content/signals) and use such segments to retarget with content associated with the detected content (and/or content experiences). For example, the systems and techniques described herein can retarget users in a segment with interactive experiences associated with a same or different content, brand, product, service, message, and/or advertisement as a content detected in a content signal.

To illustrate, the systems and techniques described herein can use ACR to detect an advertisement in a video streamed, played, or displayed by devices associated with a set of users. The systems and techniques described herein can identify (e.g., in real-time or near real-time) whether the advertisement matches targeted content available from one or more sources, and select the advertisement for retargeting or use in determining retargeting content if the advertisement matches any of the targeted content. In some cases, the systems and techniques described herein can additionally or alternatively select users for retargeting with a same or different advertisement. The users can include users who watched the advertisement in the video, interacted with the advertisement, did not skip the advertisement, replayed the advertisement, showed interest in the advertisement, were engaged by the advertisement, engaged in certain activity or inactivity during presentation of the advertisement, and/or demonstrated a threshold interest or likelihood of interest in the advertisement.

The systems and techniques described herein can create a user segment (e.g., in real-time or near real-time) including the selected users. The user segment can represent an audience of users to retarget with content associated with the advertisement, such as a version of the advertisement, the advertisement configured in a different advertisement unit, the advertisement configured to provide a different experience, a different advertisement determined or generated based on the advertisement, etc. The systems and techniques described herein can subscribe the users in the user segment to the retargeted advertisement, and provide the retargeted advertisement to such users. As previously noted, the term “retargeted” as used in “retargeted advertisement” can but does not necessarily mean that such advertisement was previously targeted to such users (or any users). In other words, retargeted does not necessarily mean targeted again. Instead, the term retargeted is used herein to mean targeted or provided to retargeted users (e.g., users being targeted/retargeted with content) or provided as part of a user retargeting action or process. Thus, the retargeted advertisement can include an advertisement provided as part of a user retargeting action or process, irrespective of whether such advertisement has been previously targeted to the users (or any other users) or is the same or different as an advertisement previously targeted to the users.

In some cases, the systems and techniques described herein can retarget users in a user segment with an advertisement using a different type of advertisement unit than an advertisement unit associated with an advertisement detected in a content signal (e.g., a live video, etc.), such as an advertisement used to select the users for retargeting and/or used to determine the retargeting advertisement. For example, if an advertisement detected in a live video is an interstitial advertisement, the retargeting advertisement provided to users selected for retargeting based on one or more retargeting conditions satisfied with respect to the users and the interstitial advertisement can be configured in a different advertisement unit, such as a banner advertisement, an overlay advertisement, a rewarded video advertisement, an in-stream video advertisement, a text advertisement, a display advertisement, a native advertisement, a native advertisement, an offerwall, a skippable or non-skippable advertisement, a playable advertisement, a rewarded advertisement unit, a bumper advertisement, an outstream advertisement, or any other type of advertisement unit. The systems and techniques described herein can retarget the users with the retargeting advertisement within a different portion of the live video and/or within any other content, such as a page or screen of a platform/application, within a different video, within a user interface, within an image, within a content item, within a different content signal, etc.

In some cases, the systems and techniques described herein can retarget users with a modified version of a content item detected in a content signal. The modified version can include a content item configured to provide a different experience than the detected content item. For example, if the detected content item is an image advertisement a product and configured to include a link to purchase the product, the retargeting content can include a video showing how to use the product and optionally include a link to a destination associated with the product, such as a page to purchase the product, a website of the maker or seller of the product, another video of the product, a game associated with the product, a social media post associated with the product, etc.

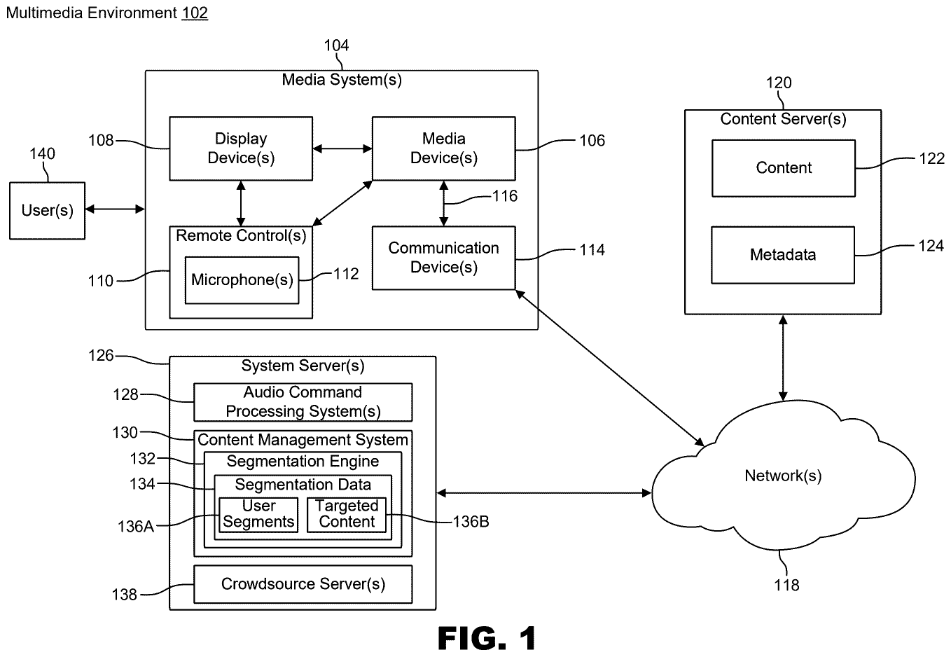

Embodiments and aspects of the disclosure may be implemented using and/or may be part of multimedia environment 102 shown in FIG. 1. However, multimedia environment 102 is provided for illustrative purposes and is not limiting. Examples and embodiments of this disclosure may be implemented using, and/or may be part of, other environments that are different from and/or in addition to multimedia environment 102, as will be appreciated by persons skilled in the art(s) based on this disclosure. An example of multimedia environment 102 shall now be described.

### Example Multimedia Environment

FIG. 1 illustrates a block diagram of an example multimedia environment 102, according to some examples of the present disclosure. In some non-limiting examples, multimedia environment 102 may be directed to media content, such as streaming media, live media content (e.g., live media broadcasts, streams, etc.), pre-recorded/on-demand content (e.g., movies, television (TV) shows, podcasts, audiobooks, video games, videos, video clips, images, etc.), animated content, media content channels, media content platforms and/or services, TV media and/or environments, online media content, invitational content (e.g., advertisements, etc.), media applications, etc. However, this disclosure is applicable to any type of content (instead of or in addition to media content), as well as any mechanism, means, protocol, method, system, apparatus, and/or process for distributing, accessing and/or consuming (e.g., playing, displaying, watching, streaming, etc.), and/or interacting with media content, targeting or retargeting content to users, and/or implementing any of the systems and techniques described herein.

Multimedia environment 102 can include a media system(s) 104. The media system(s) 104 can include one or more media systems. Each media system can include and/or represent a scene, an environment, a room (e.g., family room, a conference room, an entertainment room, a bedroom, etc.), a kitchen, a yard (e.g., a backyard, a front yard, a patio, etc.), a theatre (e.g., a home theatre, a movie theatre, etc.), a classroom, a library, a vehicle (e.g., a car, a boat, a bus, etc.), a plane, a stadium, an auditorium, a park, a bar, a home, a restaurant, an office, a garage, a commercial building, a campus or campus building, a gymnasium, a store, a facility, an entertainment center, a community center, or any other location or space where media content, such as live and/or streaming content, can be (and/or may be desirable to) access, receive, play display, stream, etc. A user(s) 140 may select, access, consume, and/or interact with content from, using, and/or at the media system(s) 104. The user(s) 140 can include or represent one or more users.

The media system(s) 104 may include a media device(s) 106. The media device(s) 106 can include a display device(s), such as a display screen, and/or can be coupled to a display device(s), such as display device(s) 108. The media device(s) 106 can include one or more media devices. The display device(s) 108 can include one or more display devices and/or media devices. In some examples, each media device of the media device(s) 106 and each device of the display device(s) 108 can be coupled to a respective display (or multiple displays). It is noted that terms such as “coupled,” “connected to,” “attached,” “linked,” “combined” and similar terms may refer to physical, electrical, magnetic, logical, etc., connections, unless otherwise specified herein.

The media device(s) 106 may be, include, or represent one or more media devices, media streaming devices, DVD devices, BLU-RAY devices, audio/video playback devices, cable boxes, gaming systems, televisions, head-mounted display (HMD) devices, set-top boxes, video display devices, online media content devices, and/or digital video playback and/or recording devices, to name a few non-limiting examples. Display device(s) 108 may include, implement, or be part of one or more monitors, TVs, desktop computers, laptop computers, mobile phones (e.g., smartphones), tablet computers, wearable devices (e.g., smartwatches, HMDs, smart glasses, etc.), screens, appliances, internet-of-things (IoT) devices, single-board computers (SBCs) or system-on-chips (SoCs), and/or projectors, to name a few non-limiting examples. In some examples, the media device(s) 106 can be a part of, integrated with, operatively coupled to, and/or connected to one or more display devices, such as the display device(s) 108.

The media device(s) 106 may be configured to communicate with network(s) 118 via a respective communication device from the communication device(s) 114. The communication device(s) 114 may include, for example, one or more cable modems, routers, antennas, access points, gateways, transceivers (e.g., satellite TV transceivers, cellular transceivers, etc.), etc. The media device(s) 106 may communicate with the communication device(s) 114 over a link 116. The link 116 may include one or more wireless (e.g., WiFi, cellular, etc.) and/or wired connections.

The network(s) 118 can include one or more public networks (e.g., Internet Service Provider (ISP) networks, core or backbone networks, cloud networks, the Internet, etc.), private networks (e.g., local area networks, private cloud networks, on-premises networks, private wide area networks, etc.), wireless networks (e.g., WiFi networks, cellular networks, satellite networks, etc.), and/or wired networks (e.g., Ethernet networks, fiber optic networks, etc.). In some examples, the network(s) 118 can include, for example and without limitation, wired and/or wireless intranet, extranet, Internet, cellular, Bluetooth, infrared, cloud, short range, long range, local, regional, and/or global communications mechanism, means, approach, protocol, environment, system, datacenter, and/or network, or any combination(s) thereof.

Media system(s) 104 may include a remote control(s) 110. The remote control(s) 110 can be, include, or represent any component, application, system, part, apparatus and/or method for controlling and/or interacting with the media device(s) 106 and/or display device(s) 108, such as a remote control, a touchscreen, a remote control application, a computer (e.g., a tablet computer, a laptop computer, a desktop computer, etc.), a mobile phone (e.g., smartphone), a wearable control or remote, on-screen controls, integrated control buttons, audio controls, a peripheral input device, or any combination thereof, to name a few examples. In some examples, the remote control(s) 110 can wirelessly communicate with the media device(s) 106 and/or display device(s) 108 using cellular, Bluetooth, infrared, WIFI, WIFI direct, and/or any other wireless communication system, technology, mechanism, means, protocol, component, and/or apparatus or any combination thereof. In some cases, the remote control(s) 110 can include a microphone(s) 112, which can be used to record audio, such as audio inputs (e.g., verbal inputs, speech inputs, voice inputs, input utterances, etc.) as further described below.

The multimedia environment 102 may include content server(s) 120. Content server(s) 120 can include, implement, and/or represent one or more content servers. Although only one content server is shown in FIG. 1, in practice, the multimedia environment 102 may include any number of content servers. In some cases, content server(s) 120 can additionally or alternatively include, implement, and/or represent one or more content providers, content storage systems, content channels, content platforms, content networks, distributed content systems, cloud content systems/providers, content producers, advertisers, content services, and/or content sources.

The content server(s) 120 may be configured to communicate with the network(s) 118. The content server(s) 120 may store content 122 and metadata 124. Content 122 may include music, videos, movies, video games, TV shows, TV programs, multimedia, images, still pictures, text, graphics, gaming applications, advertisements, programming content, live content (e.g., live broadcasts, live streams, etc.), pre-recorded or on-demand content, public service content, government content, local community content, targeted content, software, any other content or data objects in electronic form, and/or any combination of thereof. In some examples, content 122 can include video frames, videos (e.g., sequences of video frames), content packages (e.g., highlight videos, video reels, custom videos, recorded videos, video broadcasts, televised videos, uploaded videos, etc.), user preferences, audio content (e.g., audio assets or files, audio signals, audio recordings, audio transmissions, etc.), text content (e.g., closed captions, subtitles, text transcriptions, intertitles, superimposed text, onscreen text, text documents, text messages, etc.), logged content, content statistics, user profiles, targeted content (e.g., targeted videos, targeted advertisements, targeted invitational content items, targeted image content, targeted recorded content, etc.), and/or any other content or data described herein.

In some examples, metadata 124 can include data about content 122. For example, metadata 124 may include associated or ancillary information such as information indicating or related to a content writer, director, producer, composer, artist, actor, summary, chapter, production, history, year, trailer, alternative version, related content, application, provider, advertiser, host, sponsor, source, owner, setting, attribute, description, control data, tag, header, container, and/or any other information associated with, pertaining to, relating to, and/or corresponding to the content 122. Metadata 124 may also or alternatively include links to any such information. Metadata 124 may also or alternatively include one or more indexes of content 122, such as but not limited to a trick mode index.

The multimedia environment 102 may include system server(s) 126. The system server(s) 126 may include or represent one or more servers, data centers, systems, distributed server systems, server components, etc. The system server(s) 126 may operate to support the media device(s) 106 and/or the display device(s) 108 from a remote location(s) and/or network(s), such as a cloud or remote network(s), a backend system(s), a data center(s), a server(s), etc. The structural and functional aspects of the system server(s) 126 may wholly or partially exist in the same or different system servers.

In some examples, the system server(s) 126 may include, host, operate, and/or implement audio command processing system(s) 128, content management system 130, and/or crowdsource server(s) 138. The audio command processing system(s) 128 can process audio data such as speech/voice inputs and/or commands, audio/speech in videos, etc. For example, as noted above, the remote control(s) 110 may include a microphone(s) 112 that can receive audio data from user(s) 140 (as well as other sources, such as the display device(s) 108). In some examples, the media device(s) 106 may be audio responsive, and the audio data may represent verbal commands from the user(s) 140 to control the media device(s) 106 as well as other components in the media system(s) 104, such as the display device(s) 108. In some examples, the audio data received by the microphone(s) 112 in the remote control(s) 110 can be transferred to the media device(s) 106, which can then be forwarded to the audio command processing system(s) 128 for processing. The audio command processing system(s) 128 may process and analyze the received audio data to recognize any verbal commands or inputs from the user(s) 140. The audio command processing system(s) 128 may forward the verbal commands or inputs (or associated signals or instructions) to the media device(s) 106 for processing and/or implementation.

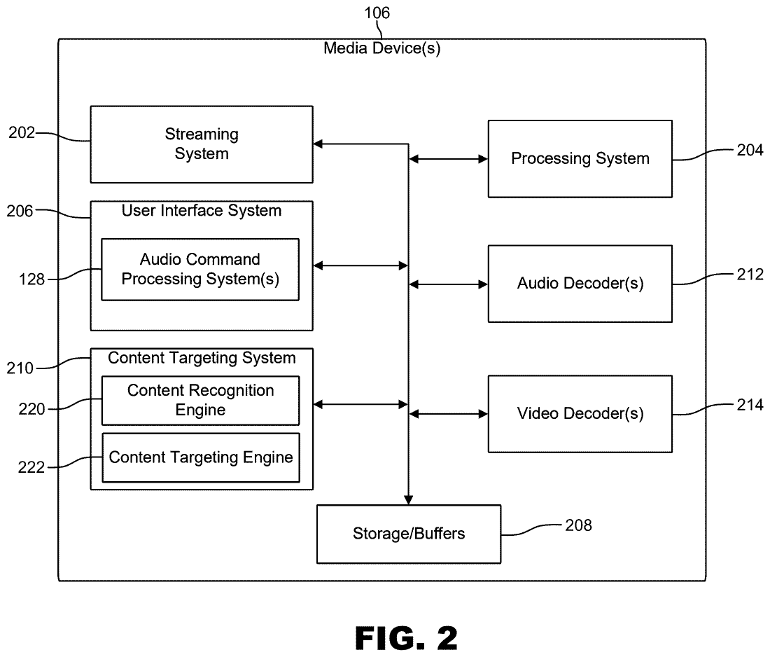

In some examples, the audio data may be alternatively or additionally processed and analyzed by a copy or version of audio command processing system(s) 128 in media device(s) 106 (see FIG. 2). The audio command processing system(s) 128 in the system server(s) 126 and/or the media device(s) 106 can process any audio data, such as audio recorded by the microphone(s) 112. In some cases, the audio command processing system(s) 128 can include, perform, or implement automatic speech recognition (ASR), natural language processing (NLP), natural language understanding (NLU), natural language generation (NLG), text-to-speech generation, etc.

The system server(s) 126 can also include, implement, and/or host a content management system 130. The content management system 130 can include one or more servers, applications, computers, software containers, virtual machines (VMs), microservices, runtime environments, software models (e.g., artificial intelligence (AI) and/or machine learning (ML) models/networks, algorithms, etc.), data centers, computing components, processors, compute resources, and/or computing systems. The content management system 130 can be used to target, retarget, and/or manage the targeting or retargeting of users with content and/or content to users. In some examples, the content management system 130 can include a segmentation engine 132 that generates, hosts, and/or manages segmentation data 134 used to target and/or retarget users with content and/or content to users. The segmentation engine 132 can include one or more servers, applications, computers, software containers, VMs, microservices, runtime environments, software models (e.g., AI and/or ML models/networks, algorithms, etc.), data centers, computer components, processors, compute resources, and/or computing systems.

The segmentation data 134 can include user segments 136A and targeted content 136B associated with the user segments 136A. Each of the user segments 136A can include users selected to be targeted or retargeted with content from or identified in the targeted content 136B. The segmentation engine 132 can generate the user segments 136A for targeting or retargeting with the targeted content 136B, as further described herein. The targeted content 136B can include content targeted and/or retargeted to users and/or content selected, customized, designed, and/or used for targeting and/or retargeting to users. In some cases, the targeted content 136B can include any of the content 122 from the content server(s) 120. In some cases, the targeted content 136B can include any other content, such as content generated by the content management system 130, content obtained from another content source (e.g., another server(s), a content provider(s), the Internet, a repository, a storage system, a distributed storage system, a cloud, etc.), etc. The content management system 130 can subscribe each user segment and/or the users in each user segment to respective content from or identified in the targeted content 136B associated with that user segment. The content management system 130 or the content server(s) 120 can deliver targeted content to the devices of the users in a user segment associated with the targeted content for presentation to the users, or can trigger the devices of the users to stream, display, play, retrieve, and/or render the targeted content for the users.

Alternatively, the content management system 130 or the content server(s) 120 can use the user segments 136A to identify which users (and/or associated devices) should receive what content from or identified in the targeted content 136B, and deliver the corresponding content to the devices of users selected to receive that content based on the user segments 136A. The targeted content 136B can include, for example and without limitation, videos (e.g., movies, TV shows, video clips, video recordings, video streams, animated videos, etc.), images, audio content, invitational content items (e.g., advertisements, etc.), video games, media content, content experiences, interactive content, customized content, software and/or media applications, digital objects, and/or any other media and/or digital/electronic content.

The content management system 130 can target/retarget users in the user segments 136A with content in or identified by the targeted content 136B. In some examples, the content management system 130 can retarget the user(s) 140 with targeted content determined based on content detected by the media device(s) 106 or display device(s) 108 in a content signal, such as a live video, livestream, live broadcast, live/linear TV channel, live/linear TV program, live/linear TV broadcast, a pre-recorded video, etc. In some cases, the content management system 130 can determine whether content detected in a content signal should trigger certain users to be retargeted with the detected content or content determine based on the detected content based a comparison of the detected content with content in or identified by the targeted content 136B. If the detected content matches or has a threshold similarity or relevance to a targeted content item in or identified in the targeted content 136B, the content management system 130 can determine or select to retarget the content associated with the detected content to certain users. In some cases, the content management system 130 can additionally or alternatively retarget selected users with any targeted content, such as content identified as targeted content based on a recognition result (e.g., an ACR result) and/or a determination that the content includes one or more attributes, cues, tags, metadata items, data, and/or objects used to identify/recognize the content as targeted content and/or select the targeted content for retargeting.

In some examples, the content management system 130 can match or compare content detected in content signals with targeted content items in or identified in the targeted content 136B based on a signature of the detected content and respective signatures of the targeted content items in or identified in the targeted content 136. For example, the content management system 130 can compare a signature of the detected content with respective signatures of the targeted content items in or identified in the targeted content 136B, and select a targeted content item matching or having a similarity or relevance to the detected content for retargeting to selected users if the signature of the detected content matches a signature from the respective signatures of the targeted content items in or identified in the targeted content 136B or the signature of the detected content has a threshold similarity or distance to the signature from the respective signatures. In some cases, the signature of a content item can be generated (e.g., by the content management system 130, the content server(s) 120, the media device(s) 106, the display device(s) 108, and/or any other device) based on a content (or portion thereof), attribute(s), metadata, configuration, tag(s), pattern(s), object(s), and/or cue(s) in or of the content item. For example, to generate a signature of the content item, a hash function can be applied to a content (or a portion thereof), attribute(s), metadata, configuration, tag(s), pattern(s), object(s), and/or cue(s) in or of the content item.

The segmentation engine 132 can create, host, control, modify, configure, and/or manage user segments 136A used to target or retarget with content from or identified in the targeted content 136B and/or selected to be targeted or retargeted with content from or identified in the targeted content 136B. Each user segment can include users selected, matched with, and/or subscribed to receive specific content from or identified in the targeted content 136B. The targeted content associated with a user segment (also referred to herein as a “segment”, a “targeting segment”, a “targeting user segment”, a “data management platform segment”, or a “customer data platform segment”) can be or include content tailored/customized, selected, and/or targeted/retargeted for/to users, such as users in the user segment.

In some examples, the segmentation data 134 generated by the segmentation engine 132 can associate or match each of the user segments 136A with targeted content in or identified in the targeted content 136B. The targeted content associated with a user segment can be delivered (e.g., provided, presented, streamed, broadcast, transmitted, targeted, retargeted, etc.) to the users (e.g., to associated devices) in the user segment. For example, the segmentation engine 132 can create a user segment for a targeted content item. The user segment can include users selected for targeting or retargeting with the targeted content item. The content management system 130 can subscribe the users in the user segment to the targeted content item and/or configure the targeted content item to be delivered to devices associated with the users in the user segment. The content management system 130, the content server(s) 120, and/or another content source(s) can deliver the targeted content item to the devices of the users in the user segment. In some cases, the content management system 130 can instruct the content server(s) 120 to deliver the targeted content item to the devices of the users in the user segment, instruct the devices of the users to obtain the targeted content item from the content server(s) 120 or the content management system 130, and/or instruct the devices to play and/or display the targeted content item for the users.

In some examples, the segmentation engine 132 can identify or select users to target or retarget with a targeted content item, and create a user segment for the targeted content item. The user segment can include users selected to be targeted or retargeted with the targeted content item. The content management system 130 can subscribe the user segment, the users in the user segment, or the devices of the users in the user segment to receive the targeted content item. The content management system 130 or the content server(s) 120 can deliver the targeted content item to the devices of the users in the user segment. The devices can then play or display the targeted content item for the users. For example, the segmentation engine 132 can select the user(s) 140 to retarget with a targeted content item based on content detected by the media device(s) 106 associated with the user(s) 140 within a content signal streamed, received, played, and/or displayed by the media device(s) 106. The segmentation engine 132 can include the user(s) 140 in a user segment associated with the targeted content item. The content management system 130 can then deliver the targeted content item to the media device(s) 106 associated with the user(s) 140, trigger or instruct the content server(s) 120 to deliver the targeted content item to the media device(s) 106 associated with the user(s) 140, subscribe the user(s) 140 (and/or the media device(s) 106 associated with the user(s) 140) to receive the targeted content item, and/or trigger or instruct the media device(s) 106 to display/play the targeted content item from the user(s) 140 and/or obtain the targeted content item for presentation to the user(s) 140. This way, the content management system 130 can target or retarget the user(s) 140 with the targeted content item.

The segmentation engine 132 can create segmentation data 134, including user segments 136A associated with targeted content 136B, based on one or more targeting conditions and/or a determination that one or more targeting conditions are satisfied with respect to the users and/or targeted content 136B. The one or more targeting conditions and/or a determination that the one or more conditions are satisfied/met can include and/or be based on targeting information and/or cues. For example, the one or more targeting conditions and/or a determination that the one or more targeting conditions are satisfied/met can include a determination that a content item detected in a content signal played, streamed, or displayed by a device (e.g., the media device(s) 106, the display device(s) 108, etc.) matches a targeted content item in or identified by the targeted content 136B, an indication or determination that a user associated with the device watched the content item, has a threshold interest in (or likelihood of interest in) or preference for a content item (e.g., the detected content) or content category/type, interacted (or had a type of interaction with) the content item, has a number of content interactions or a type(s) of content interactions associated with the content item (or associated content), had a certain reaction or is predicted to have a certain reaction to the content item, provided a content rating associated with the content item, has a predicted interest in or preference for the content item, has a user preference or statistic that has a threshold match or alignment with the content item (or an associated characteristic), indicated or demonstrated an interest or liking of the content item, and/or any other matching or selection criteria for associating the with the content item. In some cases, the one or more targeting conditions and/or satisfaction of the one or more targeting conditions can include and/or can be determined based on targeting information and/or cues.

The targeting information and/or cues can include, for example and without limitation, matching results between content detected in content signals and targeted content associated with the targeted content 136B, user profiles, user activity, content statistics, user inputs (e.g., content requests, content interactions, content “likes”, content feedback, content playback, content playback counts, user comments, content ratings, etc.), content consumption data associated with the users (e.g., data indicating what content items and/or categories of content items the users have subscribed to, consumed (e.g., played, watched, interacted with, etc.), ignored, skipped, replayed, requested, positively or negatively rated (e.g., based on “likes”, comments, input ratings, etc.), etc.), content patterns associated with the users (e.g., content playback counts, content views, content interactions, content skips, content forwards, content replays, content trends and/or content category trends, content activity or inactivity, etc.), user preferences, cues indicative of content preferences and/or engagement (e.g., user inactivity during playback/presentation of content which can indicate user engagement if the content does not include user input prompts or interactive content or user disengagement (lack of user engagement) if the content includes input prompts or interactive content, user activity during playback/presentation of content which can indicate user engagement if the activity includes interactions or enabled/allowed/expected/solicited interactions with the content or disengagement if the activity includes interactions with other content or interactions with a portion of the content that does not allow/expect/solicit interactions such that the interactions may indicate user boredom or lack of engagement, content playback or playback counts, content replays, content skips, content requests, content subscriptions, content blocks, etc.), user characteristics (e.g., demographics, etc.), content characteristics, and/or other information about the content, users, user activity, and/or user/content statistics, patterns, interests, or trends.

The content management system 130 can retarget a user segment with targeted content that was previously delivered (e.g., streamed, transmitted, targeted, etc.) to the users in the user segment or different targeted content such as different targeted content determined based on the targeted content, a different version of the targeted content, different targeted content that has a same or similar attribute(s) as the targeted content (e.g., a same or similar content type, content category, content provider, content design or style, content source, content characteristic, content producer, semantic content, content experience, content format, content configuration, content setting, content message, content object, content franchise, content topic, content genre, content brand, etc.). For example, if a set of users is targeted with a targeted content item, the content management system 130 can retarget the targeted content item or a different targeted content item to a subset of the users selected to be retargeted with content (e.g., retargeted with the targeted content item or a different content item). The subset of users can represent a user segment from the user segments 136A. The segmentation engine 132 can identify the subset of users based on the users who watched the targeted content, respective user reactions to the targeted content, user activity (or lack thereof) during playback/presentation of the targeted content, user preferences, user demographics, user interactions with the targeted content, cues indicating user interest in the targeted content, user inputs, user feedback, content characteristics, content statistics, content trends or patterns of the users, and/or any other targeting information and/or cues.

For example, the media device(s) 106 can play, stream, or display content that includes a targeted content item. The media device(s) 106 can analyze the content using automatic content recognition (ACR). The media device(s) 106 can use the ACR to detect the targeted content item in the content. The media device(s) 106 can determine whether the user(s) 140 should be retargeted with content based on the targeted content item detected (and any user or device activity (or lack thereof) associated with the targeted content item) or whether to notify the content management system 130 of a retargeting event. The retargeting event can include a detection of the targeted content item, a retargeting decision, and/or a detection of retargeting information. In some examples, the retargeting decision can be based on the retargeting information, and the retargeting information can include an indication or determination that the user(s) 140 played the targeted content item, interacted with the targeted content item, did not skip the targeted content item, likely watched the targeted content item (e.g., based on user activity or lack thereof), liked or estimated to have a threshold interest in the targeted content item (e.g., based on a user comment, feedback, “like”, subscription, activity, conversion action/attempt, interaction, inactivity, etc.), was likely engaged by the targeted content item (e.g., based on user activity or inactivity, user inputs, user interactions, etc.), did not ignore the targeted content item, and/or has preferences/interests that match or align with (or have a likelihood of matching or aligning with or having a threshold match or alignment with) the targeted content item (or characteristics thereof). The media device(s) 106 can report such event/information to the content management system 130 (e.g., to the segmentation engine 132) or instruct the content management system 130 (e.g., the segmentation engine 132) to add the user(s) 140 associated with the media device(s) 106 to a user segment selected to be retargeted with content based at least in part on the targeted content item detected, and/or to subscribe the user(s) 140 to the user segment.

In response, the segmentation engine 132 can create the user segment (if not already created/started) and add the user(s) 140 to the user segment. The user segment can include the user(s) 140 and other users selected to be retargeted with specific content. The user segment can be retargeted with content by the content management system 130, the content server(s) 120, or the respective devices of the users in the user segment. In some examples, the users (and/or associated devices) in the user segment can be retargeted with the same targeted content item as the targeted content item detected in the content signal. In other examples, the users (and/or associated devices) in the user segment can be retargeted with different content or a different or modified version of the targeted content item. For example, the users (and/or associated devices) in the user segment can be retargeted with the content of the targeted content item provided in, configured to include, and/or presented according to a different medium, configuration, format, environment, content behavior, stylization, visual appearance, attribute, experience, etc. To illustrate, if the targeted content item is an advertisement presented in a particular advertisement format or advertisement unit, the user segment can be retargeted with the advertisement configured in a different advertisement format or unit. Non-limiting examples of advertisement units and formats that can be used to target or retarget advertisements can include banner advertisements, interstitial advertisements, rewarded interstitials, rewarded advertisements, native advertisements, interactive advertisements, mobile banners, display banners, video advertisements, image advertisements, in-feed video advertisements, outstream advertisements, skippable or non-skippable advertisements, bumper advertisements, overlay advertisements, slider advertisements, offerwall advertisement units, playable advertisement units, responsive advertisements, text advertisements, etc.

As another example, if the targeted content item is a content of a video game, the user segment can be retargeted with different content in the video game or a different video game, such as another video game in a same video game franchise, another video game from a same developer or source, another video game in a same video game category, another video game with a same character(s), another video game associated with a same topic, another video game that has a threshold similarity or relevance to the video game, another video game in a video game collection or sequence, a different version of the video game, etc.

The content management system 130 can retarget users with content and/or content to users in order to increase user engagement, increase conversion rates, improve targeting performance, improve targeting outcomes, increase user interest in content, improve user experiences, provide better and/or more granular targeting, increase brand loyalty, increase user retention, and/or optimize user targeting. For example, as previously explained, certain user activity, interactions, inputs, and/or responses can indicate an interest in, preference for, engagement with, and/or receptiveness to a targeted content item. Retargeting users who watched the targeted content item or have shown interest in (or a likelihood of interest in), an indicia of interest in, preference for, engagement with, interactions with, and/or receptiveness to the targeted content item with content associated with the targeted content item (e.g., the same content, a different version of the same content, content, content having a threshold similarity or relevance to the targeted content item, etc.) may be more likely to produce better targeting results and/or outcomes than retargeting the content item or another content item to all users or a set of users that includes users who did not watch, show interest in, preference for, engagement with, and/or receptiveness to the targeted content item and/or who skipped, ignored, closed, showed a lack of interest in, preference for, engagement with, and/or receptiveness to the targeted content item. Accordingly, the users who did not skip, did not ignore, did not close, or who watched, showed or indicated interest in, preference for, engagement with, and/or receptiveness to the targeted content item can be retargeted with the targeted content item, a version (e.g., a different or modified version) of the targeted content item, similar or relevant content, or any other content determined based on the targeted content item. The retargeted content (also “retargeting content) can be delivered to devices associated with users in a user segment that includes such users. Moreover, the retargeted content can be provided to such devices in a same or different format, configuration, medium, attribute, behavior, environment, experience, etc., as the targeted content item.

In some cases, the segmentation engine 132 can create the user segments 136A (e.g., to add users to the user segments 136A and associate the user segments 136A with respective content) based on events and/or information reported by the devices associated with the users in the user segments 136A. In some examples, the events can include detection events (e.g., detection of content included a content signal, detection of device operations or activity, etc.), user activity events (e.g., watching content in a content signal, playing or replaying the content, interacting with the content, starting a conversion action associated with the content, etc.), user input events (e.g., inputs “liking” the content, commenting on the content, rating the content, sharing the content, saving the content, subscribing to the content, responding to a prompt in the content, providing an input, etc.), inactivity events, matching events (e.g., matching the content with content in or identified in the targeted content 136B, matching the content with a user preference or interest, etc.), etc. In some cases, the information reported by the devices can include information used to add or determine to add a user to a user segment, a request to include the user in the user segment, a retargeting decision, a retargeting cue, a retargeting condition, etc.

In some cases, the device associated with the user(s) 140 (e.g., the media device(s) 106, the display device(s) 108) can notify the segmentation engine 132 of a targeting event, a detection event, a determination that the user(s) 140 should be added to a user segment, a determination (e.g., based on an ACR result) that a content (e.g., a video, stream, broadcast, etc.) presented by the device includes targeted content, a determination that the user(s) 140 did not skip the targeted content, watched the targeted content (e.g., as determined based on a user interaction, user activity, user inactivity, a user input or type of user input received at a given time within a presentation timeline or in response to a certain content or prompt, etc.), interacted with the targeted content, requested the targeted content (or retargeting of the targeted content), provided a feedback or input associated with the targeted content (e.g., a comment, a subscription request, a “like”, a rating, a replay input, an input maximizing or increasing a size of the targeted content, an input moving the targeted content to a certain location in a screen such as a foreground, etc.), did not provide a certain input (e.g., a lack of a “dislike”, a lack of a negative rating or comment, a lack of an input closing or skipping the targeted content, etc.), had a certain user activity or inactivity during playback/presentation of the targeted content, etc.

In some examples, the media device(s) 106 and/or the display device(s) 108 can detect respective content played/displayed by the media device(s) 106 and/or the display device(s) 108, such as targeted content, and detect targeting information and/or cues that the media device(s) 106 and/or the display device(s) 108 can use to determine whether the user(s) 140 should be retargeted with content, such as the targeted content or different content. For example, the media device(s) 106 can use ACR to detect/recognize content included in a content signal played/displayed by the media device(s) 106. The media device(s) 106 can then determine whether the one or more retargeting conditions were satisfied with respect to the user(s) 140 and the detected content, and determine whether the user(s) 140 should be retargeted with content based on the determination whether the one or more retargeting conditions were satisfied. For example, the media device(s) 106 can determine that the user(s) 140 should be retargeted with content based on a determination that the detected content in the content signal matches a targeted content item in or identified in the targeted content 136B, a determination that the user(s) 140 watched (or likely watched) the detected content, a determination that the user(s) 140 did not skip/close or ignore the detected content, a determination that the user(s) 140 played or replayed the detected content, a determination that the user(s) 140 interacted or engaged with the detected content, and/or a determination that one or more additional retargeting conditions are satisfied with respect to the user(s) 140 and the detected content.

Non-limiting examples of retargeting conditions can include a determination that the targeted content matches content in or identified in the targeted content 136B and/or certain events such as certain user interactions with the targeted content and/or the device presenting/playing the targeted content (e.g., the media device(s) 106 and/or the display device(s) 108) during playback/presentation of the targeted content, detection of any cues or indications that the user(s) 140 played/watched the targeted content, detections of any cues or indications that the user(s) 140 did not skip or close the targeted content, detection of certain user activity during playback/presentation of the targeted content, detection of inactivity during playback/presentation of the targeted content (or during playback/presentation of a specific portion of the targeted content, such as an interactive portion, a portion containing a prompt or an input element, a non-interactive portion, or a portion lacking a prompt or input element), a targeting rule or criterion, a match (or threshold match) between the targeting content and user information (e.g., a user preference, a user characteristic, a user statistic, etc.), a detection of certain targeting information and/or cues, and/or any other targeting conditions described herein or suitable for retargeting content. In some cases, the media device(s) 106 can determine whether a retargeting condition(s) is/was satisfied/met based on any of the targeting information and/or cues described herein.

The targeting information and/or cues can include, for example and without limitation, user activity (e.g., an indication that the user watched/played the targeted content, initiated an associated conversion action, replayed the targeted content, interacted with the targeted content, responded to a prompt in the targeted content, skipped the targeted content, closed the targeted content, rewinded the targeted content, forwarded the targeted content, subscribed to the targeted content, resized or moved the targeted content, interacted with other content, etc.), user inactivity (e.g., a lack of response to a prompt or an input request, a timeout triggered by user inactivity, etc.), a user interaction and/or type of user interaction (or lack thereof) with the targeted content, a cue indicating that the user was engaged or disengaged/distracted (e.g., a user input during a portion of the targeted content that does not include a prompt or input element which can indicate that the user was distracted, a user input in a portion of the targeted content or the screen displaying the targeted content that does or does not include an input element or interactive content, etc.), a user preference, a user profile, a user characteristic (e.g., user demographics, a user location, etc.), a user input and/or type of user input (e.g., a content request, a skip or ignore request, a subscription request, a conversion input, a comment, a “like” or “dislike”, a rating, etc.), a content characteristic, user and/or content statistics, a user and/or content pattern, a user behavior, and/or any other information as further described herein.

In some cases, the media device(s) 106 or the display device(s) 108 can detect targeted content within a content or signal (e.g., a live video, stream, broadcast, transmission, etc.) played, displayed, and/or received/streamed by the media device(s) 106 or the display device(s) 108. In response to detecting targeted content within the content or signal, the media device(s) 106 or the display device(s) 108 can determine (e.g., in real-time or near real-time) whether a retargeting condition(s) associated with the targeted content is/was satisfied/met with respect to the user(s) 140 associated with the media device(s) 106 or the display device(s) 108. If the retargeting condition(s) is/was satisfied, the media device(s) 106 or the display device(s) 108 can notify the segmentation engine 132 that the retargeting condition(s) is/was satisfied/met by the user(s) 140, and the segmentation engine 132 can add the user(s) 140 to a user segment from the user segments 136A. The user segment can include users selected to be retargeted with content. In some cases, the media device(s) 106 or the display device(s) 108 can alternatively use the determination that the retargeting condition(s) is/was satisfied/met by/for the user(s) 140 to determine that the targeted content should be retargeted to the user(s) 140 or used to determine content to retarget to the user(s) 140, and send a message to the segmentation engine 132 requesting that the user(s) 140 be added to the user segment.

Alternatively, the media device(s) 106 or the display device(s) 108 can send the targeting information and/or cues associated with the user(s) 140 to the segmentation engine 132, and the segmentation engine 132 can use the targeting information and/or cues to determine whether the retargeting condition(s) is/was satisfied/met by/for the user(s) 140 and whether the user(s) 140 should be added to the user segment. The content management system 130 or the content server(s) 120 can send the retargeted content to the devices associated with the users in the user segment for presentation to the users. In other examples, the content management system 130 can subscribe the users in the user segment to the retargeted content, and the content server(s) 120 or the content management system 130 can send the retargeted content to the devices of the users subscribed to the retargeted content (e.g., the users in the user segment). In yet other examples, the content management system 130 can instruct the devices of the users in the user segment to play, present, stream, and/or render the retargeted content for the users or can subscribe the devices (or the associated users) to receive the retargeted content for presentation to the users in the user segment.

In some cases, the media device(s) 106 (or the display device(s) 108) can notify the segmentation engine 132 that the user(s) 140 should be added to a user segment associated with a targeted content item(s) from the targeted content 136B, and the segmentation engine 132 can use the notification to add the user(s) 140 to the user segment associated with the targeted content item. In other cases, rather than notifying the segmentation engine 132 that the user(s) 140 should be added to the user segment, the media device(s) 106 can provide the user information (e.g., user activity/inactivity, user interactions, user inputs, etc.) associated with the targeted content item to the segmentation engine 132, which can use the information to determine whether to include the user(s) 140 in the user segment. In some examples, the information from the media device(s) 106 can include an indication that the targeted content item was played/displayed at the media device(s) 106, liked by the user(s) 140, consumed (e.g., watched, played, interacted with, etc.) by the user(s) 140, etc. In other cases, the segmentation engine 132 can keep track of the targeted content presented at the media device(s) 106 based on content delivered to the media device(s) 106, and can determine whether the targeted content item was presented at the media device(s) 106 based on the tracked information about the content delivered to the media device(s) 106.

In some cases, the targeted content 136B can include or represent targeted content or a list of targeted content associated with the user segments 136A. The list of targeted content can identify targeted content items at the content server(s) 120 (e.g., within the content 122), retrieved (and/or stored) by the content management system 130 from the content 122 at the content server(s) 120, and/or generated by the content management system 130 based on the content 122 at the content server(s) 120. In some cases, the content management system 130 can obtain content from the content server(s) 120 and assemble content packages that include the targeted content 136B. For example, the content management system 130 can combine media content from the content server(s) 120 with targeted content to generate content packages that include media content and targeted content. The targeted content combined with the media content can include targeted content stored or generated by the content server(s) 120, content from the content server(s) 120 modified by the content management system 130 to implement targeted data and/or configurations associated with the user segments 136A, or targeted content generated by the content management system 130. An assembled content package including and/or representing targeted content can include text, graphics, audio, video, executable code, image data, content experiences, digital objects, digital content, advertisements, and/or any other digital data.

In some cases, the targeted content 136B can include invitational content designed to inform or elicit a response from the user, such as an advertisement. In some examples, the invitational content can be associated with a product or can directly or indirectly advertise a product. For example, a targeted content item can include one or more types of advertisements from one or more advertisers. Moreover, the targeted content 136B can include active invitational content. The active invitational content can include content designed to elicit a pre-defined response from a user. For example, active invitational content can include one or more types of advertisements configured to be activated (e.g., clicked), solicit information, or be converted by a user into a further action, such as a purchase or a download of an item. In some cases, the targeted content 136B can additionally or alternatively include passive invitational content. The passive invitational content can include content designed to primarily inform a user, such as a video. In some cases, a passive invitational content can include information that can lead or direct users to other targeted content including active invitational content.

In some examples, the targeted content 136B can include dynamic invitational content. The dynamic invitational content can include content that varies over time or based on user interactions. For example, dynamic invitational content can include an interactive game. In some cases, the targeted content 136B can include static invitational content that neither varies over time nor with user interactions. In some cases, a targeted content item can replace or update content in a content package previously delivered to a user device. For example, a content item can include an application that can be installed on the media device(s) 106. A retargeted content item can include targeted content that can be modified and presented to the user(s) 140 of the media device(s) 106 while the user(s) 140 interacts with the application. As another example, a content item presented at the media device(s) 106 can include media content combined with content targeted to the user(s) 140 associated with the media device(s) 106. A retargeted content item associated with the targeted content can include a modified version of the targeted content that can be presented to the user(s) 140 of the media device(s) 106 within different media content or an application.

In some examples, the targeted content 136B can include content items (or a list of content items) filtered or selected based on specific rules or criteria. For example, the targeted content 136B can include content items (or a list of content items) that are relevant to the user segments 136A and/or detected content used to create the user segments 136A (e.g., used to determine which users to retarget with content). In some cases, the targeted content 136B can include content combined according to a predefined arrangement and/or rules. The rules can specify how to select, configure, deliver, assemble, modify, and/or format targeted content for the user segments 136A. In some cases, the targeted content 136B can be based at least in part based on one or more attributes of media content from the content servers(s) 120 delivered or to be delivered to users. The one or more attributes can include, for example, a genre, a media content type or category, a content producer, a content provider, a preferred audience, a configuration attribute, a behavior attribute, a preference, an owner, a setting, a description, metadata, etc.

In some cases, the targeted content 136B can be generated and/or configured based on user characteristics. The user characteristics can include, for example, channel characteristics, demographic characteristics, behavioral characteristics, spatial-temporal characteristics, user preferences, user statistics, historical data, a user profile, content patterns or trends, user activity, a user location, a user description, etc. Channel characteristics can define a channel(s) used to deliver content to an associated user. For example, channel characteristics can include a type of electronic content, a type of device, a carrier or network provider, an application, a content platform, a media content item, a TV channel, and/or any other delivery channel. Spatial-temporal characteristics can define a location, zone, date, time, and/or any other content delivery location and/or time. Demographic characteristics can include characteristics of the users in the user segments 136A (and/or users considered for inclusion in the user segments 136A) such as age, income, gender, occupation, and/or any other user characteristics.

Behavioral characteristics can include user behaviors with respect to certain content or types of content. User characteristics can also include characteristics descriptive of a user's state of mind such as characteristics indicative of how likely a user is to like a content item, click on or convert an item of invitational content, interact with a content item, react to a content item, etc. User characteristics can be learned directly or derived indirectly from one or more sources. In some examples, user characteristic values can be collected from one or more databases, such as databases containing user registration information, user profiles, user statistics, user historical data, user preferences, user patterns, user activity logs, etc. In some cases, the content management system 130 and/or a user device (e.g., the media device(s) 106 and/or the display device(s) 108) can be configured to learn or derive user characteristics from any number of information sources. For example, the content management system 130 or media device(s) 106 can derive or infer one or more user characteristic values from user information known about a user, user information tracked, user information reported, user inputs, etc.

In some cases, the user segments 136A can include segments of users and associations between the segments and users and the targeted content 136B that should be targeted or retargeted to the users in the user segments 136A. In some examples, a user segment can be defined based on one or more user characteristics or derived from user characteristics, and can be associated with one or more targeted content items. By associating users in the user segments 136A with content from the targeted content 136B, the content management system 130 can match targeted content with users in the user segments 136A or subscribe the users to such targeted content.

The system server(s) 126 can also include a crowdsource server(s) 138. In some examples, the crowdsource server(s) 138 can cause closed captioning to be automatically turned on and/or off during streaming/presentation of a media content item, such as a given movie. For example, using information received from the media device(s) 106 (e.g., in thousands or millions of media systems), the crowdsource server(s) 138 may identify similarities and overlaps between closed captioning requests issued by different users watching a particular movie. Based on such information, the crowdsource server(s) 138 may determine that turning closed captioning on may enhance the users'viewing experience at particular portions of the movie (for example, when the soundtrack of the movie is difficult to hear), and turning closed captioning off may enhance the users'viewing experience at other portions of the movie (for example, when displaying closed captioning obstructs important or relevant visual aspects of the movie). Accordingly, the crowdsource server(s) 138 may operate to cause closed captioning to be automatically turned on and/or off during future streamings of the movie.

In some cases, the audio command processing system(s) 128, the content management system 130, and/or the crowdsource server(s) 138 can be part of, hosted at, or implemented by a same system server (or a same set of system servers) from the system server(s) 126 or different/separate system servers from the system server(s) 126. In other cases, a subset of the audio command processing system(s) 128, the content management system 130, and the crowdsource server(s) 138 can be part of, hosted at, or implemented by a same system server (or a same set of system servers), and a remaining one of the audio command processing system(s) 128, the content management system 130, and the crowdsource server(s) 138 can be implemented by a different/separate server (or set of servers). In some cases, the audio command processing system(s) 128, the content management system 130, and/or the crowdsource server(s) 138 can be distributed across multiple and/or different system servers. In some examples, the media device(s) 106 can include, implement, and/or host respective copies or versions of the audio command processing system(s) 128 and/or the content management system 130.

In some cases, the audio command processing system(s) 128, the content management system 130, and/or the crowdsource server(s) 138 can include, implement, and/or host one or more servers, computers, models and/or neural networks (e.g., AI/ML models and/or neural networks, statistical models, etc.), algorithms, software applications, software engines, software modules, software services, software code/logic, software components, processors and/or processing circuitry (e.g., central processing units (CPUs), digital signal processors (DSPs), graphics processing units (GPUs), image signal processors (ISPs), microprocessors, processor cores, system-on-chip (SOC) devices, application-specific integrated circuits (ASICs), field-programmable gate arrays (FPGAs), integrated circuits, etc.), software and/or hardware elements, and/or any other hardware and/or software components.

FIG. 2 illustrates a block diagram of an example media device, according to some examples of the present disclosure. In FIG. 2, the media device(s) 106 represents a single media device. Moreover, the media device(s) 106 in FIG. 2 may include a streaming system 202, processing system 204, storage/buffers 208, user interface system 206, and a content targeting system 210. The user interface system 206 may optionally include a respective copy or version of the audio command processing system(s) 128.

In some cases, the audio command processing system(s) 128 optionally included in the user interface system 206 in FIG. 2 can be the same as the audio command processing system(s) 128 in/from the system server(s) 126 in the multimedia environment 102 shown in FIG. 1. In other cases, the audio command processing system(s) 128 optionally included in the user interface system 206 in FIG. 2 can be a version of the audio command processing system(s) 128 in/from the system server(s) 126 in the multimedia environment 102 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of the audio command processing system(s) 128 in/from system server(s) 126 in FIG. 1.

The content targeting system 210 can monitor content received and/or presented by the media device(s) 106 and report targeting information (e.g., events, decisions, detections, cues, parameters, requests, notifications, etc.) to the content management system 130. The content targeting system 210 can include a content recognition engine 220 and a content targeting engine 222. The content recognition engine 220 and the content targeting engine 222 can be, be part of, include, implement, host, and/or represent one or more servers (e.g., hardware and/or software/virtual), software services, application/software microservices, software components (e.g., modules, functions, algorithms, etc.), neural networks, models (e.g., statistical models, AI/ML models, etc.), software containers, virtual machines, execution environments, processing systems (e.g., FPGAs, ASICs, DSPs, GPUs, SBCs, SoCs, etc.), datacenters, distributed systems, computers, software applications, algorithms, cloud networks, computer resources, and/or any other software and/or hardware component(s).

In some cases, the content recognition engine 220 and the content targeting engine 222 can be part of, hosted by, run by, and/or implemented by a same hardware and/or software system(s) and/or component(s), such as a same server(s), software component(s), virtual machine(s), model(s), application(s), service(s), code, algorithm(s), distributed system(s), data center(s), processing system(s), neural network(s), microservice(s), etc. In other cases, the content recognition engine 220 and the content targeting engine 222 can be part of, hosted by, run by, and/or implemented by different hardware and/or software systems and/or components.

The content recognition engine 220 can perform content detection/recognition (e.g., ACR) to detect content items within content signals or content received and/or presented by the media device(s) 106 and/or a video or audio/video interface of the media device(s) 106, such as an HDMI interface, a VGA interface, a USB-C interface, a DisplayPort interface, a DVI interface, etc. For example, the content recognition engine 220 can include an ACR model (e.g., AI/ML model/network), algorithm, component, system, and/or software configured to detect content in content signals, such as live or pre-recorded videos, streams, broadcasts, live/linear TV content or transmissions, etc. The content recognition engine 220 can detect content in the content signals in real-time or near real-time (e.g., as the content signals are received, streamed, displayed, played, rendered, and/or processed). In some examples, the content recognition engine 220 or the content targeting engine 222 can determine whether the detected content matches targeted content in or identified in the targeted content 136B. If the detected content matches targeted content in or identified in the targeted content 136B, the content targeting engine 222 can select the detected content as a content retargeting candidate or can select the detected content for retargeting.

The targeted content can include, for example, invitational content or advertisements, targeted or customized media content, videos, images, text, audio, interactive content, games, application content, digital objects, artwork, and/or any other digital content. The content targeting system 210 (e.g., via the content recognition engine 220 and the content targeting engine 222) can detect content within a content signal, determine whether to select a user for retargeting content associated with the detected content or notify the content management system 130 that the user should be retargeted with content, determine whether to retarget the user(s) 140 with the detected content or content determined based on the detected content, determine whether to notify the content management system 130 that the user(s) 140 is a retargeting candidate or was selected for retargeting with content, notify the content management system 130 of the detected content associated with a user selected for retargeting with content, request or indicate to the content management system 130 a content to provide to the user(s) 140 when retargeting the user(s) 140, and/or obtain targeting information and/or cues associated with the detected content in real-time (or near real-time).

In some cases, the content targeting engine 222 or the content management system 130 can use such information to determine whether to retarget the user(s) 140 associated with the media device(s) 106 with content, such as content associated with the detected content. For example, the content targeting engine 222 can select the user(s) 140 for retargeting with the detected content or content determined based on the detected content (e.g., a different version of the detected content, different content, content with a different experience or configuration, etc.), and notify the content management system 130. In some cases, the content targeting system 210 can provide information to the content management system 130 identifying the user(s) 140, the media device(s) 106, and/or any content detected in the content signal and/or selected for delivery to the user(s) 140 when retargeting the user(s) 140. For example, the content targeting system 210 can send a message to the content management system 130 requesting that the user(s) 140 be retargeted with content determined based on content detected in a live signal/content, requesting that the user(s) 140 be added to a user segment representing users selected for retargeting with content, requesting that the user(s) 140 be subscribed to the user segment or the retargeting content, or notifying the content management system 130 of a content detection event and/or a retargeting decision.

The segmentation system 132 can use information from the media device(s) 106 to add (and/or determine whether to add) the user(s) 140 to a user segment representing users selected for retargeting with content (e.g., targeted content) determined based on content detected by the media device(s) 106 within a content signal. In some cases, the information can include event information, such as information indicating that the content was detected in the content signal, the content matches targeted content in or identified in the targeted content 136B, the content was selected for retargeting to the user(s) 140 or is a retargeting candidate, the user(s) 140 is a retargeting candidate for content determined based on the detected content, etc. In some cases, the information can additional or alternatively include any other targeting information and/or cues describe herein. In some cases, the content targeting system 210 can send targeting information and/or cues obtained by the content recognition engine 220 and/or the content targeting engine 222 to the content management system 130.

The segmentation engine 132 can use the information from the content targeting system 210 to add/subscribe or determine whether to add/subscribe the user(s) 140 to a user segment representing users selected for retargeting with specific content, such as content determined based on content detected in a content signal (e.g., targeted content determined based on content detected in a content signal). In response to a determination to add or subscribe the user(s) 140 to the user segment, the segmentation engine 132 can add or subscribe the user(s) 140 to the user segment. In some cases, the content targeting system 210 can provide content detection results (e.g., ACR results) from the content recognition engine 220 to the content management system 130 and/or matching results from matching the detected content with content in or identified in the targeted content 136B. The segmentation engine 132 of the content management system 130 can use information about content detected by the media device(s) 106 (e.g., by the content recognition engine 220) and/or targeting information from the content targeting engine 222 to add (or determine whether to add) the user(s) 140 to a user segment representing users selected to be retargeted with content based on information associated with content detected in the content signal (e.g., targeted content) and/or determine whether one or more retargeting conditions are satisfied/met by/for the user (and, if so, add the user to the user segment).

The detection results from the content recognition engine 220 and the targeting information, cues, and/or decisions from the content targeting engine 222 can be used to create user segments for retargeting content, subscribe users to the user segments, or add users to the user segments in real-time or near real-time (e.g., as the content signal is displayed, played, or streamed, as the content is detected in the content signal, as information used to determine whether to include the user(s) 140 in the user segment is obtained, etc.). The content targeting engine 222 can use the detection results to determine whether the user(s) 140 associated with the media device(s) 106 should be included in a user segment selected for retargeting with content based on information associated with the content detected in the content signal and/or determine whether to report a retargeting event/information to the content management system 130.

For example, the content targeting engine 222 can receive an indication from the content recognition engine 220 that a targeted content was detected in a content signal. The content targeting engine 222 can monitor and/or analyze any targeting information and/or cues described herein to determine whether to notify the content management system 130 of the detection event, request that the user(s) 140 be added to a user segment, and/or determine whether the user(s) 140 associated with the media device(s) 106 should be retargeted with content (e.g., based on one or more targeting conditions). If the content targeting engine 222 determines that the user(s) 140 should be retargeted with content or that a retargeting condition is satisfied (e.g., based on a detection of a certain event(s)), the content targeting system 210 can send a notification to the content management system 130 (and/or the segmentation engine 132) indicating that the user(s) 106 should be added to a user segment containing users selected for retargeting with content, a request to add the user(s) 140 to the user segment, and/or a notification reporting any targeting information, cues, and/or events.

In some cases, the content targeting engine 222 can send event information to the content management system 130 used to add or determine whether to add the user(s) 140 to the user segment. The event information can include a detection event (e.g., a detection of content in a content signal), a content matching event (e.g., a determination that the detected content matches content in or identified in the targeted content 136B), a user event (e.g., a determination that the user(s) 140 consumed (e.g., watched, played, replayed, interacted with, engaged with), provided an input, saved, and/or shared the detected content), etc. In some cases, the event information can include a request to add the user(s) 140 to a user segment used to retarget content to or information used to determine whether to add the user(s) 140 to the user segment. In other cases, the content targeting engine 222 can include one or more filters and/or logic used to determine which events to report to the content management system 130 and/or which targeted content to provide to users selected for retargeting, such as the user(s) 140. For example, a content provider and/or platform may only be interested in retargeting certain content items and/or types of content items. Thus, the content targeting engine 222 can include one or more filters and/or logic to determine which content detection events to report to the content management system 130 and/or which content items and/or types of content items should be provided to the user(s) 140 when retargeting the user(s) 140 with content.

To illustrate, the content targeting engine 222 can receive detection outputs from the content recognition engine 220. The detection outputs can identify any content detected within a content signal(s). The content targeting engine 222 can analyze the detection outputs and use the one or more filters and/or logic to determine which content items in the detection outputs to ignore or filter out, and which content items in the detection outputs to report to the content management system 130 and/or consider for retargeting decisions. The content targeting engine 222 can notify the content management system 130 of any content item in the detection results, a user selected for retargeting based on the detection results and any other information, and/or any events or decisions selected for reporting to the content management system 130 (e.g., any content item that is not filtered out or ignored based on the one or more filters and/or logic, any retargeting decisions, etc.). The segmentation engine 132 of the content management system 130 can create a user segment for one or more content items based on information reported by the content targeting engine 222. The content targeting engine 222 can selectively filter which information to report to the content management system 130, which user is selected for retargeting with content, and/or which content is selected as a retargeting candidate when retargeting the user(s) 140, and the content management system 130 can intelligently retarget selected users with specific content based in part on content detected by client devices, associated information and/or events detected by the client devices, and/or notifications from the client devices.

As another example, the content targeting engine 222 can include filters and/or logic to select detected content to report to the content management system 130 based on a determination that the detected content matches or has a threshold similarity or relevance to content in or identified in the targeted content 136B. This way, the retargeted content can focus on or be based on targeted content and the media device(s) 106 can filter other content and selectively identify targeted content for retargeting decisions.

In some cases, instead of or in addition to the content targeting engine 222 filtering content detection events, the content recognition engine 220 can filter certain detection results from a detection output provided to the content targeting engine 222. The content recognition engine 220 can filter out detection results for content items that match one or more filters or do not match a selection rule/condition (e.g., content items that are not selected for retargeting or consideration in retargeting decisions) and only include certain detected content items in the detection results provided to the content targeting engine 222.

In some examples, the information from the content targeting system 210 to the content management system 130 can include information identifying the user(s) 140 (e.g., a user identifier, a username, a user profile, a user value, a user description, a unique value associated with the user(s) 140, etc.), the media device(s) 106 associated with the user(s) 140 (e.g., a device identifier, an Internet Protocol (IP) address of the media device(s) 106, a media access control (MAC) address of the media device(s) 106, a device address or resource identifier, a device name, a unique value associated with the media device(s) 106, etc.), content detected in the live signal or content or detected content selected for retargeting or that is not filtered based on one or more filters and/or logic (e.g., a unique content identifier, a content description, a copy of the targeted content, a header associated with the targeted content, a description of the targeted content, a resource identifier of the targeted content, an address of the targeted content, an identification value, a content title, a hash value generated based on the targeted content, etc.), the live signal or content containing the targeted content, and/or any targeting information and/or cues used to determine whether to retarget the targeted content to the user(s) 140.

The information from the content targeting system 210 to the content management system 130 can additionally or alternatively include information used to determine whether the user(s) 140 should be added to the user segment representing users selected for retargeting with content based on information associated with a detected targeted content item(s). The information can include targeting information and/or cues such as, for example, any user input provided or received during a playback or presentation of the targeted content and/or the signal/content containing the targeted content, any user interaction or type of user interaction with the targeted content and/or the signal/content containing the targeted content, any user interaction with the media device(s) 106 during a playback or presentation of the targeted content and/or the signal/content containing the targeted content, user activity and/or inactivity during a playback or presentation of the targeted content, a content playback/presentation log or statistics, an indication of a behavior of the targeted content at the media device(s) 106, a user preference, a user profile, a user identifier, a device identifier, and/or any other targeting information and/or cues described herein.

The media device(s) 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. The media device 106 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

### Real-Time Targeting Decisions Using Live Content Recognition

Now referring to both FIGS. 1 and 2, in some examples, the user(s) 140 may be targeted with content in a live content or signal (or any other content or content signal) such as live videos, streams, broadcasts, transmissions, etc. The media device(s) 106 can detect the targeted content in the content or signals consumed by the user(s) 140 at the media device(s) 106, and determine whether the targeted content should be retargeted to the user(s) 140. Retargeting users with content who have indicated or demonstrated an interest (or likelihood of interest) in or engagement with associated content or are predicted to like or be interest in the associated content may yield better targeting results and/or outcomes than targeting or retargeting the content to all users of a system or a set of users that includes users who have indicated or are estimated to have a lower interest in the associated content or have not demonstrated or indicated an interest in the associated content. Accordingly, the user(s) 140 can be intelligently retargeted with certain content such as content selected based on content that the user(s) 140 indicates, demonstrates, or is predicted to have a threshold interest in or be engaged by, content selected based on content that the user(s) 140 interacts with, content selected based on content that the user(s) 140 requests, content that matches or aligns with a preference(s) or interest(s) of the user(s) 140, and/or content determined based on content that the user(s) 140 likes. On the other hand, the user(s) 140 may not be retargeted with content associated with content that the user(s) 140 skips, closes, ignores, and/or otherwise dislikes or demonstrates (or is predicted to have) a disinterest in.

If the media device(s) 106 determines that the user(s) 140 should be retargeted with content associated with content detected in a live signal (e.g., the same or different content), the media device(s) 106 can notify the content management system 130 or send a message to the management system 130 requesting that the user(s) 140 be added to a user segment selected for retargeting with retargeting content or subscribed to the retargeting content. The segmentation engine 132 can add the user(s) 140 to the user segment, which can be used to retarget the user(s) 140 (and any other users in the user segment) with content selected based on the targeted content, such as the same content, a version of the same content, or different content. In other cases, the media device(s) 106 can send targeting information and/or cues to the content management system 130. The segmentation engine 132 of the content management system 130 can use such information and/or cues to determine whether to add the user(s) 140 to the user segment and, if so, add the user(s) 140 to the user segment.

In some examples, the media device(s) 106 can monitor information, inputs, activity, rules, cues, conditions, and/or any other data used to determine whether the user(s) 140 should be retargeted with content based at least in part on a determination that the targeted content was detected in a signal or content played, displayed, received, and/or streamed by the media device(s) 106 associated with the user(s) 140. The media device(s) 106 can send information to the content management system 130 used to select the user(s) 140 for retargeting and/or the content provided to the user(s) 140 when retargeting the user(s) 140. For example, the media device(s) 106 can obtain information used to add or determine whether to add the user(s) 140 to a segment of users selected for retargeting, send such information to the content management system 130, request that the user(s) 140 be added to a user segment, trigger the segmentation engine 132 to add the user(s) 140 to a user segment, etc. In some examples, the media device(s) 106 can obtain and/or send such information in real-time or near real-time (e.g., as the media device(s) 106 collects or generates such information, as the media device(s) 106 detects targeted content in a signal or content, as the media device(s) 106 obtains targeting information and/or cues associated with targeted content detected in a signal or content, as the media device(s) 106 determines whether the user(s) 140 should be added to a user segment or whether to request that the user(s) 140 be added to a user segment, etc.).

For example, the media device(s) 106 can analyze a live signal or content as the live signal or content is received, streamed, presented, or played by the media device(s) 106. The media device(s) 106 can use ACR to detect certain content in the live signal or content such as targeted content, predetermined content selected for retargeting, a predetermined type of content, content that matches one or more retargeting factors or conditions, or any other content. In some examples, the media device(s) 106 can monitor, extract, and/or collect targeting information and/or cues associated with content detected in a live signal or content at the media device(s) 106, such as targeted content, retargeting content, or a retargeting content candidate. The targeting information and/or cues can be used to make retargeting decisions and/or trigger retargeting actions for content detected in a live signal or content.

The media device(s) 106 and/or the content management system 130 can do or implement a retargeting decision(s) and/or action(s) in real-time or near real-time (e.g., relative to when content is consumed by the user(s) 140 at the media device(s) 106, detected within a live signal or content (or any other content or signal) at the media device(s) 106, streamed by the media device(s) 106, presented/played by the media device(s) 106, etc.). A retargeting decision and/or action can include, for example and without limitation, analyzing a live signal or content (or any other signal or content) using ACR, detecting content (e.g., targeted content) within the live signal or content (e.g., based on ACR results), obtaining (e.g., collecting, extracting, receiving, generating, etc.) and/or monitoring targeting information and/or cues associated with a user and/or the detected content item, determining whether one or more retargeting conditions are satisfied/met with respect to a user and/or the detected content, creating user segments for retargeting, adding a user to a user segment, subscribing a user to a user segment or associated content, configuring retargeting content, requesting that a user be added to a user segment or subscribed to associated content, delivering content, triggering a device to deliver or stream content, triggering a device to load content, and/or any other targeting/retargeting decisions and/or actions described herein.

By retargeting content to specific users intelligently selected as targets for the retargeted content as described herein, the systems and techniques described herein can improve targeting results and outcomes. Moreover, by checking live signals or content for content to retarget to users, detecting content to retarget to users based on content detected in the live signals or content, obtaining retargeting information/cues in real-time (or near real-time), and/or making retargeting decisions and/or actions in real-time (or near real-time), the systems and techniques described herein can more quickly identify and retarget suitable audiences (e.g., user segments) with content. For example, by using ACR to detect content within live signals or content, the systems and techniques described herein can quickly (e.g., based on the ACR results) identify content to retarget to users, which allows for faster and intelligent content retargeting. The systems and techniques described herein can quickly and intelligently retarget content detected in live signals/content to certain users based on retargeting conditions and/or information/cues obtained in real-time (or near real-time). This can result in better user experiences as well as faster and more precise/accurate targeting results and/or outcomes.

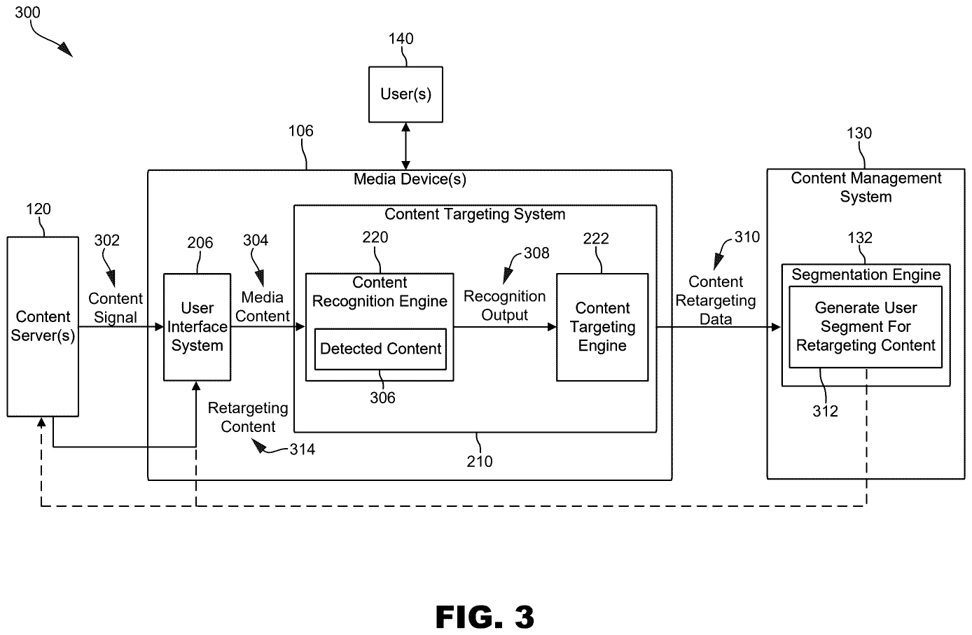

FIG. 3 is a diagram illustrating an example system process 300 for retargeting users with digital content, according to some examples of the present disclosure. The system process 300 can be used to determine whether to retarget users with selected content based on real-time (or near real-time) content detection results and retargeting decisions. The users can include any of the users associated with client devices that received content signals, such as live content signals (e.g., linear TV content, live videos, livestreams, live broadcasts, live transmissions, live podcasts, live social media broadcasts or streams, etc.) and/or pre-recorded/on-demand content signals (e.g., pre-recorded/on-demand movies, TV shows, video games, TV programming content, media streams, video clips, podcasts, recorded videos, etc.), and detected certain content, such as targeted content, within the content signals.

For example, the system process 300 can detect (e.g., in real-time or near real-time) content, such as targeted content, in the content signals and associated retargeting cues/information. In response to detecting the content in the content signals, the system process 300 can determine (e.g., in real-time or near real-time) whether to retarget any of the users with content based on the detection of the content in the content signals, the retargeting cues/information, and optionally any other data described herein. The content provided to the users selected for retargeting (e.g., the retargeting content provided) can include the detected content (e.g., the content detected in the content signals), a version of the detected content (e.g., the detected content modified to include a different format, content type, experience, configuration, design, style, feature(s), content element(s), visual appearance, behavior, content, advertising unit (e.g., if the detected content and the retargeting content are advertisements), presentation medium, settings, etc.), or different content.

The different content can include digital content associated with the detected content. The digital content associated with the detected content can include digital content selected based on the detected content, such as digital content that has a threshold similarity and/or relevance to the detected content, digital content that has a relationship(s) with the detected content, digital content that has one or more aspects in common with the detected content (e.g., digital content that has one or more aspects that are the same as one or more aspects of the detected content), or any other digital content. The one or more aspects in common with the detected content can include, for example and without limitation, a visual attribute(s), a setting(s), a design and/or style attribute(s) and/or parameter(s), a content experience(s) and/or behavior(s), a content characteristic(s), a common content source(s) and/or provider(s), a common content producer(s), a common advertiser(s), a common entity, a same promoted item (e.g., a same promoted brand, product, service, message, merchandise, sponsor, event, entity, application and/or platform, channel, company, object, person, digital content, content affinity or likeness, targeting parameter(s) such as a characteristic(s) of users targeted by such content, etc.), a content item having a threshold similarity and/or relevance to the detected content (e.g., a similar or relevant movie, TV show, TV channel, media application, media channel and/or platform, video game, product, service, brand, company, podcast, video, digital content item, genre, category, rating, style, appearance, promoted item, attribute, setting, content experience, content behavior, content affinity or likeness, targeting parameter(s) such as a characteristic(s) of users targeted by such content, etc.).

The system process 300 can use ACR to identify, detect, and/or recognize (e.g., in real-time or near real-time) content in the content signals and determine (e.g., in real-time or near real-time) whether to retarget any of the users with certain content. The retargeting decision can be based on a determination that the content was detected in the content signals, one or more retargeting cues/information, one or more retargeting conditions, the content detected in the content signals, content available for targeting/retargeting to users, and/or any other information described herein. The process 300 can use the content detections and retargeting decisions, which can be performed in real-time (or near real-time), to quickly and efficiently create a user segment (e.g., in real-time or near real-time) used to retarget digital content to selected users. The user segment can include users selected for retargeting with digital content. The system process 300 can similarly create additional user segments with respective users selected for retargeting with other digital content The system process 300 can efficiently create a user segment associated with digital content (e.g., retargeting content) and deliver the digital content to respective devices (e.g., media devices) associated with the users in the user segment. Accordingly, the system process 300 can quickly, efficiently, accurately, and intelligently retarget users with selected content. By retargeting users in a user segment with specific content selected for retargeting to such users may achieve better targeting results, outcomes, experiences, performance, etc.

As shown in FIG. 3, the content server(s) 120 can deliver a content signal 302 to the media device(s) 106 associated with the user(s) 140. While FIG. 3 shows the content signal 302 delivered to the media device(s) 106, the content server(s) 120 can deliver the content signal 302 (and any other content) to any other media devices that are not shown in FIG. 3. Moreover, while the retargeting performed by the system process 300 is illustrated in FIG. 3 with respect to the user(s) 140 and the media device(s) 106 associated with the user(s) 140, the system process 300 can deliver the content signal 302 (and/or other content) to other devices that are not shown in FIG. 3 and retarget other users (e.g., associated with the other devices) that are not shown in FIG. 3. FIG. 3 illustrates the system process 300 with respect to the user(s) 140 and media device(s) 106 for illustration and explanation purposes. The user(s) 140 is merely one illustrative example of a user retargeted via the system process 300 and the media device(s) 106 is merely one illustrative example of a media device(s) used by the retargeted user in the system process 300. One of ordinary skill in the art will recognize that, in other examples, the system process 300 can deliver content (e.g., live and/or pre-recorded content) to other devices (e.g., in addition to or instead of the media device(s) 106) and retarget other users (e.g., in addition to or instead of the user(s) 140) with content (e.g., the same and/or different content), as further described herein.

The content signal 302 in FIG. 3 can include media content 304. The media content 304 can include live or pre-recorded/on-demand content such as a live or pre-recorded/on-demand movie, TV show, TV broadcast, podcast, stream, livestream, TV programming content, video, content package, transmission, etc. In one illustrative example, the media content 304 in the content signal 302 can include live content such as a live video (e.g., a live movie, TV show, TV video broadcast, video transmission, podcast, livestream video, etc.), a live recording, a livestream, a live broadcast, live media, a live transmission, a live video game, a live content package, a live content interaction, linear TV content, or any other live or linear content or signal. For example, the media content 304 in the content signal 302 can include a live TV show, podcast, movie, stream (e.g., a TV stream, a social media stream, a stream in an online media sharing platform, a stream in a media content platform or application, a stream in a media channel, etc.), broadcast (e.g., a TV broadcast, a social media broadcast, a broadcast in an online media sharing platform, a broadcast in a media content platform or application, a broadcast in a media channel, etc.), live TV programming content, live video game, live channel content, or any other live content.

The media device(s) 106 can use the user interface system 206 to play, display, and/or render the media content 304 in the content signal 302 for the user(s) 140. For example, the user interface system 206 can include a display or rendering system used to render/display the media content 304 on a display device(s), such as the display device(s) 108 or a display device in, implemented by, or coupled to the media device(s) 106, or any other display device(s). The display or rendering system of the user interface system 206 can receive the content signal 302 and render/display the media content 304 in the content signal 302 on the display device(s). The user(s) 140 can interact with the media content 304 in the content signal 302 via the media device(s) 106 (e.g., via the user interface system 206, via a peripheral device(s) of the media device(s) 106, via input software at the media device(s) 106, via the remote control(s) 110, and/or via any hardware and/or software input component or element) and can watch the media content 304 in the content signal 302 via the display device(s).

For example, the user(s) 140 can use the media device(s) 106 to manage a presentation and/or playback (e.g., play, stop, rewind, forward, replay, pause, etc.) of the media content 304 in the content signal 302, interact with the media content 304 in the content signal 302 (e.g., initiate a conversion action associated with a targeted content item in the media content 304, respond to a prompt in the media content 304, provide an input(s) used to interact with the media content 304 in the content signal 302, etc.), close or terminate the media content 304 and/or the content signal 302, skip any portion of the media content 304 in the content signal 302, provide any inputs associated with the media content 304 in the content signal 302 and/or during presentation of the media content 304 (e.g., an input comment, an input “like” or “dislike”, an input “subscription” to a portion of the media content 304 or a content source, an input rating, input feedback, an input response, an input request, an input control, an input action, an input command, an input answer, an input setting, an input content “skip”, an input instruction, input data, etc.), adjust any settings associated with the content signal 302 (and/or the media content 304) and/or media device(s) 106 (e.g., adjust a volume, adjust a content size, adjust a screen/display or window size, move content within a screen/display or window, move an area displaying the media content 304 or a portion thereof, adjust a resolution, adjust a playback setting, etc.), and/or provide or trigger any other inputs, commands, actions, operations, data, and/or interactions.

The content recognition engine 220 can use ACR to analyze the content signal 302 and detect certain content (e.g., detected content 306) within the media content 304 in the content signal 302. For example, the content recognition engine 220 can use ACR to analyze the media content 304 in the content signal 302 as the content signal 302 (e.g., as the media content 304) is received, played, displayed, and/or rendered by the media device(s) 106, to look for and/or detect certain content (e.g., the detected content 306) within the media content 304 in the content signal 302. If the media content 304 includes such content, the content recognition engine 220 can detect such content in the media content 304 using ACR. The detected content 306 can include any digital content and/or type of digital content, such as digital content that the content recognition engine 220 is configured to look for and/or detect, digital content selected or predetermined as a candidate for triggering the system process 300 to determine whether to retarget the user(s) 140 with content, targeted content or certain targeted content, a type(s) of targeted content, content from a particular source or entity (e.g., a particular brand, advertiser, content provider, producer, company, etc.), content promoting a particular item (e.g., a product, service, brand, content, object, event, person, company, message, etc.), and/or any other digital content.

For example, the detected content 306 in the media content 304 can include, without limitation, a copy of the detected content 306, a version of the detected content 306 (e.g., a modified or reconfigured version, an updated version, a version configured to provide a different experience or behavior, a version configured with a different format or advertisement unit (if the detected content 306 is or includes an advertisement), content determined based on the detected content 306 (e.g., content that has a threshold similarity or relevance to the detected content 306, content that has one or more commonalities or similarities to the detected content 306, targeted content (e.g., invitational content, advertisements, promoted media, recommended media content, etc.), a targeted content item associated with the detected content 306, a content retargeting candidate (e.g., a targeted content item selected for retargeting, an invitational content item, an advertisement, etc.), interactive content, customized content (e.g., content tailored to or customized for the user(s) 140 and/or a group of users, content customized for a particular purpose or experience, etc.), content (or a type(s) of content) selected or preselected for targeting/retargeting, a predetermined retargeting content candidate(s), content that has certain characteristics (e.g., predetermined or preselected content attributes, a predetermined promoted item, a predetermined configuration, etc.), a type(s) of content predefined as a retargeting candidate(s), and/or any other content.

The content recognition engine 220 can be configured to detect (e.g., can look for and detect) or generate a detection message for certain content or type of content in the media content 304, such as one or more predetermined content items, targeted content items (e.g., invitational content, advertisements, targeted media content, recommended media, customized media content, etc.), types of content items or content types, content items having one or more specific features (e.g., specific content appearances, designs, experiences, behaviors, parameters, characteristics, links, sources, brands, promotions, messages, associated entities, conveyed or depicted content or objects, conveyed or depicted content that has a certain semantic meaning or message, etc.), application content items, graphics content items, media content items (e.g., videos, TV shows, images, movies, podcasts, etc.), and/or any other content items. The content recognition engine 220 can use ACR to identify the detected content 306 in the media content 304. In some cases, the detected content 306 can include targeted content. The targeted content can include, for example, secondary content (e.g., invitational content such as advertisements or promotions), content with certain characteristics, a predetermined type(s) of content, a content retargeting candidate, and/or any other content or type of content. The content recognition engine 220 can be configured to check for such targeted content in the media content 304 and detect such targeted content.

The content recognition engine 220 can generate a recognition output 308. In FIG. 3, the media content 304 includes the detected content 306. Thus, the recognition output 308 can include the detected content 306 and/or an indication that the detected content 306 was included (and detected) in the media content 304. In some cases, the recognition output 304 can include a notification that the media content 304 includes the detected content 306, a notification that the detected content 306 was detected in the media content 304, information identifying the detected content 306 (e.g., a description of the detected content 306, a signature or hash generated or associated with the detected content 306, a content identifier associated with the detected content 306, metadata associated with the detected content 306, etc.), information identifying the media content 304 containing the detected content 306 and/or a portion of the media content 304 containing the detected content 306, a description of the media content 304 and/or a portion of the media content 304 containing the detected content 306, and/or any other information from the content recognition engine 220. For example, the recognition output 304 can notify the content targeting engine 222 that media content 304 includes the detected content 306 and/or the detected content 306 was detected in the media content 304.

In some cases, the content recognition engine 220 can include one or more filters, rules, and/or logic used by the content recognition engine 220 to determine which content to detect/identify and/or include in the recognition output 308. For example, a content provider or platform may only be interested in retargeting certain types of content and/or content with certain characteristics. The content recognition engine 220 can use one or more filters, rules, and/or logic to determine which content detected in the media content 304 to report to the content targeting engine 222. The content recognition engine 220 can include that content or an indication of that content in the recognition output 308. Thus, the detected content 306 can include a subset of content detected in the media content 304, such as a portion of the detected content that is not filtered or excluded by one or more filters, rules, and/or logic. In other cases, the content recognition engine 220 may be configured to only detect certain content and/or types of content, and the detected content 306 can include all the content detected in the media content 304 by the content recognition engine 220 based on the content and/or type(s) of content that the content recognition engine 220 is configured to detect.

The content targeting engine 222 can use the recognition output 308 from the content recognition engine 220 to provide content retargeting data 310 to the content management system 130. For example, the content targeting engine 220 can use the recognition output 308 to identify the detected content 306 and report to the content management system 130 (e.g., within the content retargeting data 306) that the detected content 306 was detected in the media content 304. In some cases, the content targeting engine 220 can determine which content from the detected content 306 to report to the content management system 130 via the content retargeting data 310. In some examples, the content targeting engine 220 can trigger (e.g., via the content retargeting data 310) the content management system 130 to retarget the user(s) 140 with content. In some cases, the content targeting engine 220 can use the detected content 306 and any retargeting information and/or cues described herein to determine whether to retarget the user(s) 140 with content. The content targeting engine 220 can notify the content management system 130 (e.g., via the content retargeting data 310) of the determination to retarget the user(s) 140 with content, trigger the content management system 130 to retarget the user(s) 140 with content, and/or request that the user(s) 140 be subscribed or added to a user segment used to retarget users with selected content.

In some cases, the content targeting engine 222 or the content management system 130 can include one or more filters, rules, and/or logic used to select which content to provide to the user(s) 140 when retargeting the user(s) 140 based on the recognition output 308 and/or the content retargeting data 310. In some cases, the content targeting engine 220 can include one or more filters, rules, and/or logic to determine, based on the recognition output 308 and/or the content targeting engine 222, which content to report to the content management system 130 as selected content or a content candidate to provide to the user(s) 140 (e.g., the user's device) when retargeting the user(s) 140, which content to request be used to retarget the user(s) 140, and/or which content to exclude from the content retargeting data 306 provided to the content management system 130. For example, the content targeting engine 222 (or the content management system 130) can include one or more filters or logic used to select content for retargeting (or reporting to the content management system 130) based on a match, relevance, and/or similarity between such content (and/or the detected content 306) and content in or identified in the targeted content 136B. In some examples, the content targeting engine 222 (or the content management system 130) can compare the detected content 306 included and/or identified in the recognition output 308 with the targeted content 136B and/or content identified in the targeted content 136B. If the detected content 306 in the recognition output 308 matches or has a threshold similarity or relevance to a content item in or identified in the targeted content 136B, the content targeting engine 222 (or the content management system 130) can select that content item for use when retargeting the user(s) 140. Alternatively or additionally, the content targeting engine 220 can report that content item to the content management system 130 or report the comparison result to the content management system 130.

In some cases, the content targeting engine 222 or the content management system 130 can generate or obtain a fingerprint of each content item in the recognition output 308 and compare the fingerprint with respective fingerprints of content items in or identified in the targeted content 136B (e.g., generated by the content targeting engine 222 or the content management system 130). If the fingerprint matches one of the respective fingerprints, the content targeting engine 222 or the content management system 130 can determine that the content item associated with that fingerprint matches a content item in or identified in the targeted content 136B. The content targeting engine 222 or the content management system 130 can determine to retarget the user(s) 140 with content based on the determination that the content item associated with that fingerprint matches a content item in or identified in the targeted content 136B and/or can select that content item in or identified in the targeted content 136B as the content to provide to the user(s) 140 when retargeting the user(s) 140 with content. A fingerprint can be generated based on a hash function applied to a content (or portion thereof), attribute, metadata, pattern, and/or component of a content item. In some cases, the content targeting engine 222 or the content management system 130 can additionally or alternatively use other information and/or cues in the recognition output 308 (and/or the content retargeting data 310) to determine whether to retarget the user(s) 140 with content, determine whether to report the detected content 306 to the segmentation engine 132, and/or request to the segmentation engine 132 that the user(s) 140 be retargeted with content and/or added (or subscribed to) a user segment used to retarget content to selected users (e.g., a user segment including or identifying the selected users).

In some examples, the recognition output 308 can include all content detected by the content recognition engine 220, and the content targeting engine 222 can use one or more filters, rules, and/or logic to determine which, if any, of the detected content 306 (and/or associated identifiers) to exclude from the content retargeting data 310 and/or what information, content from the detected content 306, and/or data from the recognition output 308 to include in the content retargeting data 310. In other cases, the recognition output 308 can include a subset of the content detected by the content recognition engine 220, such as detected content that is not filtered by the content recognition engine 220 based on a filter, rule, or logic. The content targeting engine 220 can optionally report such content to the content management system 130 (e.g., via the content retargeting data 310), report to the content management system 130 (e.g., via the content retargeting data 310) that such content was detected in the media content 304, or apply one or more filters, rules, and/or logic to the recognition output 308 to determine which content (and/or associated identifiers) to include or identify in the content retargeting data 310 (e.g., which content to report to the content management system 130) and which content to exclude (if any).

In some examples, the content recognition engine 220 can detect content items in the media content 304 and, for each content item, the content targeting engine 222 or the content management system 130 can determine whether the detected content item should trigger the user(s) 140 to be retargeted with content and/or determine whether the detection of the content item should trigger a retargeting decision (e.g., a decision whether the user(s) 140 should be retargeted with content). In some cases, the determination whether the detection of the content item should trigger the retargeting decision can be based on a determination that the content item matches or has a threshold similarity or relevance to a content item in or identified in the targeted content 136B. The content recognition engine 220 or the content management system 130 can determine whether each detected content item matches a content item in or identified in the targeted content 136B by comparing a fingerprint of each detected content item with respective fingerprints of the content items in or identified in the targeted content 136B. If the fingerprint of a detected content item matches one of the respective fingerprints of the content items in or identified in the targeted content 136B, the detected content item associated with such fingerprint can be determined to match a content item in or identified in the targeted content 136B (e.g., the content item associated with the matching fingerprint). In some cases, the recognition output 308 or the content retargeting data 310 content recognition engine 220 can include or identify any content item matching a content item in or identified in the targeted content 136B.

The content targeting engine 222 or content management system 130 can determine whether the user(s) 140 should be retargeted with content based on information in the content retargeting data 310, such as the detected content 306, an indication that the detected content 306 was detected in the media content 304, and/or the recognition output 308 (or a portion thereof). In some cases, the content targeting engine 222 can use the recognition output 308 (or a portion thereof) and one or more filters, rules, and/or logic to determine whether the user(s) 140 should be retargeted with content based on a determination that the detected content 306 was detected in the media content 304 and one or more retargeting conditions are satisfied with respect to the user(s) 140 and the detected content 306. In some cases, the content targeting engine 222 can additionally or alternatively determine whether to report the detection event (e.g., the detection of the detected content 306) to the content management system 130 and/or request to the content management system 130 (e.g., to the segmentation engine 132) that the user(s) 140 be retargeted with content or added/subscribed to a user segment used to retarget users with selected content.

In some examples, the content targeting engine 222 or the content management system 130 can use the recognition output 308 and/or the content retargeting data 310 to determine whether one or more retargeting conditions are satisfied with respect to the user(s) 140 and the detected content 306 (or a portion of the detected content 306 identified in the recognition output 308). If the one or more retargeting conditions are satisfied, the content targeting engine 222 or the content management system 130 can decide to retarget the user(s) 140 with specific content, such as a version of the detected content, a content having a relevance or similarity to the detected content, a content having one or more commonalities with the detected content, content determined/selected based on the detected content, etc.

The content targeting engine 220 can monitor, analyze, listen for, generate, collect, aggregate, and/or obtain targeting information and/or cues used to determine whether the user(s) 140 should be retargeted with content associated with the detection event (e.g., the detection of the detected content 306) in the recognition output 308 or whether the content targeting engine 220 should report the detection event (e.g., via the content retargeting data 310) and/or any other information to the content management system 130 and/or request to the content management system 130 that the user(s) 140 be retargeted with content or considered as a retargeting candidate. In some cases, the recognition output 308 or content retargeting data 310 can include the targeting information and/or cues. The targeting information and/or cues can include, for example and without limitation, a user activity and/or inactivity during a playback/presentation of the media content 304 and/or the detected content 306, any user interactions (e.g., interactions with the media device(s) 106, the media content 304, and/or the detected content 306) during a playback/presentation of the media content 304 and/or the detected content 306, any events detected during playback/presentation of the media content 304, any user preferences, a behavior of the media content 304 and/or the detected content 306, playback settings and/or statistics of the media content 304 and/or the detected content 306, any content characteristics of the detected content 306, any inputs from the user(s) 140 during a playback/presentation of the media content 304 and/or the detected content 306 (e.g., content requests, content “likes” or “dislikes”, content feedback, content playback inputs, content playback counts, user comments, content ratings, etc.), content consumption data (e.g., data indicating what content and/or categories of content the user(s) 140 subscribed to, consumed (e.g., played, watched, interacted with, etc.), ignored, skipped, replayed, requested, positively or negatively rated, etc.), content patterns (e.g., playback counts, content views, content interactions, content skips, content forwards, content replays, content trends, content category trends, content activity or inactivity, etc.), etc.

In some cases, the targeting information and/or cues can additionally or alternatively include any cues indicative of user preferences for and/or engagement/disengagement with the detected content 306 (e.g., user inactivity during playback/presentation of the detected content 306 which can indicate user engagement if the detected content 306 does not include an input prompt or interactive content or can indicate user disengagement if the detected content 306 includes an input prompt or interactive content, interactions with the detected content 306 or interactions with an interactive portion of the detected content 306 (e.g., a portion with enabled or allowed interactions, a portion associated with expected interactions, a portion soliciting interactions, a prompt, etc.) which can be indicative of user engagement with the detected content 306, user activity indicative of user disengagement such as user interactions with content other than the detected content 306 (or media content 304) during playback/presentation of the detected content 306 or interactions with a portion of the detected content 306 that is not interactive (e.g., does not allow, expect, enable, or solicit interactions) which may be interpreted as accidental/unintentional or erroneous interactions (e.g., and indicative of user boredom, distraction, or disengagement), a content playback of the detected content 306 and/or associated playback counts, an input subscribing to the detected content 306 (or an associated content source, entity, brand, person, content collection, channel, etc.), inputs indicative of disinterest in the detected content 306 (e.g., inputs skipping the detected content 306, requesting other content, blocking the detected content 306, closing the detected content 306, providing a negative rating or feedback/comment associated with the detected content 306, etc.), user characteristics (e.g., demographics, etc.), content characteristics, and/or any other information about the detected content 306, the user(s) 140, user activity, the media device(s) 106, and/or user/content statistics, patterns, interests, or trends.

In some examples, the content targeting engine 220 can provide the targeting information and/or cues to the content management system 130. For example, the content retargeting data 310 can include the targeting information and/or cues and an indication that the detected content 306 was detected in the media content 304. In such cases, the segmentation engine 132 of the content management system 130 can use the content retargeting data 310, including the targeting information and/or cues, to determine whether the user(s) 140 should be retargeted with specific content based in part on the detected content 306 being detected in the media content 304 and thus whether the user(s) 140 should be added to a user segment representing users selected for retargeting with certain content. In other examples, the content targeting engine 220 can use the targeting information and/or cues to determine whether the user(s) 140 should be retargeted with certain content, such as targeted content determined based on the detected content 306, and send a message (e.g., via the content retargeting data 310) to the content management system 130 configured to trigger the segmentation engine 132 to add the user(s) 140 to the user segment or configured to request that the user(s) 140 be added to the user segment. In some examples, the content targeting engine 220 can use the targeting information and/or cues to determine whether any of the detected content 306 should be reported to the content management system 130 for use in determining whether to retarget the user(s) 140 with content and/or identify a retargeting content candidate to provide to the user(s) 140 when retargeting the user(s) 140.

The content targeting engine 220 and/or content management system 130 can make retargeting determinations based on one or more retargeting conditions. In some cases, the one or more retargeting conditions can be defined or determined based on one or more filters, rules, preferences, cues, events, and/or logic. The content targeting engine 222 or content management system 130 can determine to retarget the user(s) 140 with content in response to detecting the detected content 306 in the media content 304 and a determination that one or more retargeting conditions are satisfied/met with respect to the user(s) 140 and/or the detected content 306.

The one or more retargeting conditions can include, for example, a threshold interest in (or likelihood of interest in) or preference for the detected content 306 (or an associated content type or category), a user interaction or type of interaction with the detected content 306, a number of user interactions (and/or types of user interactions) with the detected content 306, a playback or view count associated with the detected content 306, a user reaction or predicted reaction to the detected content 306, a rating of the detected content 306 (e.g., from the user(s) 140, from a group including the user(s) 140 such as a user group having a common attribute(s), etc.), a predicted user interest in or preference for the detected content 306, a threshold match or alignment between a preference or statistic associated with the user(s) 140 and the detected content 306 (and/or an associated characteristic), an indication that the user(s) 140 liked or likes the detected content 306, an indication that the user(s) 140 watched or replayed the detected content 306, an indication that the user(s) 140 initiated an action associated with the detected content 306 such as a conversion action, a targeting filter(s), an indication that the user(s) 140 interacted with the detected content 306 or an interactive portion of the detected content 306, a user input (and/or type of user input) during playback or presentation of the detected content 306, a user activity or type of user activity during playback or presentation of the detected content 306, a user inactivity during a playback or presentation of the detected content 306 (or a portion thereof, such as a prompt or an interactive portion), and/or any other cue or selection criteria for selecting to retarget the user(s) 140 with content, such as content determined based on the detected content 306.

In some cases, different targeting conditions can be used to make an overall decision to retarget the user(s) 140 with content associated with the detected content 306 or report the detected content 306 to the content management system 130, which can trigger the content management system 130 to determine whether to retarget the user(s) 140 with certain content or instruct the content management system 130 to retarget the user(s) 140 with certain content. For example, different targeting conditions can be weighed and/or combined to determine whether to retarget the user(s) 140 with content associated with the detected content 306 or whether to report the detected content 306 to the content management system 130. The different targeting conditions can include targeting filters, rules, cues, preferences, data, events, criteria, logic, parameters, and/or any other information.

Example targeting conditions that can favor a decision not to retarget the user(s) 140 with content associated with the detected content 306 or weighed against retargeting the user(s) 140 with such content include a determination that the user(s) 140 skipped the detected content 306 (or a portion thereof), closed the detected content 306, forwarded the detected content 306 (e.g., activated a playback forwarding control), provided a negative comment or feedback about the detected content 306, provided an input “disliking” the detected content 306, ignored the detected content 306 (e.g., ignored a prompt or request, ignored an interactive portion, did not engage in activity indicating interest or engagement, etc.), minimized or moved a portion of the screen depicting the detected content 306 to a background or a less prominent/salient region, interacted with other content during playback/presentation of the detected content 306, provided an input during a portion of or at a location within the detected content 306 that is not interactive or enable inputs (e.g., which can indicate that the user was not paying attention to the detected content 306 or was bored/disengaged), reduced a size of the detected content 306, increased a size of other content during a presentation of the detected content 306, moved other content within a foreground during a presentation of the detected content 306, content statistics indicating a disinterest in or less interest in the detected content 306 (or a type of content associated with the detected content 306), a less than a threshold match between a user preference and a characteristic of the detected content 306, a user history indicating a disinterest or lower interest in a type of content associated with the detected content 306, inactivity resulting in a timeout (e.g., which can indicate disengagement), a lack of interaction with the detected content 306 (or a lack of interaction with the detected content 306 during a playback portion when an interaction is expected), and/or user information indicating a lack of user interest in the detected content 306.

On the other hand, example retargeting conditions that can be used or weighed in favor of retargeting the user(s) 140 with content associated with the detected content 306 can include user inactivity during playback/presentation of a portion of the detected content 306 that does not include an input element/prompt or interactive content, an interaction with the detected content 306 or an interactive portion of the detected content 306 (e.g., a portion with enabled or allowed interactions, a portion associated with expected interactions, a portion soliciting interactions, etc.), user activity indicative of user engagement with the detected content 306 (e.g., a user response to a prompt or interactive portion of the detected content 306, etc.), a content playback of the detected content 306 and/or associated playback count, an input subscribing to the detected content 306 (or associated content), inputs indicative of interest in the detected content 306 (e.g., inputs maximizing or increasing a size of the detected content 306 or an associated interface, requesting similar content, subscribing to the detected content 306 or an associated category or provider, “liking” or positively rating the detected content 306, providing positive feedback/comments associated with the detected content 306, moving the detected content 306 from a background to a foreground or a less salient region to a more salient region, initiating an associated action such as a conversion action, etc.), a match between a user preference or characteristic and a content characteristic of the detected content 306, a match between a user characteristic (e.g., demographics, etc.) and a content characteristic of the detected content 306, a match or relationship between the detected content 306 and other content items of interest to the user(s) 140 (e.g., other content items that the user(s) 140 has a threshold view count for and/or interacted with, “liked”, subscribed to, requested, watched, played, replayed, shared, etc.), user/content statistics or patterns matching a characteristic of the detected content 306, and/or any other interest cues.

In some cases, the recognition output 308 can include an indication that the detected content 306 was detected in the media content 304, the one or more retargeting conditions, and/or the retargeting information and/or cues. The content retargeting data 310 can additionally or alternatively include an indication that the detected content 306 was detected in the media content 304, the one or more retargeting conditions, and/or the retargeting information and/or cues. Moreover, the content targeting engine 222 can use the recognition output 308 to generate the content retargeting data 310 sent to the content management system 130. In some cases, the content retargeting data 310 can include information about and/or reporting a retargeting event used by the content management system 130 to select the user(s) 140 for retargeting with selected content, determine whether to retarget the user(s) 140 with selected content, and/or add the user(s) 140 to a user segment selected for retargeting with selected content. The retargeting event can include a content detection event, such as a detection of detected content 306 in the media content 304, retargeting information and/or cues, a retargeting decision, a retargeting request, one or more retargeting conditions, information about the user(s) 140 and/or the detected content 306, and/or any other information described herein. In some cases, the retargeting event can additionally include a determination that the detected content 306 and/or the user(s) 140 satisfies or comports with one or more retargeting conditions used to select the user(s) 140 for retargeting with content associated with the detected content 306, or information used to make such determination.

In some cases, the content retargeting data 310 can additionally or alternatively include a request to retarget the user(s) 140 with content associated with the detected content 306, a request to add the user(s) 140 to a user segment selected for retargeting with content associated with the detected content 306, a request to subscribe the user(s) 140 to retargeting content associated with the detected content 306, an indication that the user(s) 140 should be retargeted with content associated with the detected content 306, a retargeting score calculated for the user(s) 140 and the detected content 306, targeting information and/or cues, an instruction to retarget the user(s) 140 with content associated with the detected content 306, information identifying the detected content 306 and/or the user(s) 140, information identifying the media device(s) 106 associated with the user(s) 140, information about a configuration of the detected content 306 and/or the media content 304, delivery information for the retargeting content (e.g., a delivery location, a delivery medium, a configuration of the retargeting content, a delivery timing or date, a delivery preference, a delivery package, a delivery trigger, etc.), a behavior or requested behavior of the retargeting content, a content package containing the retargeting content or associated data, retargeting preferences, and/or any other retargeting information.

In some examples, the content retargeting data 310 can include a request to retarget the user(s) 140 with content associated with the detected content 306, information reporting the detected content 306 as a retargeting condition for retargeting the user(s) 140 with selected content associated with the detected content 306, and/or an indication that the detected content 306 was determined to trigger a retargeting of the user(s) 140 with content associated with the detected content 306. For example, the content targeting engine 222 or the content management system 130 can weigh, analyze, combine/aggregate, and/or consider any retargeting conditions (e.g., in favor of and/or against retargeting the user(s) 140 with content), information, and/or cues associated with the detected content 306 and/or the user(s) 140 to determine whether the user(s) 140 should be retargeted with content associated with the detected content 306, the detection of the detected content 306 should be reported to the content management system 130 or the segmentation engine 132, or the user(s) 140 should be selected for retargeting based on a detection of the detected content 306 and one or more retargeting conditions.

In some cases, the content retargeting data 306 from the content targeting engine 222 can include a request to retarget the user(s) 140, information reporting the detected content 306 (or a detection thereof), an indication that the detected content 306 was determined to trigger a retargeting of the user(s) 140 or a retargeting decision. The content targeting engine 222 can send the content retargeting data 310 to the content management system 130, which can use such data to add/subscribe (e.g., via the segmentation engine 132) the user to a user segment for retargeting with selected content and/or determine whether to retarget the user(s) 140 with selected content (or add/subscribe the user(s) 140 to such user segment).

In some examples, the segmentation engine 132 of the content management system 130 can use the content retargeting data 310 to generate or update a user segment for retargeting with content associated with the detected content 306. For example, the segmentation engine 132 can determine that the user(s) 140 should be added or subscribed to a user segment that includes users selected to be retargeted with retargeting content 314 associated with the detected content 306, and add or subscribe the user(s) 140 to the user segment based on the content retargeting data 310. The user segment can be associated with retargeting content 314 to be delivered to users (e.g., to associated devices) in the user segment. The user segment can identify the users in the user segment and/or devices associated with the users in the user segment. In some cases, the user segment can include content delivery and/or configuration parameters, such as delivery formats, mediums, timing, dates, packages, behaviors, attributes, etc.

In some cases, the segmentation engine 132 can weigh one or more retargeting conditions and/or associated information in the content retargeting data 310 to determine whether to retarget the user(s) 140 with content associated with the detected content 306. The segmentation engine 132 can add the user(s) 140 to the user segment associated with the retargeting content 314 based on a determination that the user(s) 140 should be retargeted with the retargeting content 314.

The retargeting content 314 associated with the user segment can include the detected content 306, specific targeted content (or type of targeted content) generated based on the detected content 306, a different/modified version of the detected content 306, and/or content (e.g., targeted content) determined based on the detected content 306. For example, in some cases, the retargeting content 314 can include a copy of the detected content 306. In other cases, the retargeting content 314 can include the content (or a portion of content) of the detected content 306 with a different format (e.g., different media format, type of file or content item, package, advertisement unit, etc.), configuration (e.g., different parameters, inputs or input types enabled, size or aspect ratio, resolution, shape, settings, attributes, etc.), behavior (e.g., different actions, inputs, interactions, responses, input types, behavior, animation, conversion actions, sequence of conversion actions, etc.), content experience, style and/or design (e.g., different layout, imagery, color palette, objects, fonts or typography, visual elements, language, organization or arrangement of items, alignment, spacing, themes, etc.), and/or appearance (e.g., different colors, brightness, visual elements, visual patterns, graphics, stylization, visual effects, etc.).

For example, if the detected content 306 is a banner advertisement, the retargeting content 314 can include the same advertisement provided in a different advertisement unit such as, for example, a video advertisement, an outstream advertisement, a native advertisement, an image advertisement, an interstitial advertisement, a rewarded advertisement, an interactive advertisement, an audio advertisement, a carousel advertisement, a playable advertisement, a text advertisement, an offerwall advertisement, an overlay advertisement, a slider advertisement, a skippable or non-skippable advertisement, an in-feed video advertisement, a bumper advertisement, or any other type of advertisement. As another example, if the detected content 306 is an image, the image can be converted into a video or an animated image. In this example, the retargeting content 314 can include the video or animated image.

As another example, if the detected content 306 includes a final level of a video game completed by the user(s) 140, the retargeting content 314 can include another video game (e.g., a next video game) in a same video game franchise, a similar video game, a suggested video game based in part on the detected content 306, a video game in a same or similar video game category, a video game from a same developer, a video game with a threshold relevance or similarity to the detected content 306, a video game having one or more commonalities with the detected content 306, a movie of the video game (the detected content 306), an advertisement or coupon for any of the video games or the movie noted above, or any other relevant content. The user(s) 140 can be retargeted with the retargeting content 314 via any medium. For example, the user(s) 140 can be retargeted with the retargeting content 314 on a page or screen (e.g., a home screen, a video game page, etc.) of a media platform associated with the content signal 302, a video (e.g., movie, TV show, etc.) consumed by the user(s) 140, etc. As yet another example, if the detected content 306 includes a video game, the retargeting content 314 can include a cheat code for the video game or an advertisement for a related video game. The user(s) 140 can be retargeted with the retargeting content 314 via any medium. As previously noted, as used herein, references to retargeting the user(s) 140 with certain content does not mean that such content was previously targeted to the user(s) 140 and is being targeted to the user(s) 140 again. Instead, the references to retargeting the user(s) 140 with certain content mean that the user(s) 140 is being retargeted with content irrespective of whether such content was or was not targeted to the user(s) 140 before or at all.

In some cases, the retargeting content 314 can be generated or determined based on the detected content 306. For example, the retargeting content 314 can be generated by modifying one or more aspects of the detected content 306 and/or configuring the detected content 306 as a different type of media content or to provide a different experience. As another example, the content (or a portion(s) of the content) of the detected content 306 can be extracted from the detected content 306 and used to generate the retargeting content 314. The extracted content can be incorporated into a content item or package of the retargeting content 314, formatted as desired, and/or modified according to a specific design, configuration, format, style, appearance, behavior, attribute, experience, etc. As another example, the retargeting content 314 can be identified based on one or more characteristics of the detected content 306 such as a genre, a content type, a content category, a content source, a content franchise, a content attribute, a promoted item, an associated entity, an associated brand or product, etc. The one or more characteristics of the detected content 306 can be compared with characteristics of other content items to identify a content item (e.g., the retargeting content 314) that has characteristics that match or have a threshold similarity or relevance to the one or more characteristics of the detected content 306.

In some cases, the content management system 130 can generate the retargeting content 314 associated with the user segment and the detected content 306. For example, the segmentation engine 132 can generate and/or configure the retargeting content 314 for or based on the user segment selected for retargeting with the retargeting content 314. In other cases, a different device or system can generate the retargeting content 314 associated with the user segment and the detected content 306. For example, the content server(s) 120 can generate the retargeting content 314 based on the detected content 306, the user segment associated with the retargeting content 314, user information, and/or information from the content management system 130, such as configuration information, retargeting instructions and/or information, requested attributes, etc.

The retargeting content 314 can then be delivered to respective devices of the users in the user segment associated with the retargeting content 314. To illustrate, in the previous example, the user(s) 140 is associated with the media device(s) 106 and part of the user segment associated with retargeting content 314. Accordingly, the retargeting content 314 can be delivered to the media device(s) 106 associated with the user(s) 140. The media device(s) 106 can receive and present/play the retargeting content 314 for the user(s) 140. The media device(s) 106 can present the retargeting content 314 via the user interface system 206.

The system process 300 can optionally be used to determine whether to retarget any other users with the retargeting content 314 (or a version thereof). In some cases, the content management system 130 can deliver the retargeting content 314 to the devices associated with the users in the user segment. For example, the content management system 130 can deliver the retargeting content 314 to the media device(s) 106 associated with the user(s) 140 in the user segment. The media device(s) 106 can then present or play the retargeting content 314 for the user(s) 140 via the user interface system 206, as previously explained.

In other cases, the content server(s) 120 can deliver the retargeting content 314 to the devices associated with the users in the user segment. For example, the content server(s) 120 can receive an instruction from the content management system 130 to deliver the retargeting content 314 to the devices associated with the users in the user segment. The content server(s) 120 can receive the instruction with or without the retargeting content 314. To illustrate, in some cases, the content server(s) 120 can generate the retargeting content 314 or store a copy of the retargeting content 314. Accordingly, the content server(s) 120 can deliver the retargeting content 314 to the devices of the users in the user segment in response to an instruction or request to deliver the retargeting content 314 to the user segment from the content management system 130. In other cases, the content management system 130 can generate the retargeting content 314 and send the retargeting content 314 to the content server(s) 120 with an instruction to deliver the retargeting content 314 to the devices associated with the users in the user segment.

In another example, the content management system 130 can subscribe the users (and/or the devices associated with the users) in the user segment to the retargeting content 314. The content server(s) 120 can determine that the users in the user segment are subscribed to the retargeting content 314. In response, the content server(s) 120 can deliver the retargeting content 314 to the users in the user segment (e.g., to the devices associated with the users in the user segment). In some cases, the content management system 130 can subscribe the users to the user segment and the user segment to the retargeting content 314. The content server(s) 120 can determine that the user segment is subscribed to the retargeting content 314 and which users are subscribed to the user segment. The content server(s) 120 can then deliver the retargeting content 314 to the devices associated with the users in the user segment.

In some examples, the users in the user segment can be subscribed to the retargeting content 314 and the retargeting content 314 can be placed in a delivery queue. The content server(s) 120 or the content management system 130 can use the subscription of the users to the retargeting content 314 and the delivery queue associated with the retargeting content 314 to determine where to deliver the retargeting content 314 (e.g., to which users and/or associated devices to deliver the retargeting content 314). In some cases, the content server(s) 120 or the content management system 130 can optionally use the delivery queue to determine when to deliver the retargeting content 314 to the users in the user segment and/or associated devices.

The retargeting content 314 can be delivered to the user segment (e.g., to devices associated with the users in the user segment) within a same or different medium as the detected content 306. For example, in some cases, the retargeting content 314 can be delivered within a portion of the content signal 302 delivered to the media device(s) 106 (and any other devices receiving the content signal 302) after a portion of the content signal 302 containing the detected content 306 and after the user segment and the retargeting content 314 are created. To illustrate, if the detected content 306 was included in a segment of the media content 304 in the content signal 302, the retargeting content 314 can be delivered within a subsequent segment of the media content 304 in the content signal 302 that is delivered to the media device(s) 106 (and any other devices) after the user segment and the retargeting content 314 are created.

In other examples, the retargeting content 314 can be delivered within a different medium as the detected content 306. For example, rather than including the retargeting content 314 in a different portion of the media content 304 in the content signal 302, the retargeting content 314 can be included and/or presented within a page or user interface of a media application/platform, within different media content (e.g., a different live or pre-recorded/on-demand movie, TV show, video game, image, a screensaver, a backdrop, etc.) or within a content item or container in the different media content (e.g., within an advertisement unit, a video package, a display region, a page, a screen, a closed captions or subtitles portion, a background, a foreground, an designated region, etc.). In such cases, the retargeting content 314 can be presented to devices associated with users in the user segment as the devices receive, load, render, display, or play the different media content containing the retargeting content 314 or the content item or container in the different media content that contains the retargeting content 314.

To illustrate, in some cases, assume the media content 304 in the content signal 302 is a live video (e.g., a live movie, TV show, TV broadcast, etc.), the detected content 306 is an in-video overlay advertisement, and the retargeting content 314 is a banner advertisement generated based on the in-video overlay advertisement and/or containing the content (or a portion of the content) of the in-video overlay advertisement. In such examples, the banner advertisement (e.g., the retargeting content 314) can be delivered or presented within a different content item such as a page/interface/screen of a media application, a movie, a TV show, a video game, or any other content. The banner advertisement can be displayed to users in the user segment as the users access the different content item containing the banner advertisement (e.g., the page/interface/screen of the media application, the movie, the TV show, the video game, etc.).

In some cases, the content management system 130 can generate delivery parameters for the retargeting content 314. The delivery parameters can be based on one or more factors such as, for example and without limitation, a content of the detected content 306, a content of the retargeting content 314, a type of content and/or configuration of the retargeting content 314, the user segment, one or more characteristics of the user segment and/or the users in the user segment, a media campaign associated with the retargeting content 314 (and/or associated parameters), a preference(s) and/or rule(s) of a content provider associated with the retargeting content 314, a preference associated with the user segment or users in the user segment, content trends and/or statistics, a delivery medium/channel, context data, historical data, and/or any other data. The delivery parameters can specify and/or can be used to determine when to deliver or present the retargeting content 314, where to place or include the retargeting content 314, how to configure the retargeting content 314, a trigger for presenting or delivering the retargeting content 314, a type of device to provide or target the retargeting content 314 to from a set of devices associated with the users in the user segment, an interval (e.g., an exact interval, a maximum interval, and/or a minimum interval) between the presentation of the detected content 306 and the delivery and/or presentation of the retargeting content 314, and/or any other parameters.

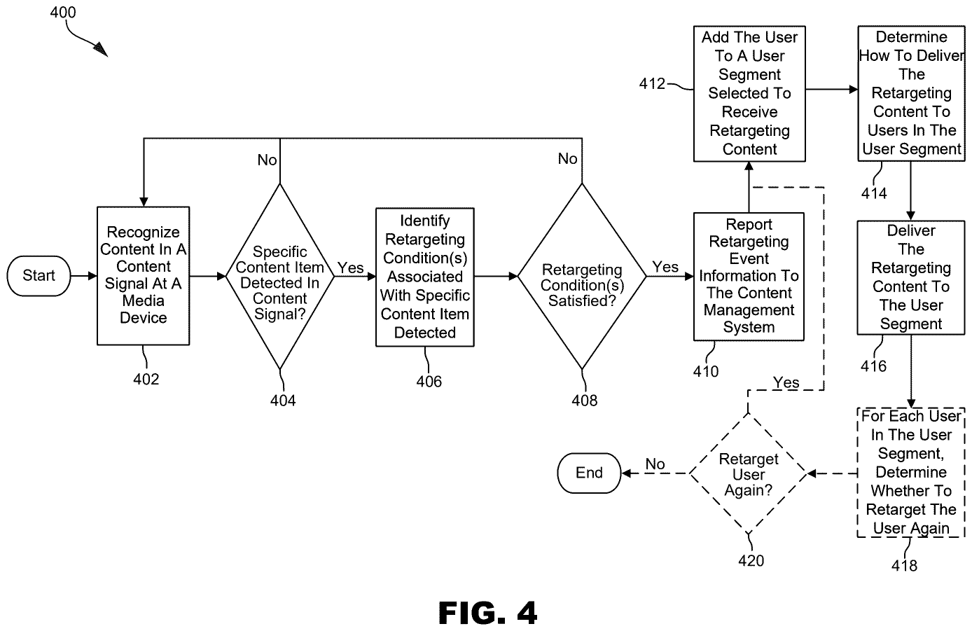

FIG. 4 is a flowchart illustrating an example method 400 for retargeting users with content, according to some examples of the present disclosure. The method 400 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 400. Further, some of the steps may be performed simultaneously, or in a different order than shown in FIG. 4, as will be understood by a person of ordinary skill in the art. Method 400 shall be described with reference to FIGS. 1 and 2. However, method 400 is not limited to those examples.

At step 402, the content recognition engine 220 can recognize content in a content signal at the media device(s) 106 associated with the user(s) 140. The content signal can include live or pre-recorded/on-demand content, such as a live video (e.g., live movie, live TV show, live/linear TV programming, live/linear TV channel content, live video broadcast, etc.), live audio (e.g., live music, live podcast, live audio signal of a live video, etc.), live text (e.g., closed captions of a live content, subtitles of a live content, etc.), live multimedia content (e.g., live audio-visual content, etc.), a livestream, a recorded video, an on-demand movie, a media content item, etc. The content signal can be received/streamed by the media device(s) 106 and/or used by the media device(s) 106 to play, display, and/or render content.

The content recognition engine 220 can use ACR to recognize content in the content signal. In some examples, the content recognition engine 220 can recognize content in the content signal as the content signal is received, processed, rendered, played, etc. In some cases, the content recognition engine 220 can check the content signal for certain content and/or type(s) of content, and determine whether any of such content and/or type(s) of content is detected/recognized in the content signal. For example, the content recognition engine 220 can be configured to recognize targeted content or certain targeted content (e.g., predetermined targeted content, targeted content having one or more attributes, targeted content associated with one or more companies or content providers, targeted content matching a targeted content filter or condition, targeted content from a list of targeted content, etc.) and/or certain type(s) of targeted content. If the content signal includes that content and/or type(s) of content, the content recognition engine 220 can detect and recognize such content in the content signal. As another example, the content recognition engine 220 can be configured to detect content that has one or more characteristics, such as certain visual characteristics, behavior, experience, content source, content message, promoted content or item, content type, content identifier or name/title, content parameters, etc. If any content in the content signal includes the one or more characteristics, the content recognition engine 220 can detect such content for use in a retargeting decision, as further described herein.

At step 404, the content recognition engine 220 can determine whether the recognized content in the content signal includes or matches a specific content item. The content recognition engine 220 can determine whether the recognized content includes or matches the specific content item in real-time or near real-time. For example, the content recognition engine 220 can determine whether the recognized content in the content signal includes the specific content item as the content signal is received by the content recognition engine 220 (and the media device(s) 106) and/or as the portion of the content signal containing the specific content item is received.

In some examples, the content recognition engine 220 can determine whether any of the recognized content includes one or more characteristics configured to trigger a detection event by the content recognition engine 220 (e.g., trigger detection of the specific content item at step 404). In another example, the content recognition engine 220 can determine whether the recognized content is a targeted content item, a specific type(s) of targeted content item, a specific targeted content item, or any other specific content item configured to trigger a detection event. If so, the content recognition engine 220 can trigger the detection event. Accordingly, the content recognition engine 220 can detect the specific content item at step 404.

In some cases, when determining whether recognized content includes the specific content item, the content recognition engine 220 can check for certain content or type(s) of content, such as targeted content or a type(s) of targeted content. The content recognition engine 220 can filter content that does not match a detection criteria, matches a filter, does not match any content items in or identified in the targeted content 136B, and/or does not satisfy a retargeting condition. The content recognition engine 220 can filter, exclude, or ignore such content from the determination at step 404, and include other detected content in the determination at step 404. In some cases, the content recognition engine 220 can determine whether the recognized content includes the specific content item by comparing the fingerprint of any recognized content item to the fingerprints of content items in or identified in the targeted content 136B. If the fingerprint of a content item detected in the content signal matches a fingerprint of a content item in or identified in the targeted content 136B, the content recognition engine 220 can determine that the content item is a targeted content item, and determine that the recognized content item in the content signal includes the specific content item (e.g., the targeted content item).

In some cases, the content recognition engine 220 can determine whether any content in the content signal satisfies a retargeting condition(s), matches or does not match a filter, or satisfies or does not satisfy a criteria/cue or an exclusion criteria/cue. If the content recognition engine 220 determines that a content item in the content signal satisfies a retargeting condition(s), does not match a filter, satisfies a criteria/cue, and/or does not satisfy an exclusion criteria/cue, the content recognition engine 220 can determine that such content is the specific content item (e.g., a targeted content item). Thus, the content recognition engine 220 can determine at step 404 that the recognized content in the content signal includes the specific content item.

In some examples, the content recognition engine 220 can additionally or alternatively recognize the specific content item in the content signal based on a content, attribute, metadata, source, and/or characteristic of the content detected/recognized in the content signal. For example, the content recognition engine 220 can recognize whether a content item in the content signal is a targeted content item or another type of content item based on a content, attribute, metadata, and/or characteristic of the content item in the content signal.

In some cases, the content recognition engine 220 may not filter content detected in the content signal. In other cases, the content recognition engine 220 can determine that the specific content item was detected in the content signal if the detection result includes certain content and/or type of content such as targeted content matching one or more criteria, matching or satisfying a retargeting condition(s), not matching a filter or exclusion criteria, matching content in or identified in the targeted content 136B, matching a certain type(s) of content (e.g., invitational content or advertisements, targeted media, etc.), and/or associated with one or more targeting cues. In some examples, the content recognition engine 220 can optionally identify any targeted content (or any other type of content) detected in the content signal and, for each targeted content item detected in the content signal, determine whether to filter the targeted content item (e.g., exclude the targeted content item from retargeting decisions or reporting to the content management system 130) or include the targeted content item in its detection results.

If the content recognition engine 220 determines that the specific content item was not detected in the content signal, the method 400 can return to step 402 (or end if there are no more content in the content signal). If the content recognition engine 220 determines at step 404 that the specific content item was detected in the content signal, the method 400 can proceed to step 406.

At step 406, the content targeting engine 222 can identify a retargeting condition(s) associated with the specific content item detected in the content signal (e.g., a targeted content item detected in the content signal at step 404). The retargeting condition(s) can include any filter, rule, preference, factor, logic, criteria, cue, and/or information used to determine whether the user(s) 140 should be retargeted with content based on or associated with the specific content item, the detection of the specific content item should be reported to the content management system 130 for a user retargeting determination, or whether the media device(s) 106 should notify the content management system 130 that the user(s) 140 and the specific content item satisfy a retargeting condition(s) and/or should be associated with a user segment used for retargeting content to users associated with the specific content item.

In some cases, the retargeting condition(s) can include a playback/presentation activity of the specific content item at the media device(s) 106, an interaction (or type of interaction) of the user(s) 140 with the specific content item, a user input associated with the specific content item (e.g., a user “like”, a user rating, a positive feedback or comment, a replay input, a rewind input, a store or record input, a subscribe input, a share or recommend input, etc.), a match between a user preference or characteristic and the specific content item or a characteristic(s) thereof, a user activity or lack of user activity during a playback or presentation of the specific content item, a threshold likelihood of interest by the user(s) 140 in the specific content item, a threshold interest of the user(s) 140 in the specific content item, a content trend or pattern associated with the user(s) 140, a match between the specific content item detected in the content signal and content in or identified in the targeted content 136B, and/or any other retargeting condition(s), information, and/or cue described herein.

For example, the retargeting condition(s) can include a determination that the user(s) 140 liked the specific content item, was engaged in the specific content item, played or replayed the specific content item, watched the specific content item, was interested in (or is estimated to have a threshold likelihood of being interested in) the specific content item, indicated or demonstrated a threshold interest in the specific content item, interacted with the specific content item, initiated a conversion action associated with the specific content item, etc. In some cases, the retargeting condition(s) can additionally or alternatively include an absence of certain conditions, factors, cues, activity, and/or indicia. For example, the retargeting condition(s) can include a determination that the user(s) 140 did not skip or ignore the specific content item, a determination that the user(s) 140 did not close or forwarded the specific content item, a determination that the user(s) 140 was not distracted with other content (e.g., based on user activity with other content) during playback/presentation of the specific content item, a determination that the user(s) 140 did not trigger a timeout from inactivity during playback/presentation of the specific content item, and/or an indication that the user(s) 140 did not dislike the specific content item (e.g., based on an input “disliking”, unsubscribing from, or negatively commenting on the specific content item).

At step 408, the content targeting engine 222 can determine whether the retargeting condition(s) associated with the specific content item was satisfied. For example, the content targeting engine 220 can analyze the specific content item, the retargeting condition(s), and any targeting information and/or cues to determine whether the retargeting condition(s) associated with the specific content item was satisfied by or with respect to the user(s) 140. The targeting information and/or cues can include, for example, user preferences, user activity, user interactions, user inputs, user characteristics, content activity at the media device(s) 106, characteristics of the specific content item, and/or any other information.

If the content targeting engine 222 determines that the retargeting condition(s) was not satisfied, the method 400 can return to step 402 (or end if there is no more content in the content signal). If the content targeting engine 222 determines that the retargeting condition(s) was satisfied, the method 400 can proceed to step 410.

At step 410, the content targeting engine 222 can report retargeting event information to the content management system 130. In some examples, the retargeting event information can include an indication of the specific content item detected in the content signal, an indication that the specific content item matches content in or identified in the targeted content 136B, an indication that the user(s) 140 matches any retargeting criteria, an indication that the user(s) 140 satisfies a retargeting condition(s), an event used to determine to retarget the user(s) 140 with content associated with the specific content item (e.g., a playback event, a replay event, a content watching event, a content interaction event, an input event, a user activity event, etc.), an indication that the specific content item matches a particular type of content and/or content characteristic(s) or attribute(s), an indication that one or more retargeting conditions were satisfied with respect to the user(s) 140 and the specific content item, and/or any other targeting information and/or cues.

In some examples, the retargeting event information can include a notification to the content management system 130 indicating that the specific content item was detected in the content signal at the media device(s) 106. In some cases, the retargeting event information can include other information such as any information used to determine that the specific content item satisfies a retargeting condition(s), information about the user(s) 140 (e.g., a user identifier, a user name, a unique identifier, a user email, a user profile, etc.), information about the media device(s) 106 (e.g., location information, an IP address, a MAC address, a unique device identifier, an address, etc.), the specific content item, information identifying the specific content item (e.g., a content identifier, a fingerprint, etc.), an indication that the specific content item satisfies the retargeting condition(s), a request to add or subscribe the user(s) 140 to a user segment representing users selected for retargeting with content associated with the specific content item, a request to retarget the user(s) 140 with content associated with the specific content item, a request to subscribe the user(s) 140 to retargeting content associated with the specific content item, information about a retargeting event (e.g., a content detection event, a determination that content detected in the content signal satisfies a retargeting condition(s), a retargeting decision, etc.), and/or any other information.

Based on the retargeting event information reported by the content targeting engine 222, at step 412, the segmentation engine 132 of the content management system 130 can add the user(s) 140 to a user segment representing users selected for retargeting with content associated with the specific content item. In some examples, the segmentation engine 132 can determine to retarget the user(s) 140 with content associated with the specific content item and add the user to a user segment selected for retargeting with content associated with the specific content item. In some cases, the segmentation engine 132 can subscribe the user segment, the users in the user segment, and/or the devices associated with the users in the user segment to retargeting content associated with the specific content item. For example, the segmentation engine 132 can add the user segment (or associated users and/or devices) to a content delivery or retargeting queue configured to deliver retargeting content to the user segment.

In some cases, the segmentation engine 132 can include information in the user segment or associate the user segment with information uniquely identifying the user segment, associating the user segment with the targeting content associated with the specific content item, associating the users in the user segment with respective devices, uniquely identifying the users in the user segment, uniquely identifying content associated with the user segment (e.g., the specific content item and/or associated retargeting content), identifying one or more retargeting parameters, and/or any other information.

The user segment can be associated with retargeting content selected for delivery to users (e.g., associated devices) in the user segment. The retargeting content can include any content associated with the specific content item. For example, the retargeting content can include the same content as the specific content item, a version of the specific content item (e.g., a modified version, an updated version, a version configured with a different behavior or experience, a version configured with a different attribute, a version configured with a different advertisement unit if the specific content item is an advertisement, a version configured with a different design or style, a version configured as a different content type, etc.), a different content than the specific content item, a content item selected based on the specific content item (e.g., based on a similarity or relevance score between the content item and the specific content item, based on a common source or developer, based on a common category or genre, based on a common content collection or franchise, based on a common attribute, based on a common brand or product/company, based on a similar attribute, based on a relationship between the content item and the specific content item, based on a matching criteria, etc.), and/or any other content.

At step 414, the content management system 130 can determine how to retarget the retargeting content to the users in the user segment. For example, the content management system 130 can determine when to deliver the retargeting content to the devices of the users in the user segment, how to deliver the retargeting content to the devices of the users, how to configure and/or format the retargeting content delivered to the devices of the users, where to place or present the retargeting content for the users, how to trigger a delivery of the retargeting content to the users, how to generate or configure the retargeting content associated with the specific content item, and/or any other information used to deliver the retargeting content to the devices of the users in the user segment.

At step 416, the content management system 130 can deliver the retargeting content to the users (e.g., to the user devices) in the user segment. In some examples, the content management system 130 can deliver the retargeting content to the devices associated with the users for presentation with or within a selected content item, medium, channel, screen, page, application, and/or interface. In other examples, the content management system 130 can create the retargeting content based on the specific content item detected in the content signal or modify the specific content item to generate the retargeting content. In some cases, the content management system 130 can obtain, identify, and/or trigger a delivery of the retargeting content from a source, such as the content server(s) 120.

In some cases, the retargeting content can include or be selected based on a content (or portion thereof), advertisement, promotion, message, content, and/or attribute of the specific content item. In some cases, the retargeting content can have a different format, configuration, attribute, appearance, style, design, delivery medium, behavior, setting, parameter, content, and/or characteristic than the specific content item. For example, the specific content item can include promotional content in a media format and the retargeting content can include the promotional content or a version thereof in a different media format. In another example, the specific content item can include an animated message recommending a particular movie to the user(s) 140, and the retargeting content can include a banner promoting another movie in a same movie franchise or collection.

In some cases, when retargeting the user segment with the retargeting content, the content management system 130 can deliver the retargeting content to the devices associated with the users in the user segment. In other cases, the content management system 130 can instruct another system, such as the content server(s) 120, to deliver the retargeting content to the devices associated with the users in the user segment or subscribe the users in the user segment to the retargeting content in the content server(s) 120. The content server(s) 120 can then deliver the retargeting content to the devices associated with the users in the user segment.

In some cases, the content management system 130 or the content server(s) 120 can maintain a queue of content selected for user segments, and retarget users in user segments based on the queue of content and the user segments. For example, the content management system 130 or the content server(s) 120 can include a distributed storage system that stores copies of content and maintains content delivery queues based the user segments created by the content management system 130 and associated content. The distributed storage system or an application (e.g., a microservice or any application) can deliver content from the queues to users in respective user segments associated with the content.

The retargeting content can be delivered to users in the user segments within a content platform or application, or across content platforms or applications. For example, in some cases, the retargeting content can be delivered to users in an associated user segment. The retargeting content can be displayed for the users within a particular content platform or application, or across multiple content platforms or applications.

At step 418, for each user in the user segment, the content management system 130 can optionally determine whether to retarget the user with content again. The content management system 130 can determine whether to retarget a user again based on any of the retargeting conditions, information, cues, and/or factors described herein. For example, the content management system 130 can determine whether to retarget a user with content associated with the specific content item or the retargeting content again based on a reception of the retargeting content by the user, an interaction with the retargeting content by the user, a user input during a playback or presentation of the retargeting content, user activity or inactivity during a playback or presentation of the retargeting content, user feedback regarding the retargeting content, a retargeting condition(s), an indication of user interest/disinterest or engagement/disengagement with respect to the retargeting content, etc.

At step 420, if the content management system 130 determines not to retarget a user with content associated with the specific content item or the retargeting content again, the method 400 can end or proceed to step 402. If the content management system 130 determines to retarget a user with content again, the method 400 can optionally proceed from step 420 to step 412, where the segmentation engine 132 of the content management system 130 can add the user to a user segment representing users selected for retargeting with certain content, such as content determined based on the retargeting content and/or the specific content item. The method 400 can continue from step 412 to step 414, 416, and optionally 418 and/or 420 as previously described.

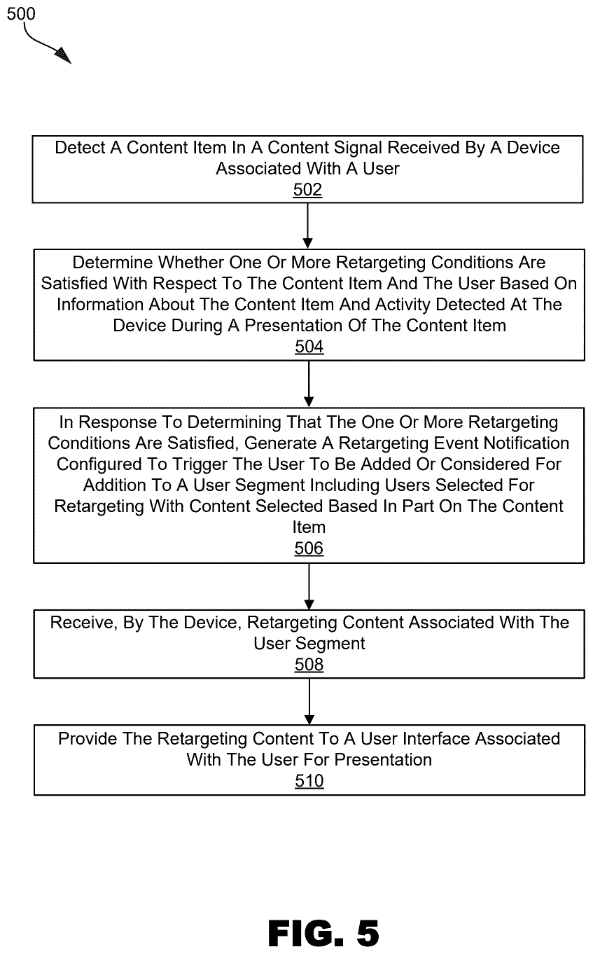

FIG. 5 is a flowchart illustrating an example method 500 for retargeting users with selected content, according to some examples of the present disclosure. The method 500 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 500. Further, some of the steps may be performed simultaneously, or in a different order than shown in FIG. 5, as will be understood by a person of ordinary skill in the art. Method 500 shall be described with reference to FIGS. 1 and 2. However, method 500 is not limited to those examples.

At step 502, the media device(s) 106 associated with the user(s) 140 can detect (e.g., content targeting system 210 via content recognition engine 220) a content item in a content signal received by the media device(s) 106. In some cases, the content signal can include a live content signal, such as a live video signal, a livestream signal, a live video broadcast, a linear TV signal, etc. In other cases, the content signal can include a pre-recorded/on-demand content signal. The media device(s) 106 (e.g., the content recognition engine 222) can use ACR (e.g., an ACR model or algorithm) to process the content signal and detect the content item in the content signal. The media device(s) 106 can detect content items in the content signal, select specific content items, and/or filter content items, as further described herein. In some cases, the media device(s) 106 (e.g., the content recognition engine 222) can be configured to detect certain types of content items and/or content items having certain attributes, content, characteristics, behaviors, input elements, interactive content, metadata, flags, content providers, messages, owners, authors, sources, objects, patterns, formats, configurations, parameters, and/or cues. The media device(s) 106 can detect the content item in real-time or near real-time (e.g., as the portion of the content signal containing the content item is received, processed, displayed, played, buffered, completed, etc.).

In some cases, the media device(s) 106 can detect content items in the content signal and identify the content item from detected content items based on a content of the content item and/or one or more attributes, behaviors, characteristics, input elements, interactive content elements, metadata, flags, content providers, messages, owners, authors, sources, objects, patterns, formats, configurations, parameters, and/or cues associated with the content item. The media device(s) 106 can then select the content item as the detected content item and filter or exclude other content items detected. In some cases, the media device(s) 106 can apply a filter, logic, and/or condition(s) to the content item as described below, to determine whether to select the user(s) 140 for retargeting with content associated with the content item.

In some cases, the content signal can include a live video and the media device(s) 106 can detect the content item in the live video during playback or presentation of the live video. The media device(s) 106 can detect the content item in the live video using an ACR model or algorithm.

At step 504, the media device(s) 106 (e.g., the content targeting system 210 via content targeting engine 222) can determine whether one or more retargeting conditions are satisfied with respect to the content item and the user based on information about the content item and activity detected at the device during a presentation of the content item. In some cases, the information about the content item can include a content item type and/or a determination that the content item matches a predetermined type of content and/or predetermined content item from a plurality of content items. For example, the media device(s) 106 can determine whether the content item matches a targeted content item, a type of targeted content item, customized media content, invitational content, targeted content or a type of targeted content, banner content, overlay content. In some examples, the information about the content item and/or the activity detected at the device during the presentation of the content item can additionally or alternatively include one or more attributes (e.g., input elements, interactive content elements, visual elements, objects, behaviors, configurations, formats, flags, content characteristics, patterns, messages, sources, etc.) associated with the content item, a type of media content of the content item, an indication that the content item is a targeted content item, etc. In some cases, the media device(s) 106 can determine whether the content item matches content in or identified in the targeted content 136B and, if so, determine that the content item matches the predetermined content item or the predetermined type of content.

In some cases, the information about the content item can additionally or alternatively include a content description, a content identifier, a content title, a content source or developer, a content statistic, a content attribute, a content of the content item, a content behavior, a content experience, a content activity at the media device(s) 106, a user activity during a presentation of the content item, an interaction between the user(s) 140 and the content item, device activity during a presentation of the content item, retargeting cues detected or collected during a presentation of the content item, a user input(s) associated with the content item, a performance of the content item with respect to the user(s) 140, etc. The one or more retargeting conditions can include or define one or more factors, criteria, cues, rules, parameters, and/or indicia used to determine whether to retarget the user(s) 140 with content associated with the content item detected in the content signal.

For example, the one or more retargeting conditions can include and/or can be satisfied based on, without limitation, a determination that the content item matches targeted content in or identified by the targeted content 136B, a determination that the content item matches predetermined content and/or retargeting content available at one or more content sources (e.g., the content server(s) 120, the content management system 130, etc.), a determination or indicia indicating that the user(s) 140 consumed (e.g., watched, played, replayed, etc.) the content item, a determination that the user(s) 140 is likely interested in the content item, determination that the user(s) 140 has a threshold likelihood of liking the content item, determination that the user(s) 140 has a threshold likelihood of finding the content item appealing/engaging, determination that the user(s) 140 has a threshold likelihood of reacting positively to being retargeted with content associated with the content item, determination that the user(s) 140 interacted with the content item, determination that the user(s) 140 engaged with the content item, determination that the user(s) 140 did not skip or ignore the content item, determination that the user(s) 140 engaged in certain activity during playback or presentation of the content item, a determination that the media device(s) 106 did not detect or log activity associated with the user(s) 140 (e.g., user inactivity) during a playback or presentation of at least a portion of the content item, a determination that the media device(s) 106 received certain user input(s) during playback or presentation of the content item, and/or any other factors, determinations, and/or indicia described herein.

The certain user input(s) can include, for example and without limitation, an input “liking”, subscribing to, initiating playback or replay of, adjusting a setting of (e.g., increasing a volume, maximizing or increasing a size of a window depicting the content, moving a window depicting the content, adjusting a content setting such as a resolution or framerate, etc.), commenting on, rewinding, and/or providing feedback on the content item.

As previously noted, in some cases, the media device(s) 106 can determine that the one or more retargeting conditions are satisfied additionally or alternatively based on a comparison of the content item with content in or identified in the targeted content 136B. In some cases, the information about the content item and/or the activity detected at the device during the presentation of the content item used to determine that the one or more retargeting conditions are satisfied can include a user activity and/or an input(s) during a playback of the content item and/or the presentation of the content item. In some cases, the information about the content item and/or the activity detected at the device during the presentation of the content item used to determine that the one or more retargeting conditions are satisfied can additionally or alternatively include information indicating a lack/absence of a user input(s) and/or activity during a playback of the content item and/or the presentation of the content item. For example, the determination that the one or more retargeting conditions are satisfied can be based on a determination that the media device(s) 106 associated with the user(s) 140 played, replayed, and/or displayed the content item without interruption from the user(s) 140 (e.g., without an input skipping, ignoring, closing, silencing, forwarding, blocking, obstructing, or interrupting the content item) and/or without an input indicating a lack of interest or a disinterest of the user(s) 140 in the content item (e.g., without an input disliking the content item, negatively rating/commenting on the content item, blocking the content item, closing the content item, requesting not to receive the content item, etc.).

The information about the content item and/or the activity detected at the device during the presentation of the content item used to determine that the one or more retargeting conditions are satisfied can additionally or alternatively include a cue(s) indicating a content disinterest or disengagement (or a threshold amount of interest or engagement) of the user(s) 140 during a playback of the content item and/or the presentation of the content item. Non-limiting examples of cues indicating content disinterest or disengagement (or a lack of a threshold interest or engagement) can include or can be based on a lack of a user response to a prompt in the content item, a lack of a user input during a portion of the content item expecting (e.g., requesting, eliciting, etc.) a user input, user inactivity or a threshold period of user inactivity during a playback or presentation of the content item, a timeout period triggered by user inactivity during a playback or presentation of the content item, a user input interacting with a different content item (e.g., a different application, window, content item, etc.) during the playback or presentation of the content item, a user input conveying a negative emotion/sentiment or reaction with respect to the content item (e.g., a negative comment, an input “disliking” the detected content, an input blocking the content item (and/or associated content), an input skipping or closing the content item, an input providing a rating of the content item that is below a threshold, a user input in a portion of the content item (or a portion of the screen displaying the content item) that is not associated with an input function (e.g., an input in a region that does not include an input element, such as a button or a link, or interactive content, which can indicate the user(s) 140 is/was distracted or disengaged), an input forwarding the content item, etc.

In some cases, the media device(s) 106 can determine that the one or more retargeting conditions are satisfied in response to detecting the content item and determining that the content item matches a predetermined type of content (e.g., targeted content, customized media content, invitational content, interactive content, overlay content, banner content, etc.) and/or a predetermined content item (e.g., a targeted content item, an item in or identified in the targeted content 136B, etc.). The information about the content item can indicate or can be used to determine that the content item matches the predetermined type of content and/or the predetermined content item.

In some examples, the information about the content item and/or the activity detected at the device during the presentation of the content item can include a cue detected during the presentation of the content item. The cue can indicate or can be used to determine that the presentation of the content item was not interrupted by a user input, an input element configured to skip or close the content item was not activated, a user input received during the presentation of the content item includes an interaction with the content item, a received user input includes a request to replay at least a portion of the content item, a user input received during the presentation of the content item matches an input predetermined to indicate positive user feedback, a user comment includes content recognized as positive feedback associated with the content item, and/or user activity during the presentation of the content item includes viewing the content item.

In some cases, the information about the content item and/or the activity detected at the device during the presentation of the content item can include user data and/or device data detected during the presentation of the content item. The user data and/or device data can include, for example and without limitation, a user input, a user comment, a user request, a user subscription, a user interaction, a user activity, user inactivity, a presentation record associated with the content item, a playback record associated with the content item, and/or a device operation.

In some examples, the information about the content item and/or activity detected at the device during presentation of the content item can include a determination that the content item matches (or has a threshold relevance or similarity to) a predetermined type of content and/or predetermined content item. In some cases, determining that the content item matches the predetermined type of content and/or the predetermined content item can include comparing the content item with a plurality of predetermined content items and determining that the content item matches the predetermined content item from the plurality of predetermined content items based on a threshold match between the content item and the predetermined content item. The plurality of predetermined content items can include targeted content items in or identified in/by the targeted content 136B and/or any other predetermined content items.

In one illustrative example, determining whether the content item matches the predetermined type of content and/or the predetermined content item can include comparing a fingerprint generated for the content item with respective fingerprints generated for the plurality of predetermined content items, determining that the fingerprint generated for the content item matches (e.g., is a threshold match, has a threshold matching score, is the same/identical, etc.) a respective fingerprint of the predetermined content item, and determining that the content item matches the predetermined content item based on the determination that the fingerprint generated for the content item matches the respective fingerprint of the predetermined content item.

In another illustrative example, determining whether the content item matches the predetermined type of content and/or the predetermined content item can additionally or alternatively include recognizing a content of the content item, one or more attributes of the content item, one or more inputs associated with the content item, one or more interactive features associated with the content item, an object depicted in the content item, and/or a content provider associated with the content item, based on recognizing the content, the one or more attributes, the one or more inputs, the one or more interactive features, the object, and/or the content provider, determining that the content item includes a targeted content item, and in response to determining that the content item includes targeted content, determining that the content item matches the predetermined type of content.

In some examples, the determination that the one or more retargeting conditions are satisfied can be in response to detecting the content item and determining that the content item matches a predetermined type of content, a predetermined content item, and/or a selection criteria.

In some examples, the media device(s) 106 can classify the content item as a targeted content item; in response to classifying the content item as a targeted content item, the media device(s) 106 can trigger a detection event that includes detecting the targeted content item in the live content signal; and in response to the detection event, the media device(s) 106 can trigger a collection of data used to make a retargeting decision and/or a determination whether to retarget the user with content selected based at least in part on the content item including the targeted content item. The data used to make the retargeting decision can include the information about the content item and the activity detected at the device during the presentation of the content item. In some cases, the activity detected at the device can include user activity, user inactivity, device activity, and/or content activity associated with the content item.

In some examples, determining whether one or more retargeting conditions are satisfied with respect to the content item and the user can include determining that the detection of the content item in the live content signal includes a content retargeting triggering event candidate based on a content of the content item, a type of content item of the content item, a behavior or configuration of the content item, an entity associated with the content item, and/or a product or brand associated with the content item; and in response to the content retargeting triggering event candidate, collecting the information about the content item and the activity detected at the device during the presentation of the content item and determining whether the one or more retargeting conditions are satisfied based on a detection of the content retargeting triggering event candidate, the information about the content item, and the activity detected at the device during the presentation of the content item.

In some cases, determining whether the one or more retargeting conditions are satisfied can include recognizing a content of the content item, a attribute(s) of the content item, an input(s) associated with the content item, an interactive feature(s) associated with the content item, an object depicted in the content item, a brand associated with the content item, and/or a content provider associated with the content item; and triggering the retargeting event notification based on the content, the attribute(s), the input(s), the interactive feature(s), the object, the brand, and/or the content provider associated with the first content item.

At step 506, in response to determining that the one or more retargeting conditions are satisfied, the media device(s) 106 (e.g., the content targeting engine 222) can generate a retargeting event notification configured to trigger the user(s) 140 to be added (or subscribed) or considered for addition to a user segment that includes users selected for retargeting with content selected based at least in part on the content item. In some examples, the media device(s) 106 can send the retargeting event notification to the content management system 130. For example, the media device(s) 106 can send the retargeting event notification to the content management system 130 via a message(s), an application programming interface (API) call(s), a packet(s), an instruction, a command, and/or any other electronic communication. The content management system 130 (e.g., via segmentation engine 132) can use the retargeting event notification to add or subscribe the user(s) 140 to the user segment, determine whether to add or subscribe the user(s) 140 to the user segment, determine whether to retarget the user(s) 140 with content, and/or determine the content to provide to the user(s) 140 (and/or user segment) when retargeting the user(s) 140.

In some cases, the retargeting event notification can include a notification of a decision to retarget the user(s) 140 with content associated with the content item or a request to retarget the user(s) 140 with content associated with the content item and/or add the user(s) 140 to the user segment used to retarget users with content associated with the content item. The content management system 130 or the media device(s) 106 can add or subscribe the user(s) 140 to the user segment or determine whether to add or subscribe the user(s) 140 to the user segment based on the retargeting event notification. The user segment can be used to identify which users to retarget with content associated with the content item, what retargeting content to provide to the users in the user segment when retargeting the users, the devices associated with the users in the user segment used to receive the retargeting content, how and/or when to deliver the retargeting content to the users and/or associated devices, etc. By adding or subscribing the user(s) 140 to the user segment the content management system 130 or media device(s) 106 can ensure that the user(s) 140 (and/or the media device(s) 106) receives the retargeting content associated with the content item or is retargeted with content. The user segment (and/or the users in the user segment) can optionally be subscribed to retargeting content and/or added to a queue for delivering the retargeting content. Accordingly, the user segment can cause the users in the user segment to receive and be retargeted with content associated with the user segment.

In some examples, the retargeting event notification can include an indication that the content item was detected in the content signal, an indication that the content item is a targeted content item or is classified as a targeted content item, an indication that the content item matches a predetermined type of content and/or the predetermined content item, an indication that a presentation of the content item was not interrupted by a user input, an indication that an input element configured to skip or close the content item was not activated, an indication that a user input received during the presentation of the content item includes an interaction with the content item, an indication that a received user input includes a request to replay at least a portion of the content item, an indication that a user input received during the presentation of the content item matches an input recognized as indicating or predetermined to indicate positive user feedback, an indication that a user comment includes content recognized as positive feedback associated with the content item, an indication that a user activity during the presentation of the content item includes viewing the content item, a request to retarget the user(s) 140 with content, and/or an indication that the one or more retargeting conditions were satisfied.

At step 508, the media device(s) 106 can receive retargeting content associated with the user segment. In some examples, the media device(s) 106 can receive the retargeting content based on (e.g., in response to, upon, as a result of, after, according to, etc.) a determination that the user(s) 140 was added or subscribed to the user segment and/or a decision to retarget the user(s) 140 with content. The retargeting content can include content selected for to users in the user segment, including the user(s) 140.

For example, the retargeting content can include content associated with the content item, such as a copy or version of the content item, content related to the content item, content having a threshold similarity or relevance to the content item, content having a relationship to the content item, content belonging to a same content franchise/collection or owner/producer as the content item, content associated with a same brand or product/service, content having one or more attributes in common with the content item, content having a same or similar message or information as the content item, content promoting a same item as the content item, content of a same type of content as the content item, content having one or more commonalities with the content item, content matched with the content item, etc.

In some examples, the retargeting content can include, without limitation, a content of the content item, a portion of the content of the content item, or a different content than the content of the content item. The retargeting content can include or implement a same or different format, configuration, design, attribute, behavior, visual appearance, advertisement unit, and/or delivery medium than/as the content item. The retargeting content can additionally or alternatively include a modified version of the content item or content generated based on the content item. For example, if the content item includes a banner advertisement, the retargeting content can include a different type of advertisement, such as an overlay advertisement, a video advertisement, an offerwall advertisement, a skippable or non-skippable advertisement, an interactive advertisement, an in-feed advertisement, an audio advertisement, a logo advertisement, a text advertisement, or any other type of advertisement.

In some cases, the retargeting content can have a same or similar content as the content item but may be configured to provide a different experience than the content item. For example, assume that the content item is a static advertisement for a video game. The retargeting content can include an animated advertisement of the video game that can take the user(s) 140 to a purchasing page when the user(s) 140 selects an input element in the retargeting content or can load the video game upon the user(s) 140 selecting the input element.

The media device(s) 106 can receive the retargeting content from the content management system 130, the content server(s) 120, or any other content source. In some cases, the content management system 130 and/or the content server(s) 120 can use the user segment to identify users (and/or associated devices) to retarget with the retargeting content. The content management system 130 and/or the content server(s) 120 can then deliver the retargeting content to the media device(s) 106 associated with the user(s) 140 and any other devices of any other users in the user segment. For example, the content management system 130 can deliver the retargeting content to the devices associated with the users in the user segment (including the media device(s) 106 associated with the user(s) 140), trigger (e.g., via a command, scheduled or triggering event, rule, API call, operation, request, etc.) the content server(s) 120 to deliver the retargeting content to such devices, and/or place the retargeting content in a content delivery or retargeting queue to trigger the retargeting content to be delivered (e.g., based on the queue) to such devices by a system, application, or service/microservice associated with the queue.

In some cases, the content server(s) 120 can use the user segment to identify recipients for the retargeting content and deliver the retargeting content to the devices associated with the recipients (including the media device(s) 106 associated with the user(s) 140). The content management system 130 can additionally or alternatively instruct the content server(s) 120 to deliver the retargeting content to the devices associated with the users in the user segment (including the media device(s) 106 associated with the user(s) 140). In some cases, the content management system 130 can trigger (e.g., based on a command, scheduled or triggering event, message, API call, request, rule, operation, etc.) or instruct the devices associated with the users in the user segment (including the media device(s) 106 associated with the user(s) 140) to load, stream, receive, retrieve, play, render, display, and/or surface the retargeting content to the users. For example, the content management system 130 can trigger the media device(s) 106 to display the retargeting content for the user(s) 140 within or according to a particular location, content item, display region, medium, channel, display, content presentation, application, platform, target, format, configuration, attribute, behavior, appearance, design, timing, sequence, page (e.g., application page, web page, etc.), experience, session, etc.

The retargeting content can be delivered to the media device(s) 106 associated with the user(s) 140 and any other device associated with any other user in the user segment based on the user segment. For example, the user segment can identify users and/or devices selected to receive the retargeting content or subscribe the users and/or devices to receive the retargeting content. The user segment can thus trigger the retargeting content to be delivered to the devices associated with the users in the user segment (including the media device(s) 106 associated with the user(s) 140).

In some cases, the user segment can include additional information for retargeting the users in the user segment such as, for example and without limitation, information about the devices associated with the users (e.g., IP addresses, MAC addresses, hostnames, DNS names, etc.), information about the users (e.g., user identifiers, usernames, user profiles, user preferences, user devices, user locations, user demographics, user historical data, user statistics, user emails, user addresses, etc.), retargeting parameters (e.g., timing information, triggers, queues, delivery mediums or sources, content placement or organization, content configurations, content attributes, content appearances, content types, content behaviors, content portions, content objects, content tags, delivery parameters, etc.), retargeting instructions, retargeting content generation parameters or instructions, associations between users and devices, an association between the retargeting content and the user segment, and/or any other information.

At step 510, the media device(s) 106 can provide the retargeting content to a user interface associated with the user(s) 140 (e.g., for presentation to the user(s) 140). In some cases, providing the retargeting content to a user interface can include rendering and/or displaying the retargeting content for the user(s) 140 (e.g., via a display device(s) such as display device(s) 108), loading the retargeting content on the user interface, or instructing the user interface to present the retargeting content. In some examples, the user interface associated with the user(s) 140 can include, for example, a user interface loaded, opened, viewed, interacted with, and/or displayed by a display device (e.g., a display of the media device(s) 106, the display device(s) 108, etc.) for the user(s) 140. The user interface can include an application interface, a web browser, a user interface page, a media platform interface, a content interface, a device interface, or any other interface.

In some cases, the media device(s) 106 can display the content item within a video associated with the content signal, and display the retargeting content within a different video, an application, a page of an application, a banner, an overlay content, a web browser, a window, a user interface, an image, a visual element, an interface, and/or a media content item.

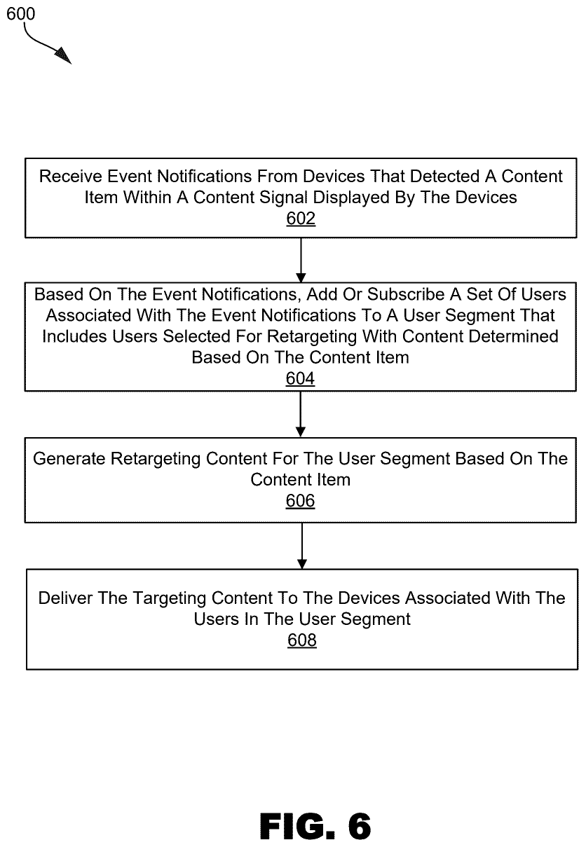

FIG. 6 is a flowchart illustrating another example method 600 for retargeting users with selected content, according to some examples of the present disclosure. The method 600 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the method 600. Further, some of the steps may be performed simultaneously, or in a different order than shown in FIG. 6, as will be understood by a person of ordinary skill in the art. Method 600 shall be described with reference to FIGS. 1 and 2. However, method 600 is not limited to those examples.

At step 602, the content management system 130 can receive event notifications from devices that detected a content item within content signals displayed by the devices. The devices can be associated with users. Moreover, the devices can include the media device(s) 106 associated with the user(s) 140. The event notifications can notify the content management system 130 of content detected by the devices within content signals (e.g., a content item detected within a content signal), information about the devices (e.g., an address, etc.), information about the users (e.g., user identifiers, usernames, user profiles, user addresses, user statistics, user inputs, user activity, user content interactions, user preferences, user data, etc.), retargeting information and/or cues, retargeting conditions, retargeting requests, content statistics, content preferences, etc.

In some cases, the event notifications can be configured to trigger the content management system 130 to add or subscribe the users associated with the devices to a user segment including users selected for retargeting with content that is based on the content item detected within the content signals. In some examples, the event notifications can include notifications of decisions or requests from the devices that the users be retargeted with content associated with the content item and/or added to the user segment used to retarget users with content associated with the content item. The content management system 130 can add or subscribe any of the users to the user segment or determine whether to add or subscribe any of the users to the user segment based on the event notifications. The user segment can be used to identify which users to retarget with content associated with the content item, what retargeting content to deliver to the users in the user segment (and/or the devices), the devices associated with the users in the user segment used to receive the retargeting content to the users, how and/or when to deliver the retargeting content to the users in the user segment and/or the devices associated with the users, etc. By adding or subscribing users to the user segment, the content management system 130 can ensure that the users are retargeted with content associated with the content item. The user segment (and/or the users in the user segment) can optionally be subscribed to retargeting content and/or added to a queue for delivering the retargeting content. Accordingly, the user segment can cause the users in the user segment to receive and be retargeting with content associated with the user segment.

In some examples, the event notifications can include an indication that the content item was detected in the content signal, an indication that the content item matches a predetermined type of content and/or the predetermined content item, an indication that a presentation of the content item was not interrupted by a user input, an indication that an input element configured to skip or close the content item was not activated, an indication that a user input received during the presentation of the content item includes an interaction with the content item, an indication that a received user input includes a request to replay at least a portion of the content item, an indication that a user input received during the presentation of the content item matches an input recognized as indicating or predetermined to indicate positive user feedback, an indication that a user comment includes content recognized as positive feedback associated with the content item, an indication that a user activity during the presentation of the content item includes viewing the content item, a request to retarget the users with content associated with the content item, and/or an indication that the one or more retargeting conditions were satisfied.

In some cases, the event notifications can include events at the devices during a playback or presentation of the content signal. For example, the event notifications can include detection events including detection of the content item within the content signal by the devices, matching events including matching the content item detected with a predetermined content item (e.g., a targeted content item associated with the targeted content 136B) and/or predetermined type of content item (e.g., targeted content, invitational content, customized media content, banner content, overlay content, interactive content, etc.), activity events (e.g., user inputs, user interactions with the devices and/or content item, content display and/or playback events, user requests, device operations, etc.), user events, retargeting decisions (e.g., determinations that one or more retargeting conditions are satisfied with respect to the content item and certain users, determinations that certain users should be retargeted or are selected for retargeting, etc.), content activity events, and/or any other events.

At step 604, based on the event notifications, the content management system 130 can add or subscribe a set of users to a user segment including users selected for retargeting with content that is based on the content item. The set of users can include all or some of the users associated with the event notifications. Moreover, the set of users can include the user(s) 140 associated with the media device(s) 106.

In some cases, the event notifications can include requests to add or subscribe the users to the user segment. The content management system 130 can receive the event notifications and add or subscribe the users to the user segment based on the event notifications. In some cases, the content management system 130 can use the event notifications to determine, for each of the users associated with the event notifications, whether the user should be added or subscribed to the user segment. For example, the content management system 130 can use the event notification associated with a user to determine whether one or more retargeting conditions are satisfied with respect to the user. If the one or more retargeting conditions are satisfied with respect to the user, the content management system 130 can add or subscribe the user to the user segment.

In some examples, the one or more retargeting conditions can include a determination or indication that the content item was detected in the content signal by the device associated with the user, the content item matches a predetermined type of content and/or the predetermined content item, a presentation of the content item by the device associated with the user was not interrupted by a user input, an input element configured to skip or close the content item was not activated at the device, a user input received by the device during the presentation of the content item includes an interaction with the content item, a user input received by the device includes a request to replay at least a portion of the content item, a user input received by the device during the presentation of the content item matches an input recognized as indicating or predetermined to indicate positive user feedback, a user comment received by the device includes content recognized as positive feedback associated with the content item, a user activity at the device during the presentation of the content item includes viewing/watching or replaying the content item, the event notification from the device includes a request to retarget the user associated with the device with content that is based on the content item, and/or the user associated with the device initiated a conversion action associated with the content item.

In some cases, the content management system 130 can determine whether the one or more retargeting conditions are satisfied with respect to a user associated with a device based on a determination that the device detected a cue during a presentation of the content item that indicates that the presentation of the content item was not interrupted by a user input, an input element configured to skip or close the content item was not activated, a determination that a user input received by the device during the presentation of the content item includes an interaction with the content item, a determination that a user input at the device includes a request to replay at least a portion of the content item, a determination that a user input received by the device during the presentation of the content item matches an input predetermined to indicate positive user feedback, a determination that the user provided a comment recognized as positive feedback associated with the content item, a determination that a user activity at the device during the presentation of the content item includes viewing/watching or replaying the content item. The content management system 130 can determine to add or subscribe the user to the user segment based on the determination that the device detected the cue.

In some cases, the user segment can include additional information for retargeting the users in the user segment such as, for example and without limitation, information about the devices associated with the users (e.g., IP addresses, MAC addresses, hostnames, DNS names, etc.), information about the users (e.g., user identifiers, usernames, user profiles, user preferences, user devices, user locations, user demographics, user historical data, user statistics, user emails, user addresses, etc.), retargeting parameters (e.g., timing information, triggers, queues, delivery mediums or sources, content placement or organization, content configurations, content attributes, content appearances, content types, content behaviors, content portions, content objects, content tags, delivery parameters, etc.), retargeting instructions, retargeting content generation parameters or instructions, associations between users and devices, an association between the retargeting content and the user segment, and/or any other information.

At step 606, the content management system 130 can generate the retargeting content for the user segment based on the content item. The retargeting content can include content selected for retargeting to users in the user segment, including the user(s) 140. For example, the retargeting content can include content associated with the content item selected for retargeting to users in the user segment. In some examples, the retargeting content can include, without limitation, a content of the content item or a portion of the content of the content item. The retargeting content can implement or can include a different format, configuration, design, attribute, behavior, visual appearance, advertisement unit, and/or delivery medium than the content item.

The retargeting content can additionally or alternatively include a modified version of the content item or content generated based on the content item. For example, if the content item includes a banner advertisement, the retargeting content can include a different type of advertisement, such as an overlay advertisement, a video advertisement, an offerwall advertisement, a skippable or non-skippable advertisement, an interactive advertisement, an in-feed advertisement, an audio advertisement, a logo advertisement, a text advertisement, or any other type of advertisement.

The content management system 130 can associate the retargeting content with the user segment, the users in the user segment, and/or the devices associated with the users in the user segment. This way, the user segment can be used not only to identify which users to retarget but also what content to retarget to the users in the user segment.

At step 608, the content management system 130 can deliver the retargeting content to the devices associated with the users in the user segment. The content management system 130 can deliver the retargeting content for presentation (e.g., retargeting) to the users associated with the devices. The content management system 130 can use the user segment to identify the users and associated devices to deliver the retargeting content.

In some cases, the content management system 130 can deliver the retargeting content to the devices associated with the users in the user segment or trigger the retargeting content to be delivered to the devices. For example, the content management system 130 can deliver the retargeting content to the devices associated with the users in the user segment (including the media device(s) 106 associated with the user(s) 140), trigger (e.g., via a command, scheduled or triggering event, rule, API call, operation, request, etc.) the content server(s) 120 to deliver the retargeting content to the devices, and/or place the retargeting content in a content delivery or retargeting queue to trigger the retargeting content to be delivered (e.g., based on the queue) to the devices by a system, application, or service/microservice associated with the queue.

In some cases, the content management system 130 can instruct the content server(s) 120 to deliver the retargeting content to devices associated with the users in the user segment (including the media device(s) 106 associated with the user(s) 140). In some cases, the content management system 130 can trigger (e.g., based on a command, scheduled or triggering event, message, API call, request, rule, operation, etc.) or instruct the devices associated with the users in the user segment to load, stream, receive, retrieve, play, render, display, and/or surface the retargeting content to the users. For example, the content management system 130 can trigger the media device(s) 106 (and a respective device of any other users in the user segment) to display the retargeting content for the user(s) 140. The content management system 130 or user segment can trigger the retargeting content to be delivered to the devices and/or presented by the devices within or according to a content item, location, display region, medium, channel, display device, presentation, application, platform, target, format, configuration, attribute, behavior, appearance, design, timing, sequence, page (e.g., application page, web page, etc.), experience, session, etc.

The devices associated with the users in the user segment can receive the retargeting content and display the retargeting content for the users. The devices can display the retargeting content according to a setting(s) of the retargeting content, an instruction and/or parameter associated with the retargeting content, an instruction and/or parameter from the content management system 130, a configuration of the retargeting content, and/or any other information. For example, the devices can display the retargeting content within user interface, an application, a web browser, a user interface page, a media platform interface, a video, a banner, an overlay content, a window, an image, a visual element, and/or a media content item.

### Example Neural Network Architectures

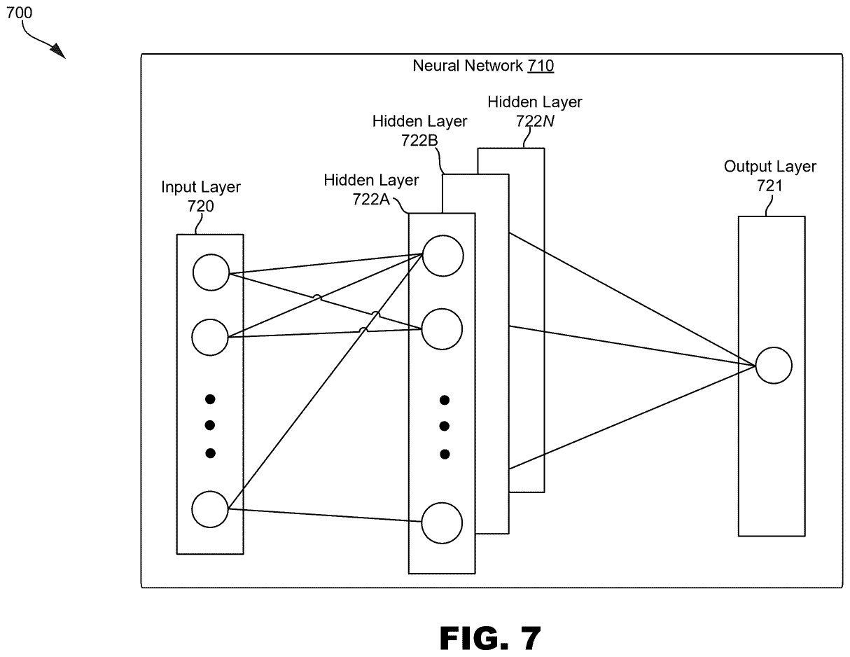

FIG. 7 is a diagram illustrating an example architecture 700 of an example neural network 710. The example architecture 700 can be used to implement any model, algorithm, or neural network described herein and/or any components described herein that can include or implement a model, algorithm, or neural network. For example, the architecture 700 can be used to implement the audio command processing system(s) 128, the content management system 130, the segmentation engine 132, the user interface system 206, the content targeting system 210, the content recognition engine 220, the content targeting engine 222, an ACR algorithm or model, and/or any portion thereof.

The architecture 700 of the neural network 710 can include an input layer 720 that can be configured to receive and process data to generate one or more outputs. The architecture 700 of the neural network 710 can also include hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The architecture 700 of the neural network 710 can further include an output layer 721 that provides an output resulting from the processing performed by the hidden layers 722a, 722b, through 722n.

The neural network 710 is a multi-layer neural network of interconnected nodes. Each node can represent a piece of information. Information associated with the nodes is shared among the different layers and each layer retains information as information is processed. In some cases, the neural network 710 can include a feed-forward network, in which case there are no feedback connections where outputs of the network are fed back into itself. In some cases, the neural network 710 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 710 are shown as having multiple output lines, a node can have a single output and all lines shown as being output from a node represent the same output value.

In some cases, each node or interconnection between nodes can have a weight that is a set of parameters derived from the training of the neural network 710. Once the neural network 710 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network 710 to be adaptive to inputs and able to learn as more and more data is processed.

The neural network 710 can be pre-trained to process the features from the data in the input layer 720 using the different hidden layers 722a, 722b, through 722n in order to provide the output through the output layer 721.

In some cases, the neural network 710 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 710 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 710 can perform a backward pass by determining which inputs (weights) most contributed to the loss of the network and can adjust the weights so that the loss decreases and is eventually minimized.

The neural network 710 can include any suitable deep network. One example neural network includes a transformer network, which can be used to implement a large language model. Another example neural network includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 710 can include any other deep network other than a transformer or CNN, such as an encoder-decoder network, an encoder-only network, a decoder-only network, a mixture of experts (MoE) network, a generative model network, an autoencoder, Deep Belief Nets (DBNs), Recurrent Neural Networks (RNNs), among others. As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Example Computer System

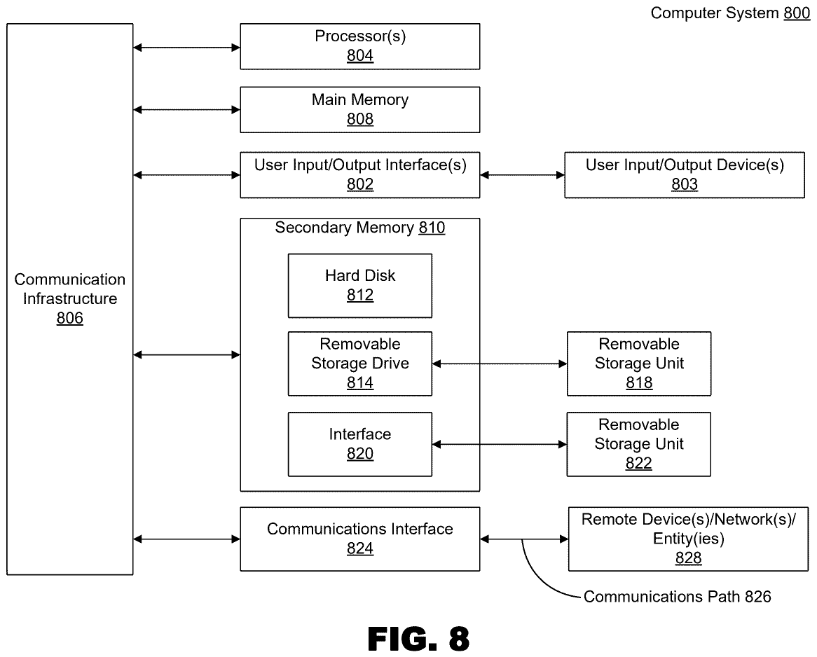

Various aspects and examples may be implemented, for example, using one or more well-known computer systems, such as computer system 800 shown in FIG. 8. For example, the media device(s) 106, the display device(s) 108, the content server(s) 120, the system server(s) 126, and/or any other device may be implemented using combinations or sub-combinations of computer system 800. Also or alternatively, computer system 800 may be used, for example, to implement any of the aspects and examples discussed herein, as well as combinations and sub-combinations thereof.

Computer system 800 may include one or more processors (e.g., central processing units or CPUs), such as processor 804. Processor 804 may be connected to a communication infrastructure 806 (or communication bus). Computer system 800 may also include user input/output device(s) 803, such as monitors, keyboards, pointing devices, etc., which may communicate with communication infrastructure 806 through user input/output interface(s) 802.

In some examples, the one or more processors 804 may include a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc. In other examples, the one or more processors 804 may additionally or alternatively include or be part of a digital signal processor (DSP), an image signal processor (ISP), an application-specific integrated circuit (ASIC), a field-programmable gate array (FPGA), an integrated circuit, a microcontroller, and/or any other processing device.

Computer system 800 may also include a main or primary memory 808, such as random access memory (RAM). Main memory 808 may include one or more levels of cache. Main memory 808 may have stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 800 may include a communication or network interface 824. Communication interface 824 may enable computer system 800 to communicate and interact with any combination of external devices, external networks, external entities, etc. (individually and collectively referenced by reference number 828). For example, communication interface 824 may allow computer system xx00 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may additionally or alternatively include a computer (e.g., tablet computer, laptop computer, server computer, desktop computer, netbook computer, notebook computer, computer workstation, computer kiosk, etc.), personal digital assistant (PDA), mobile phone (e.g., smartphone), smart wearable device (e.g., an electronic wearable device such as a smart watch or HMD), appliance, IoT device, network system, and/or embedded system, to name a few non-limiting examples, or any combination thereof.

Computer system 800 may include or represent a client or server computer that stores, accesses (e.g., streams, retrieves, receives, etc.), includes, and/or hosts any content/data and/or applications. Computer system 800 can access, retrieve, and/or receive/stream applications and/or data through any distribution, delivery, and/or access paradigm, including but not limited to remote or distributed cloud computing; local or on-premises solutions and/or services, cloud-based solutions and/or services (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and/or schemas in, of, and/or associated with computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800 or processor(s) 804), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative Examples of the disclosure include:
Example 1. A system comprising: memory; and one or more processors are coupled to the memory and configured to perform operations comprising: detecting, using automatic content recognition, a first content item in a live content signal received by a device associated with a user; determining whether one or more retargeting conditions are satisfied with respect to the first content item and the user based on information about the first content item and activity detected at the device during a presentation of the first content item; in response to determining that the one or more retargeting conditions are satisfied, generating a retargeting event notification configured to trigger the user to be added or considered for addition to a user segment comprising users selected for retargeting with a second content item associated with the first content item; receiving, by the device, the second content associated with the user segment, wherein the second content comprises content selected for the users in the user segment based at least in part on the first content item; and providing the second content to a user interface associated with the user for presentation.
Example 2. The system of Example 1, wherein the live content signal comprises a live video, wherein detecting the first content item in the live content signal comprises detecting the first content item in the live video during playback of the live video using the automatic content recognition, and wherein the operations further comprise: determining that the one or more retargeting conditions are satisfied in response to detecting the first content item and determining that the first content item matches at least one of a predetermined type of content, a predetermined content item, and a selection criteria.
Example 3. The system of any of Examples 1 or 2, wherein the operations further comprise: classifying the first content item as a targeted content item; in response to classifying the first content item as a targeted content item, triggering a detection event, the detection event comprising detecting the targeted content item in the live content signal; and in response to the detection event, triggering at least one of a collection of data used to make a retargeting decision and a determination whether to retarget the user with content selected based at least in part on the presentation of the first content item comprising the targeted content item, wherein the data used to make the retargeting decision comprises the information about the first content item and the activity detected at the device during the presentation of the first content item, wherein the activity detected at the device comprises at least one of user activity, user inactivity, device activity, and content activity associated with the first content item.
Example 4. The system of any of Examples 1 to 3, wherein determining whether one or more retargeting conditions are satisfied with respect to the first content item and the user further comprises: determining that the detection of the first content item in the live content signal comprises a content retargeting triggering event candidate based on at least one of a content of the first content item, a type of content item of the first content item, a behavior or configuration of the first content item, an entity associated with the first content item, and a product or brand associated with the first content item; and in response to the content retargeting triggering event candidate, collecting the information about the first content item and the activity detected at the device during the presentation of the first content item and determining whether the one or more retargeting conditions are satisfied based on a detection of the content retargeting triggering event candidate, the information about the first content item, and the activity detected at the device during the presentation of the first content item.
Example 5. The system of any of Examples 1 to 4, wherein determining whether the one or more retargeting conditions are satisfied comprises: detecting, during a presentation of the first content item, a cue associated with the activity detected at the device, the cue indicating that at least one of the presentation of the first content item was not interrupted by a user input, an input element configured to skip or close the first content item was not activated, a user input received during the presentation of the first content item comprises an interaction with the first content item, a received user input comprises a request to replay at least a portion of the first content item, a user input received during the presentation of the first content item matches an input recognized as indicating or predetermined to indicate positive user feedback, a user comment includes content recognized as positive feedback associated with the first content item, and user activity during the presentation of the first content item includes viewing the first content item; and based on the cue detected during the presentation of the first content item, determining that the one or more retargeting conditions are satisfied.
Example 6. The system of any of Examples 1 to 5, wherein the activity detected at the device comprises at least one of user data and device data detected during a presentation of the first content item, wherein determining whether the one or more retargeting conditions are satisfied is based on at least one of the user data and the device data detected during the presentation of the first content item, and wherein the user data and the device data comprise at least one of a user input, a user comment, a user request, a user subscription, a user interaction, a user activity, user inactivity, a presentation record associated with the first content item, a playback record associated with the first content item, and a device operation.
Example 7. The system of any of Examples 1 to 6, wherein wherein determining whether the one or more retargeting conditions are satisfied comprises: recognizing at least one of a content of the first content item, one or more attributes of the first content item, one or more inputs associated with the first content item, one or more interactive features associated with the first content item, an object depicted in the first content item, a brand associated with the first content item, and a content provider associated with the first content item; and based on at least one of the content, the one or more attributes, the one or more inputs, the one or more interactive features, the object, the brand, and the content provider associated with the first content item, triggering the retargeting event notification.
Example 8. The system of any of Examples 1 to 7, wherein the operations further comprise: displaying the first content item within a live video associated with the live content signal; and displaying the second content item within at least one of a different video displayed after the live video, an application, a page of an application, a screen, a banner, an overlay content, and a media content item.
Example 9. The system of any of Examples 1 to 8, wherein the second content item comprises a content of the first content item, a portion of the content of the first content item, or a different content than the content of the first content item, and wherein the second content item implements at least one of a different format, a different configuration, a different design, a different attribute, a different behavior, a different appearance, a different content experience, and a different delivery medium than the first content item.
Example 10. The system of any of Examples 1 to 9, wherein the retargeting event notification comprises at least one of an indication that the first content item was detected in the live content signal, an indication that the first content item is a targeted content item or is classified as a targeted content item, an indication that a presentation of the first content item was not interrupted by a user input, an indication that an input element configured to skip or close the first content item was not activated during the presentation of the first content item, an indication that a user input received during the presentation of the first content item comprises an interaction with the first content item, an indication that a user input comprises a request to replay at least a portion of the first content item, an indication that a user input received during the presentation of the first content item matches an input predetermined to indicate positive user feedback, an indication that a user activity during the presentation of the first content item includes viewing or playing the first content item, a request to retarget the user with content associated with the first content item, and an indication that the one or more retargeting conditions were satisfied.
Example 11. A computer-implemented method comprising: detecting, using automatic content recognition, a first content item in a live content signal received by a device associated with a user; determining whether one or more retargeting conditions are satisfied with respect to the first content item and the user based on information about the first content item and activity detected at the device during a presentation of the first content item; in response to determining that the one or more retargeting conditions are satisfied, generating a retargeting event notification configured to trigger the user to be added or considered for addition to a user segment comprising users selected for retargeting with a second content item associated with the first content item; receiving, by the device associated with the user, the second content associated with the user segment, wherein the second content comprises content selected for the users in the user segment based at least in part on the first content item; and providing the second content to a user interface associated with the user for presentation.
Example 12. The computer-implemented method of Example 11, wherein the live content signal comprises a live video, wherein detecting the first content item in the live content signal comprises detecting the first content item in the live video during playback of the live video using the automatic content recognition, the computer-implemented method further comprising: determining that the one or more retargeting conditions are satisfied in response to detecting the first content item and determining that the first content item matches at least one of a predetermined type of content, a predetermined content item, and a selection criteria.
Example 13. The computer-implemented method of any of Examples 11 to 12, further comprising: classifying the first content item as a targeted content item; in response to classifying the first content item as a targeted content item, triggering a detection event, the detection event comprising detecting the targeted content item in the live content signal; and in response to the detection event, triggering at least one of a collection of data used to make a retargeting decision and a determination whether to retarget the user with content selected based at least in part on the presentation of the first content item comprising the targeted content item, wherein the data used to make the retargeting decision comprises the information about the first content item and the activity detected at the device during the presentation of the first content item, wherein the activity detected at the device comprises at least one of user activity, user inactivity, device activity, and content activity associated with the first content item.
Example 14. The computer-implemented method of any of Examples 11 to 13, wherein determining whether one or more retargeting conditions are satisfied with respect to the first content item and the user further comprises: determining that the detection of the first content item in the live content signal comprises a content retargeting triggering event candidate based on at least one of a content of the first content item, a type of content item of the first content item, a behavior or configuration of the first content item, an entity associated with the first content item, and a product or brand associated with the first content item; and in response to the content retargeting triggering event candidate, collecting the information about the first content item and the activity detected at the device during the presentation of the first content item and determining whether the one or more retargeting conditions are satisfied based on a detection of the content retargeting triggering event candidate, the information about the first content item, and the activity detected at the device during the presentation of the first content item.
Example 15. The computer-implemented method of any of Examples 11 to 14, wherein determining whether the one or more retargeting conditions are satisfied comprises: detecting, during a presentation of the first content item, a cue associated with the activity detected at the device, the cue indicating that at least one of the presentation of the first content item was not interrupted by a user input, an input element configured to skip or close the first content item was not activated, a user input received during the presentation of the first content item comprises an interaction with the first content item, a received user input comprises a request to replay at least a portion of the first content item, a user input received during the presentation of the first content item matches an input recognized as indicating or predetermined to indicate positive user feedback, a user comment includes content recognized as positive feedback associated with the first content item, and user activity during the presentation of the first content item includes viewing the first content item; and based on the cue detected during the presentation of the first content item, determining that the one or more retargeting conditions are satisfied.
Example 16. The computer-implemented method of any of Examples 11 to 15, wherein the activity detected at the device comprises at least one of user data and device data detected during a presentation of the first content item, wherein determining whether the one or more retargeting conditions are satisfied is based on at least one of the user data and the device data detected during the presentation of the first content item, and wherein the user data and the device data comprise at least one of a user input, a user comment, a user request, a user subscription, a user interaction, a user activity, user inactivity, a presentation record associated with the first content item, a playback record associated with the first content item, and a device operation.
Example 17. The computer-implemented method of any of Examples 11 to 16, wherein determining whether the one or more retargeting conditions are satisfied comprises: recognizing at least one of a content of the first content item, one or more attributes of the first content item, one or more inputs associated with the first content item, one or more interactive features associated with the first content item, an object depicted in the first content item, a brand associated with the first content item, and a content provider associated with the first content item; and based on at least one of the content, the one or more attributes, the one or more inputs, the one or more interactive features, the object, the brand, and the content provider associated with the first content item, triggering the retargeting event notification.
Example 18. The computer-implemented method of any of Examples 11 to 17, further comprising: displaying the first content item within a live video associated with the live content signal; and displaying the second content item within at least one of a different video displayed after the live video, an application, a page of an application, a banner, an overlay content, a screen, a different advertising unit, and a media content item.
Example 19. The computer-implemented method of any of Examples 11 to 18, wherein the second content item comprises a content of the first content item, a portion of the content of the first content item, or a different content than the content of the first content item, and wherein the second content item implements at least one of a different format, a different configuration, a different design, a different attribute, a different behavior, a different appearance, a different advertising unit, a different content experience, and a different delivery medium than the first content item.
Example 20. The computer-implemented method of any of Examples 11 to 18, wherein the retargeting event notification comprises at least one of an indication that the first content item was detected in the live content signal, an indication that the first content item is a targeted content item or is classified as a targeted content item, an indication that a presentation of the first content item was not interrupted by a user input, an indication that an input element configured to skip or close the first content item was not activated during the presentation of the first content item, an indication that a user input received during the presentation of the first content item comprises an interaction with the first content item, an indication that a user input comprises a request to replay at least a portion of the first content item, an indication that a user input received during the presentation of the first content item matches an input predetermined to indicate positive user feedback, an indication that a user activity during the presentation of the first content item includes viewing or playing the first content item, a request to retarget the user with content associated with the first content item, and an indication that the one or more retargeting conditions were satisfied.
Example 21. The computer-implemented method of any of Examples 11 to 20, further comprising: in response to determining that the one or more retargeting conditions are satisfied, determining to retarget the user with content associated with the first content item; and selecting the second content item for use when retargeting the user with content, wherein providing the second content item to the user interface comprises displaying the second content item.
Example 22. A non-transitory computer-readable medium having instructions stored thereon that, when executed by one or more processors, cause the one or more processors to perform a method according to any of Examples 11 to 21.
Example 23. A system comprising means for performing a method according to any of Examples 11 to 21.

What is claimed is:

1. A system comprising:
memory; and
one or more processors are coupled to the memory and configured to perform operations comprising:
detecting, using automatic content recognition, a first content item in a live content signal received by a device associated with a user;
determining whether one or more retargeting conditions are satisfied with respect to the first content item and the user based on information about the first content item and activity detected at the device during a presentation of the first content item;
in response to determining that the one or more retargeting conditions are satisfied, generating a retargeting event notification configured to trigger the user to be added or considered for addition to a user segment comprising users selected for retargeting with a second content item associated with the first content item;
receiving, by the device associated with the user, the second content associated with the user segment, wherein the second content comprises content selected for the users in the user segment based at least in part on the first content item; and
providing the second content to a user interface associated with the user for presentation.

2. The system of claim 1, wherein the live content signal comprises a live video, wherein detecting the first content item in the live content signal comprises detecting the first content item in the live video during playback of the live video using the automatic content recognition, and wherein the operations further comprise:
determining that the one or more retargeting conditions are satisfied in response to detecting the first content item and determining that the first content item matches at least one of a predetermined type of content, a predetermined content item, and a selection criteria.

3. The system of claim 1, wherein the operations further comprise:
classifying the first content item as a targeted content item;
in response to classifying the first content item as a targeted content item, triggering a detection event, the detection event comprising detecting the targeted content item in the live content signal; and
in response to the detection event, triggering at least one of a collection of data used to make a retargeting decision and a determination whether to retarget the user with content selected based at least in part on the presentation of the first content item comprising the targeted content item, wherein the data used to make the retargeting decision comprises the information about the first content item and the activity detected at the device during the presentation of the first content item, wherein the activity detected at the device comprises at least one of user activity, user inactivity, device activity, and content activity associated with the first content item.

4. The system of claim 1, wherein determining whether one or more retargeting conditions are satisfied with respect to the first content item and the user further comprises:
determining that the detection of the first content item in the live content signal comprises a content retargeting triggering event candidate based on at least one of a content of the first content item, a type of content item of the first content item, a behavior or configuration of the first content item, an entity associated with the first content item, and a product or brand associated with the first content item; and
in response to the content retargeting triggering event candidate, collecting the information about the first content item and the activity detected at the device during the presentation of the first content item and determining whether the one or more retargeting conditions are satisfied based on a detection of the content retargeting triggering event candidate, the information about the first content item, and the activity detected at the device during the presentation of the first content item.

5. The system of claim 1, wherein determining whether the one or more retargeting conditions are satisfied comprises:
detecting, during a presentation of the first content item, a cue associated with the activity detected at the device, the cue indicating that at least one of the presentation of the first content item was not interrupted by a user input, an input element configured to skip or close the first content item was not activated, a user input received during the presentation of the first content item comprises an interaction with the first content item, a received user input comprises a request to replay at least a portion of the first content item, a user input received during the presentation of the first content item matches an input recognized as indicating or predetermined to indicate positive user feedback, a user comment includes content recognized as positive feedback associated with the first content item, and user activity during the presentation of the first content item includes viewing the first content item; and
based on the cue detected during the presentation of the first content item, determining that the one or more retargeting conditions are satisfied.

6. The system of claim 1, wherein the activity detected at the device comprises at least one of user data and device data detected during a presentation of the first content item, wherein determining whether the one or more retargeting conditions are satisfied is based on at least one of the user data and the device data detected during the presentation of the first content item, and wherein the user data and the device data comprise at least one of a user input, a user comment, a user request, a user subscription, a user interaction, a user activity, user inactivity, a presentation record associated with the first content item, a playback record associated with the first content item, and a device operation.

7. The system of claim 1, wherein wherein determining whether the one or more retargeting conditions are satisfied comprises:
recognizing at least one of a content of the first content item, one or more attributes of the first content item, one or more inputs associated with the first content item, one or more interactive features associated with the first content item, an object depicted in the first content item, a brand associated with the first content item, and a content provider associated with the first content item; and
based on at least one of the content, the one or more attributes, the one or more inputs, the one or more interactive features, the object, the brand, and the content provider associated with the first content item, triggering the retargeting event notification.

8. The system of claim 1, wherein the operations further comprise:
displaying the first content item within a live video associated with the live content signal; and
displaying the second content item within at least one of a different video displayed after the live video, an application, a page of an application, a screen, a banner, an overlay content, and a media content item.

9. The system of claim 1, wherein the second content item comprises a content of the first content item, a portion of the content of the first content item, or a different content than the content of the first content item, and wherein the second content item implements at least one of a different format, a different configuration, a different design, a different attribute, a different behavior, a different appearance, a different content experience, and a different delivery medium than the first content item.

10. The system of claim 1, wherein the retargeting event notification comprises at least one of an indication that the first content item was detected in the live content signal, an indication that the first content item is a targeted content item or is classified as a targeted content item, an indication that a presentation of the first content item was not interrupted by a user input, an indication that an input element configured to skip or close the first content item was not activated during the presentation of the first content item, an indication that a user input received during the presentation of the first content item comprises an interaction with the first content item, an indication that a user input comprises a request to replay at least a portion of the first content item, an indication that a user input received during the presentation of the first content item matches an input predetermined to indicate positive user feedback, an indication that a user activity during the presentation of the first content item includes viewing or playing the first content item, a request to retarget the user with content associated with the first content item, and an indication that the one or more retargeting conditions were satisfied.

11. A computer-implemented method comprising:
detecting, using automatic content recognition, a first content item in a live content signal received by a device associated with a user;
determining whether one or more retargeting conditions are satisfied with respect to the first content item and the user based on information about the first content item and activity detected at the device during a presentation of the first content item;
in response to determining that the one or more retargeting conditions are satisfied, generating a retargeting event notification configured to trigger the user to be added or considered for addition to a user segment comprising users selected for retargeting with a second content item associated with the first content item;
receiving, by the device associated with the user, the second content associated with the user segment, wherein the second content comprises content selected for the users in the user segment based at least in part on the first content item; and
providing the second content to a user interface associated with the user for presentation.

12. The computer-implemented method of claim 11, wherein the live content signal comprises a live video, wherein detecting the first content item in the live content signal comprises detecting the first content item in the live video during playback of the live video using the automatic content recognition, the computer-implemented method further comprising:
determining that the one or more retargeting conditions are satisfied in response to detecting the first content item and determining that the first content item matches at least one of a predetermined type of content, a predetermined content item, and a selection criteria.

13. The computer-implemented method of claim 11, further comprising:
classifying the first content item as a targeted content item;
in response to classifying the first content item as a targeted content item, triggering a detection event, the detection event comprising detecting the targeted content item in the live content signal; and
in response to the detection event, triggering at least one of a collection of data used to make a retargeting decision and a determination whether to retarget the user with content selected based at least in part on the presentation of the first content item comprising the targeted content item, wherein the data used to make the retargeting decision comprises the information about the first content item and the activity detected at the device during the presentation of the first content item, wherein the activity detected at the device comprises at least one of user activity, user inactivity, device activity, and content activity associated with the first content item.

14. The computer-implemented method of claim 11, wherein determining whether one or more retargeting conditions are satisfied with respect to the first content item and the user further comprises:
determining that the detection of the first content item in the live content signal comprises a content retargeting triggering event candidate based on at least one of a content of the first content item, a type of content item of the first content item, a behavior or configuration of the first content item, an entity associated with the first content item, and a product or brand associated with the first content item; and
in response to the content retargeting triggering event candidate, collecting the information about the first content item and the activity detected at the device during the presentation of the first content item and determining whether the one or more retargeting conditions are satisfied based on a detection of the content retargeting triggering event candidate, the information about the first content item, and the activity detected at the device during the presentation of the first content item.

15. The computer-implemented method of claim 11, wherein determining whether the one or more retargeting conditions are satisfied comprises:
detecting, during a presentation of the first content item, a cue associated with the activity detected at the device, the cue indicating that at least one of the presentation of the first content item was not interrupted by a user input, an input element configured to skip or close the first content item was not activated, a user input received during the presentation of the first content item comprises an interaction with the first content item, a received user input comprises a request to replay at least a portion of the first content item, a user input received during the presentation of the first content item matches an input recognized as indicating or predetermined to indicate positive user feedback, a user comment includes content recognized as positive feedback associated with the first content item, and user activity during the presentation of the first content item includes viewing the first content item; and
based on the cue detected during the presentation of the first content item, determining that the one or more retargeting conditions are satisfied.

16. The computer-implemented method of claim 11, wherein the activity detected at the device comprises at least one of user data and device data detected during a presentation of the first content item, wherein determining whether the one or more retargeting conditions are satisfied is based on at least one of the user data and the device data detected during the presentation of the first content item, and wherein the user data and the device data comprise at least one of a user input, a user comment, a user request, a user subscription, a user interaction, a user activity, user inactivity, a presentation record associated with the first content item, a playback record associated with the first content item, and a device operation.

17. The computer-implemented method of claim 11, wherein determining whether the one or more retargeting conditions are satisfied comprises:
recognizing at least one of a content of the first content item, one or more attributes of the first content item, one or more inputs associated with the first content item, one or more interactive features associated with the first content item, an object depicted in the first content item, a brand associated with the first content item, and a content provider associated with the first content item; and
based on at least one of the content, the one or more attributes, the one or more inputs, the one or more interactive features, the object, the brand, and the content provider associated with the first content item, triggering the retargeting event notification.

18. The computer-implemented method of claim 11, further comprising:
displaying the first content item within a live video associated with the live content signal; and
displaying the second content item, wherein the second content item comprises a content of the first content item, a portion of the content of the first content item, or a different content than the content of the first content item, and wherein the second content item implements at least one of a different format, a different configuration, a different design, a different attribute, a different behavior, a different appearance, a different content experience, and a different delivery medium than the first content item.

19. The computer-implemented method of claim 11, wherein the retargeting event notification comprises at least one of an indication that the first content item was detected in the live content signal, an indication that the first content item is a targeted content item or is classified as a targeted content item, an indication that a presentation of the first content item was not interrupted by a user input, an indication that an input element configured to skip or close the first content item was not activated during the presentation of the first content item, an indication that a user input received during the presentation of the first content item comprises an interaction with the first content item, an indication that a user input comprises a request to replay at least a portion of the first content item, an indication that a user input received during the presentation of the first content item matches an input predetermined to indicate positive user feedback, an indication that a user activity during the presentation of the first content item includes viewing or playing the first content item, a request to retarget the user with content associated with the first content item, and an indication that the one or more retargeting conditions were satisfied.

20. A non-transitory computer-readable medium having instructions stored thereon that, when executed by one or more processors, cause the one or more processors to perform operations comprising:
detecting, using automatic content recognition, a first content item in a live content signal received by a device associated with a user;
determining whether one or more retargeting conditions are satisfied with respect to the first content item and the user based on information about the first content item and activity detected at the device during a presentation of the first content item;
in response to determining that the one or more retargeting conditions are satisfied, generating a retargeting event notification configured to trigger the user to be added or subscribed to a user segment comprising users selected for retargeting with a second content item associated with the first content item;
receiving, by the device associated with the user, the second content associated with the user segment, wherein the second content comprises content selected for the users in the user segment based at least in part on the first content item; and
providing the second content to a user interface associated with the user for presentation.
